(19) United States
(12) Patent Application Publication
(10) Pub. No.: US 2020/0112710 A1
(43) Pub. Date: Apr. 9, 2020

(54) METHOD AND DEVICE FOR TRANSMITTING AND RECEIVING 360-DEGREE VIDEO ON BASIS OF QUALITY

(71) Applicant: LG ELECTRONICS INC., Seoul (KR)

(72) Inventors: Hyunmook OH, Seoul (KR); Sejin OH, Seoul (KR); Jangwon LEE, Seoul (KR)

(73) Assignee: LG ELECTRONICS INC., Seoul (KR)

(21) Appl. No.: 16/495,091

(22) PCT Filed: Dec. 27, 2017
(86) PCT No.: PCT/KR2017/015559

§ 371 Date: Sep. 17, 2019

Related U.S. Application Data
(60) Provisional application No. 62/472,634, filed on Mar. 17, 2017.
(60) Provisional application No. 62/478,060, filed on Mar. 29, 2017.

(51) Int. Cl. H04N 13/178; H04N 13/194; H04N 13/161; H04N 19/154; H04N 19/117; H04N 19/167

(52) U.S. Cl. CPC H04N 13/178; H04N 13/194; H04N 19/167; H04N 19/154; H04N 19/117; H04N 13/161

(57) ABSTRACT

A 360-degree video data processing method performed by a 360-degree video transmission device, according to the present disclosure, comprises the steps of: acquiring 360-degree video data captured by at least one camera; processing the 360-degree video data so as to acquire a current picture; generating metadata for the 360-degree video data; encoding the current picture; and performing processing for storing or transmitting the encoded current picture and the metadata, wherein the metadata includes information indicating the quality type of a target region in the current picture and information indicating the level of the quality type.

### BACKGROUND

### Field of the Disclosure

The present disclosure relates to a 360-degree video and, more particularly, to a method and apparatus for transmitting and receiving 360-degree video including quality information.

### Related Art

Virtual reality (VR) systems allow users to feel as if they are in electronically projected environments. Systems for providing VR can be improved in order to provide images with higher picture quality and spatial sounds. VR systems allow users to interactively consume VR content.

### SUMMARY

An object of the present disclosure is to provide a method and apparatus for improving VR video data transmission efficiency for providing a VR system.

Another object of the present disclosure is to provide a method and apparatus for transmitting VR video data and metadata with respect to VR video data.

The present disclosure provides a method and apparatus for transmitting VR video data and metadata for region-wise quality indication information of the VR video data.

The present disclosure provides a method and apparatus for selecting a video stream based on VR video data and region-wise quality indication information to which VR video data has been mapped, and performing a post-processing process.

In an aspect, there is provided a 360-degree video data processing method performed by a 360-degree video transmission apparatus. The method includes obtaining 360-degree video data captured by at least one camera, obtaining a current picture by processing the 360-degree video data, generating metadata for the 360-degree video data, encoding the current picture, and performing processing for a storage or transmission on the encoded current picture and the metadata, wherein the metadata comprises information indicating a quality type of a target region within the current picture and information indicating a level of the quality type.

In another aspect, there is provided a 360-degree video transmission apparatus for processing 360-degree video data. The 360-degree video transmission apparatus includes an input unit configured to obtain 360-degree video data captured by at least one camera, a projection processor configured to obtain a current picture by processing the 360-degree video data, a metadata processor configured to generate metadata for the 360-degree video data, an input encoder configured to encode the current picture, and a transmission processor configured to perform processing for a storage or transmission on the encoded current picture, wherein the metadata includes information indicating a quality type of a target region within the current picture and information indicating a level of the quality type.

In yet another aspect, there is provided a 360-degree video data processing method performed by a 360 video receiving apparatus. The method includes receiving a signal including information on a current picture for 360-degree video data and metadata for the 360-degree video data, obtaining the information on the current picture and the metadata by processing the signal, decoding the current picture based on the information on the current picture and the metadata, and rendering the decoded current picture on a 3D space by processing the decoded current picture, wherein the metadata includes information indicating a quality type of a target region in the current picture and information indicating a level of the quality type.

In yet another aspect, there is provided a 360-degree video reception apparatus for processing 360-degree video data. The apparatus includes a reception unit configured to receive a signal including information on a current picture for 360-degree video data and metadata for the 360-degree video data, a reception processor configured to obtain the information on the current picture and the metadata by processing the signal, a data decoder configured to decode the current picture based on the information on the current picture and the metadata, and a renderer configured to render the decoded current picture on a 3D space by processing the decoded current picture, wherein the metadata includes information indicating a quality type of a target region in the current picture and information indicating a level of the quality type.

According to the present disclosure, it is possible to efficiently transmit 360-degree content in an environment supporting next-generation hybrid broadcast using terrestrial broadcast networks and the Internet.

According to the present disclosure, it is possible to propose a method for providing interactive experience in 360-degree content consumption of users.

According to the present disclosure, it is possible to propose a signaling method for correctly reflecting the intention of a 360-degree content provider in 360-degree content consumption of users.

According to the present disclosure, it is possible to propose a method for efficiently increasing transmission capacity and forwarding necessary information in 360-degree content transmission.

According to the present disclosure, metadata for region-wise quality indication information of 360-degree video data can be transmitted, and thus overall transmission efficiency can be enhanced.

### BRIEF DESCRIPTION OF THE DRAWINGS

FIG. 1 is a view illustrating overall architecture for providing a 360-degree video according to the present disclosure.

FIGS. 2 and 3 are views illustrating a structure of a media file according to an embodiment of the present disclosure.

FIG. 4 illustrates an example of the overall operation of a DASH based adaptive streaming model.

FIG. 5 is a view schematically illustrating a configuration of a 360-degree video transmission apparatus to which the present disclosure is applicable.

FIG. 6 is a view schematically illustrating a configuration of a 360-degree video reception apparatus to which the present disclosure is applicable.

FIG. 7 illustrates an example in which a boundary artifact between a high picture quality region and a low picture quality region in a picture projected through equirectangular projection (EPR) is prevented.

FIGS. 8a to 8c illustrate examples of metadata for region-wise quality indication information.

FIG. 9 illustrates examples of types indicating a 3D space.

FIGS. 10a and 10b illustrate examples of information for the region boundary processing of a region.

FIGS. 11a to 11e illustrate embodiments in which a picture quality difference within a current picture is classified based on the metadata for region-wise quality indication information.

FIGS. 12a to 12c illustrate embodiments in which a video stream is selected based on region-wise quality indication information.

FIG. 13 illustrates RegionWiseQualityIndicationSEIBox included and transmitted in VisualSampleEntry or HEVCSampleEntry.

FIGS. 14a to 14d illustrate RegionWiseQualityIndicationBox within ISOBMFF according to an embodiment of the present disclosure.

FIGS. 15a to 15i illustrate examples of region-wise quality indication information-related metadata described in a DASH-based descriptor form.

FIG. 16 schematically illustrates a 360-degree video data processing method performed by a 360-degree video transmission apparatus according to the present disclosure.

FIG. 17 schematically illustrates a 360-degree video data processing method performed by the 360-degree video reception apparatus according to the present disclosure.

### DESCRIPTION OF EXEMPLARY EMBODIMENTS

The present disclosure may be modified in various forms, and specific embodiments thereof will be described and illustrated in the drawings. However, the embodiments are not intended for limiting the disclosure. The terms used in the following description are used to merely describe specific embodiments, but are not intended to limit the disclosure. An expression of a singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

On the other hand, elements in the drawings described in the disclosure are independently drawn for the purpose of convenience for explanation of different specific functions, and do not mean that the elements are embodied by independent hardware or independent software. For example, two or more elements of the elements may be combined to form a single element, or one element may be divided into plural elements. The embodiments in which the elements are combined and/or divided belong to the disclosure without departing from the concept of the disclosure.

Hereinafter, preferred embodiments of the present disclosure will be described in more detail with reference to the attached drawings. Hereinafter, the same reference numbers will be used throughout this specification to refer to the same components and redundant description of the same component will be omitted.

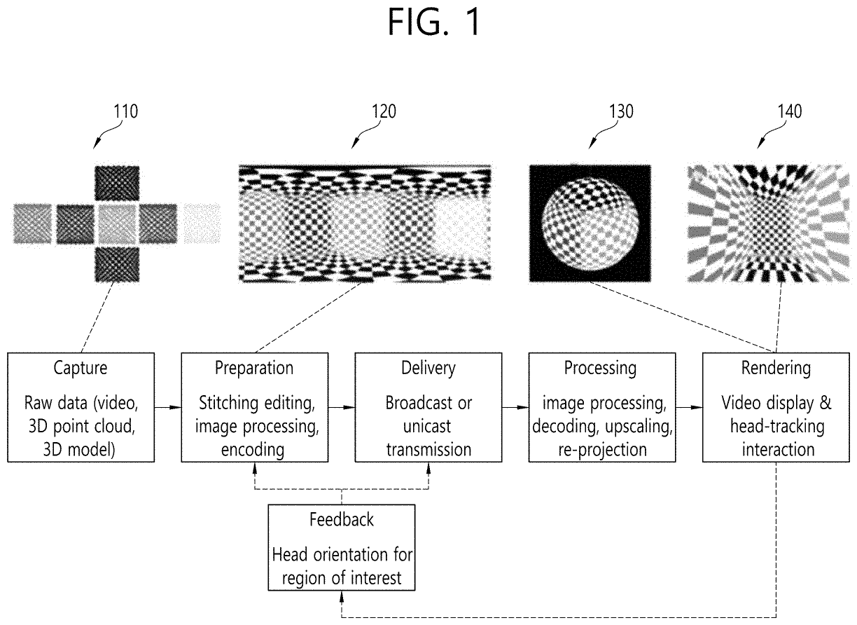

FIG. 1 is a view illustrating overall architecture for providing a 360-degree video according to the present disclosure.

The present disclosure proposes a method of providing 360-degree content in order to provide virtual reality (VR) to users. VR may refer to technology for replicating actual or virtual environments or those environments. VR artificially provides sensory experience to users and thus users can experience electronically projected environments.

360 content refers to content for realizing and providing VR and may include a 360-degree video and/or 360 audio. The 360-degree video may refer to video or image content which is necessary to provide VR and is captured or reproduced omnidirectionally (360 degrees). Hereinafter, the 360-degree video may refer to 360-degree video. A 360-degree video may refer to a video or an image represented on 3D spaces in various forms according to 3D models. For example, a 360-degree video can be represented on a spherical surface. The 360 audio is audio content for providing VR and may refer to spatial audio content whose audio generation source can be recognized to be located in a specific 3D space. 360 content may be generated, processed and transmitted to users, and the users can consume VR experiences using the 360 content.

Particularly, the present disclosure proposes a method for effectively providing a 360-degree video. To provide a 360-degree video, a 360-degree video may be captured through one or more cameras. The captured 360-degree video may be transmitted through series of processes and a reception side may process the transmitted 360-degree video into the original 360-degree video and render the 360-degree video. In this manner the 360-degree video can be provided to a user.

Specifically, processes for providing a 360-degree video may include a capture process, a preparation process, a transmission process, a processing process, a rendering process and/or a feedback process.

The capture process may refer to a process of capturing images or videos for a plurality of viewpoints through one or more cameras. Image/video data 110 shown in FIG. 1 may be generated through the capture process. Each plane of 110 in FIG. 1 may represent an image/video for each viewpoint. A plurality of captured images/videos may be referred to as raw data. Metadata related to capture can be generated during the capture process.

For capture, a special camera for VR may be used. When a 360-degree video with respect to a virtual space generated by a computer is provided according to an embodiment, capture through an actual camera may not be performed. In this case, a process of simply generating related data can substitute for the capture process.

The preparation process may be a process of processing captured images/videos and metadata generated in the capture process. Captured images/videos may be subjected to a stitching process, a projection process, a region-wise packing process and/or an encoding process during the preparation process.

First, each image/video may be subjected to the stitching process. The stitching process may be a process of connecting captured images/videos to generate one panorama image/video or spherical image/video.

Subsequently, stitched images/videos may be subjected to the projection process. In the projection process, the stitched images/videos may be projected on 2D image. The 2D image may be called a 2D image frame according to context. Projection on a 2D image may be referred to as mapping to a 2D image. Projected image/video data may have the form of a 2D image 120 in FIG. 1.

Video data projected on the 2D image may be subjected to the region-wise packing process in order to improve video coding efficiency. Region-wise packing may refer to a process of processing video data projected on a 2D image for each region. Here, regions may refer to divided areas of a 2D image. Regions can be obtained by dividing a 2D image equally or arbitrarily according to an embodiment. Further, regions may be divided according to a projection scheme in an embodiment. The region-wise packing process is an optional process and may be omitted in the preparation process.

The processing process may include a process of rotating regions or rearranging the regions on a 2D image in order to improve video coding efficiency according to an embodiment. For example, it is possible to rotate regions such that specific sides of regions are positioned in proximity to each other to improve coding efficiency.

The processing process may include a process of increasing or decreasing resolution for a specific region in order to differentiate resolutions for regions of a 360-degree video according to an embodiment. For example, it is possible to increase the resolution of regions corresponding to relatively more important regions in a 360-degree video to be higher than the resolution of other regions. Video data projected on the 2D image or region-wise packed video data may be subjected to the encoding process through a video codec.

According to an embodiment, the preparation process may further include an additional editing process. In this editing process, editing of image/video data before and after projection may be performed. In the preparation process, metadata regarding stitching/projection/encoding/editing may also be generated. Further, metadata regarding an initial viewpoint or a region of interest (ROI) of video data projected on the 2D image may be generated.

The transmission process may be a process of processing and transmitting image/video data and metadata which have passed through the preparation process. Processing according to an arbitrary transmission protocol may be performed for transmission. Data which has been processed for transmission may be delivered through a broadcast network and/or a broadband. Such data may be delivered to a reception side in an on-demand manner. The reception side may receive the data through various paths.

The processing process may refer to a process of decoding received data and re-projecting projected image/video data on a 3D model. In this process, image/video data projected on the 2D image may be re-projected on a 3D space. This process may be called mapping or projection according to context. Here, 3D model to which image/video data is mapped may have different forms according to 3D models. For example, 3D models may include a sphere, a cube, a cylinder and a pyramid.

According to an embodiment, the processing process may additionally include an editing process and an up-scaling process. In the editing process, editing of image/video data before and after re-projection may be further performed. When the image/video data has been reduced, the size of the image/video data can be increased by up-scaling samples in the up-scaling process. An operation of decreasing the size through down-scaling may be performed as necessary.

The rendering process may refer to a process of rendering and displaying the image/video data re-projected on the 3D space. Re-projection and rendering may be combined and represented as rendering on a 3D model. An image/video re-projected on a 3D model (or rendered on a 3D model) may have a form 130 shown in FIG. 1. The form 130 shown in FIG. 1 corresponds to a case in which the image/video is re-projected on a 3D spherical model. A user can view a region of the rendered image/video through a VR display. Here, the region viewed by the user may have a form 140 shown in FIG. 1.

The feedback process may refer to a process of delivering various types of feedback information which can be acquired in a display process to a transmission side. Interactivity in consumption of a 360-degree video can be provided through the feedback process. According to an embodiment, head orientation information, viewport information representing a region currently viewed by a user, and the like can be delivered to a transmission side in the feedback process. According to an embodiment, a user may interact with an object realized in a VR environment. In this case, information about the interaction may be delivered to a transmission side or a service provider in the feedback process. According to an embodiment, the feedback process may not be performed.

The head orientation information may refer to information about the position, angle, motion and the like of the head of a user. Based on this information, information about a region in a 360-degree video which is currently viewed by the user, that is, viewport information, can be calculated.

The viewport information may be information about a region in a 360-degree video which is currently viewed by a user. Gaze analysis may be performed through the viewpoint information to check how the user consumes the 360-degree video, which region of the 360-degree video is gazed by the user, how long the region is gazed, and the like. Gaze analysis may be performed at a reception side and a result thereof may be delivered to a transmission side through a feedback channel A device such as a VR display may extract a viewport region based on the position/direction of the head of a user, information on a vertical or horizontal field of view (FOV) supported by the device, and the like.

According to an embodiment, the aforementioned feedback information may be consumed at a reception side as well as being transmitted to a transmission side. That is, decoding, re-projection and rendering at the reception side may be performed using the aforementioned feedback information. For example, only a 360-degree video with respect to a region currently viewed by the user may be preferentially decoded and rendered using the head orientation information and/or the viewport information.

Here, a viewport or a viewport region may refer to a region in a 360-degree video being viewed by a user. A viewpoint is a point in a 360-degree video being viewed by a user and may refer to a center point of a viewport region. That is, a viewport is a region having a viewpoint at the center thereof, and the size and the shape of the region can be determined by an FOV which will be described later.

In the above-described overall architecture for providing a 360-degree video, image/video data which is subjected to the capture/projection/encoding/transmission/decoding/re-projection/rendering processes may be referred to as 360-degree video data. The term “360-degree video data” may be used as the concept including metadata and signaling information related to such image/video data.

To store and transmit media data such as the aforementioned audio and video data, a standardized media file format may be defined. According to an embodiment, a media file may have a file format based on ISO BMFF (ISO base media file format).

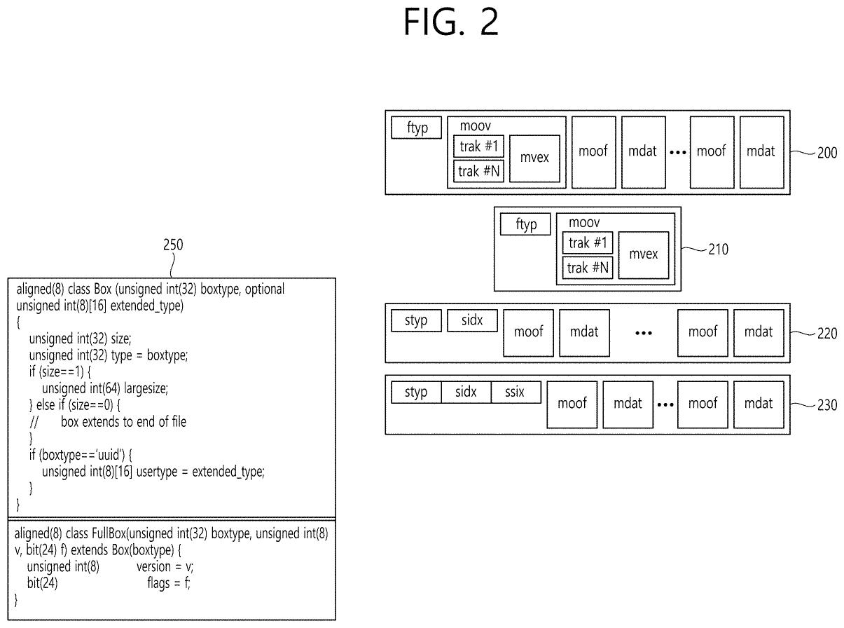

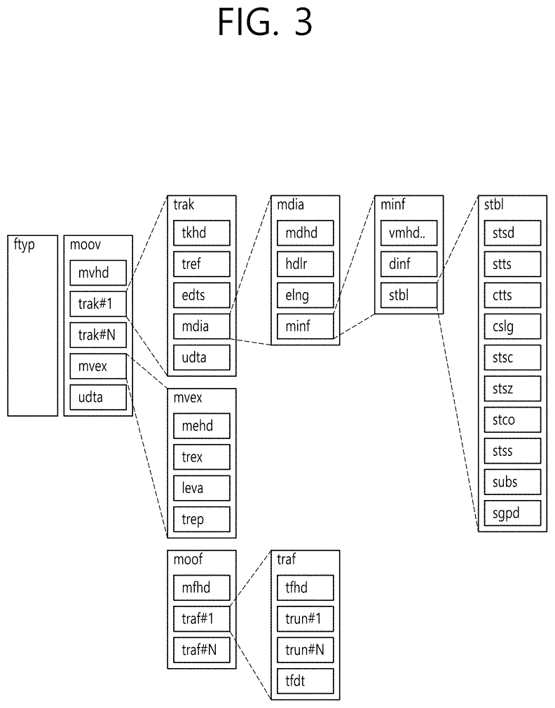

FIGS. 2 and 3 are views illustrating a structure of a media file according to an embodiment of the present disclosure.

The media file according to the present disclosure may include at least one box. Here, a box may be a data block or an object including media data or metadata related to media data. Boxes may be in a hierarchical structure and thus data can be classified and media files can have a format suitable for storage and/or transmission of large-capacity media data. Further, media files may have a structure which allows users to easily access media information such as moving to a specific point of media content.

The media file according to the present disclosure may include an ftyp box, a moov box and/or an mdat box.

The ftyp box (file type box) can provide file type or compatibility related information about the corresponding media file. The ftyp box may include configuration version information about media data of the corresponding media file. A decoder can identify the corresponding media file with reference to ftyp box.

The moov box (movie box) may be a box including metadata about media data of the corresponding media file. The moov box may serve as a container for all metadata. The moov box may be a highest layer among boxes related to metadata. According to an embodiment, only one moov box may be present in a media file.

The mdat box (media data box) may be a box containing actual media data of the corresponding media file. Media data may include audio samples and/or video samples. The mdat box may serve as a container containing such media samples.

According to an embodiment, the aforementioned moov box may further include an mvhd box, a trak box and/or an mvex box as lower boxes.

The mvhd box (movie header box) may include information related to media presentation of media data included in the corresponding media file. That is, the mvhd box may include information such as a media generation time, change time, time standard and period of corresponding media presentation.

The trak box (track box) can provide information about a track of corresponding media data. The trak box can include information such as stream related information, presentation related information and access related information about an audio track or a video track. A plurality of trak boxes may be present depending on the number of tracks.

The trak box may further include a tkhd box (track head box) as a lower box. The tkhd box can include information about the track indicated by the trak box. The tkhd box can include information such as a generation time, a change time and a track identifier of the corresponding track.

The mvex box (movie extend box) can indicate that the corresponding media file may have a moof box which will be described later. To recognize all media samples of a specific track, moof boxes may need to be scanned.

According to an embodiment, the media file according to the present disclosure may be divided into a plurality of fragments (200). Accordingly, the media file can be fragmented and stored or transmitted. Media data (mdat box) of the media file can be divided into a plurality of fragments and each fragment can include a moof box and a divided mdat box. According to an embodiment, information of the ftyp box and/or the moov box may be required to use the fragments.

The moof box (movie fragment box) can provide metadata about media data of the corresponding fragment. The moof box may be a highest-layer box among boxes related to metadata of the corresponding fragment.

The mdat box (media data box) can include actual media data as described above. The mdat box can include media samples of media data corresponding to each fragment corresponding thereto.

According to an embodiment, the aforementioned moof box may further include an mfhd box and/or a traf box as lower boxes.

The mfhd box (movie fragment header box) can include information about correlation between divided fragments. The mfhd box can indicate the order of divided media data of the corresponding fragment by including a sequence number. Further, it is possible to check whether there is missed data among divided data using the mfhd box.

The traf box (track fragment box) can include information about the corresponding track fragment. The traf box can provide metadata about a divided track fragment included in the corresponding fragment. The traf box can provide metadata such that media samples in the corresponding track fragment can be decoded/reproduced. A plurality of traf boxes may be present depending on the number of track fragments.

According to an embodiment, the aforementioned traf box may further include a tfhd box and/or a trun box as lower boxes.

The tfhd box (track fragment header box) can include header information of the corresponding track fragment. The tfhd box can provide information such as a basic sample size, a period, an offset and an identifier for media samples of the track fragment indicated by the aforementioned traf box.

The trun box (track fragment run box) can include information related to the corresponding track fragment. The trun box can include information such as a period, a size and a reproduction time for each media sample.

The aforementioned media file and fragments thereof can be processed into segments and transmitted. Segments may include an initialization segment and/or a media segment.

A file of the illustrated embodiment 210 may include information related to media decoder initialization except media data. This file may correspond to the aforementioned initialization segment, for example. The initialization segment can include the aforementioned ftyp box and/or moov box.

A file of the illustrated embodiment 220 may include the aforementioned fragment. This file may correspond to the aforementioned media segment, for example. The media segment may further include an styp box and/or an sidx box.

The styp box (segment type box) can provide information for identifying media data of a divided fragment. The styp box can serve as the aforementioned ftyp box for a divided fragment. According to an embodiment, the styp box may have the same format as the ftyp box.

The sidx box (segment index box) can provide information indicating an index of a divided fragment. Accordingly, the order of the divided fragment can be indicated.

According to an embodiment 230, an ssix box may be further included. The ssix box (sub-segment index box) can provide information indicating an index of a sub-segment when a segment is divided into sub-segments.

Boxes in a media file can include more extended information based on a box or a FullBox as shown in the illustrated embodiment 250. In the present embodiment, a size field and a largesize field can represent the length of the corresponding box in bytes. A version field can indicate the version of the corresponding box format. A type field can indicate the type or identifier of the corresponding box. A flags field can indicate a flag associated with the corresponding box.

Meanwhile, the fields (attributes) for 360-degree video of the present disclosure can be included and delivered in a DASH based adaptive streaming model.

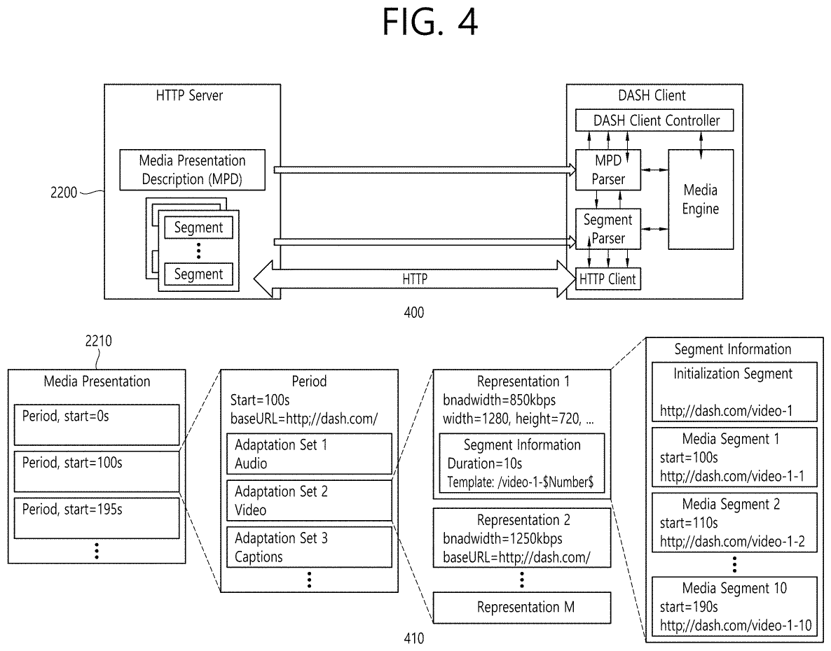

FIG. 4 illustrates an example of the overall operation of a DASH based adaptive streaming model. The DASH based adaptive streaming model according to the illustrated embodiment 400 describes operations between an HTTP server and a DASH client. Here, DASH (Dynamic Adaptive Streaming over HTTP) is a protocol for supporting adaptive streaming based on HTTP and can dynamically support streaming according to network state. Accordingly, seamless AV content reproduction can be provided.

First, a DASH client can acquire an MPD. The MPD can be delivered from a service provider such as an HTTP server. The DASH client can send a request for corresponding segments to the server using information on access to the segments which is described in the MPD. Here, the request can be performed based on a network state.

Upon acquisition of the segments, the DASH client can process the segments in a media engine and display the processed segments on a screen. The DASH client can request and acquire necessary segments by reflecting a reproduction time and/or a network state therein in real time (adaptive streaming) Accordingly, content can be seamlessly reproduced.

The MPD (Media Presentation Description) is a file including detailed information for a DASH client to dynamically acquire segments and can be represented in the XML format.

A DASH client controller can generate a command for requesting the MPD and/or segments based on a network state. Further, this controller can control an internal block such as the media engine to be able to use acquired information.

An MPD parser can parse the acquired MPD in real time. Accordingly, the DASH client controller can generate the command for acquiring necessary segments.

The segment parser can parse acquired segments in real time. Internal blocks such as the media block can perform specific operations according to information included in the segments.

An HTTP client can send a request for a necessary MPD and/or segments to the HTTP server. In addition, the HTTP client can transfer the MPD and/or segments acquired from the server to the MPD parser or a segment parser.

The media engine can display content on a screen using media data included in segments. Here, information of the MPD can be used.

A DASH data model may have a hierarchical structure 410. Media presentation can be described by the MPD. The MPD can describe a temporal sequence of a plurality of periods which forms the media presentation. A period can represent one period of media content.

In one period, data can be included in adaptation sets. An adaptation set may be a set of a plurality of exchangeable media content components. Adaptation can include a set of representations. A representation can correspond to a media content component. Content can be temporally divided into a plurality of segments within one representation. This may be for accessibility and delivery. To access each segment, the URL of each segment may be provided.

The MPD can provide information related to media presentation, and a period element, an adaptation set element and a representation element can respectively describe the corresponding period, adaptation set and representation. A representation can be divided into sub-representations, and a sub-representation element can describe the corresponding sub-representation.

Here, common attributes/elements can be defined. The common attributes/elements can be applied to (included in) adaptation sets, representations and sub-representations. The common attributes/elements may include an essential property and/or a supplemental property.

The essential property is information including elements regarded as essential elements in processing data related to the corresponding media presentation. The supplemental property is information including elements which may be used to process data related to the corresponding media presentation. According to an embodiment, when descriptors which will be described later are delivered through the MPD, the descriptors can be defined in the essential property and/or the supplemental property and delivered.

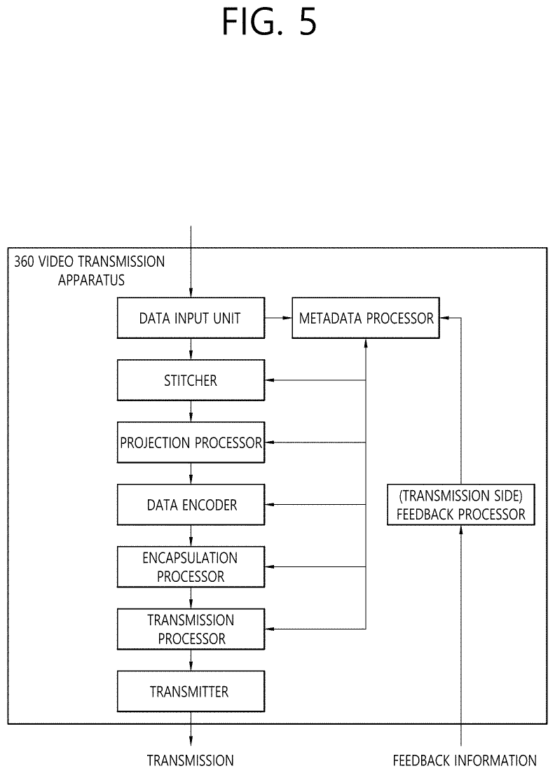

FIG. 5 is a view schematically illustrating a configuration of a 360-degree video transmission apparatus to which the present disclosure is applicable.

The 360-degree video transmission apparatus according to the present disclosure can perform operations related the above-described preparation process and the transmission process. The 360-degree video transmission apparatus may include a data input unit, a stitcher, a projection processor, a region-wise packing processor (not shown), a metadata processor, a (transmission side) feedback processor, a data encoder, an encapsulation processor, a transmission processor and/or a transmitter as internal/external elements.

The data input unit can receive captured images/videos for respective viewpoints. The images/videos for the respective viewpoints may be images/videos captured by one or more cameras. Further, data input unit may receive metadata generated in a capture process. The data input unit may forward the received images/videos for the viewpoints to the stitcher and forward metadata generated in the capture process to the signaling processor.

The stitcher can perform a stitching operation on the captured images/videos for the viewpoints. The stitcher may forward stitched 360-degree video data to the projection processor. The stitcher may receive necessary metadata from the metadata processor and use the metadata for the stitching operation as necessary. The stitcher may forward metadata generated in the stitching process to the metadata processor. The metadata in the stitching process may include information such as information representing whether stitching has been performed, and a stitching type.

The projection processor can project the stitched 360-degree video data on a 2D image. The projection processor may perform projection according to various schemes which will be described later. The projection processor may perform mapping in consideration of the depth of 360-degree video data for each viewpoint. The projection processor may receive metadata necessary for projection from the metadata processor and use the metadata for the projection operation as necessary. The projection processor may forward metadata generated in the projection process to the metadata processor. Metadata generated in the projection processor may include a projection scheme type and the like.

The region-wise packing processor (not shown) can perform the aforementioned region-wise packing process. That is, the region-wise packing processor can perform the process of dividing the projected 360-degree video data into regions and rotating and rearranging regions or changing the resolution of each region. As described above, the region-wise packing process is optional and thus the region-wise packing processor may be omitted when region-wise packing is not performed. The region-wise packing processor may receive metadata necessary for region-wise packing from the metadata processor and use the metadata for a region-wise packing operation as necessary. The region-wise packing processor may forward metadata generated in the region-wise packing process to the metadata processor. Metadata generated in the region-wise packing processor may include a rotation degree, size and the like of each region.

The aforementioned stitcher, projection processor and/or region-wise packing processor may be integrated into a single hardware component according to an embodiment.

The metadata processor can process metadata which may be generated in a capture process, a stitching process, a projection process, a region-wise packing process, an encoding process, an encapsulation process and/or a process for transmission. The metadata processor can generate 360-degree video related metadata using such metadata. According to an embodiment, the metadata processor may generate the 360-degree video related metadata in the form of a signaling table. 360-degree video related metadata may also be called metadata or 360-degree video related signaling information according to signaling context. Further, the metadata processor may forward the acquired or generated metadata to internal elements of the 360-degree video transmission apparatus as necessary. The metadata processor may forward the 360-degree video related metadata to the data encoder, the encapsulation processor and/or the transmission processor such that the 360-degree video related metadata can be transmitted to a reception side.

The data encoder can encode the 360-degree video data projected on the 2D image and/or region-wise packed 360-degree video data. The 360-degree video data can be encoded in various formats.

The encapsulation processor can encapsulate the encoded 360-degree video data and/or 360-degree video related metadata in a file format. Here, the 360-degree video related metadata may be received from the metadata processor. The encapsulation processor can encapsulate the data in a file format such as ISOBMFF, CFF or the like or process the data into a DASH segment or the like. The encapsulation processor may include the 360-degree video related metadata in a file format. The 360-degree video related metadata may be included in a box having various levels in SOBMFF or may be included as data of a separate track in a file, for example. According to an embodiment, the encapsulation processor may encapsulate the 360-degree video related metadata into a file. The transmission processor may perform processing for transmission on the encapsulated 360-degree video data according to file format. The transmission processor may process the 360-degree video data according to an arbitrary transmission protocol. The processing for transmission may include processing for delivery over a broadcast network and processing for delivery over a broadband. According to an embodiment, the transmission processor may receive 360-degree video related metadata from the metadata processor as well as the 360-degree video data and perform the processing for transmission on the 360-degree video related metadata.

The transmitter can transmit the 360-degree video data and/or the 360-degree video related metadata processed for transmission through a broadcast network and/or a broadband. The transmitter may include an element for transmission through a broadcast network and/or an element for transmission through a broadband.

According to an embodiment of the 360-degree video transmission apparatus according to the present disclosure, the 360-degree video transmission apparatus may further include a data storage unit (not shown) as an internal/external element. The data storage unit may store encoded 360-degree video data and/or 360-degree video related metadata before the encoded 360-degree video data and/or 360-degree video related metadata are delivered to the transmission processor. Such data may be stored in a file format such as ISOBMFF. Although the data storage unit may not be required when 360-degree video is transmitted in real time, encapsulated 360 data may be stored in the data storage unit for a certain period of time and then transmitted when the encapsulated 360 data is delivered over a broadband.

According to another embodiment of the 360-degree video transmission apparatus according to the present disclosure, the 360-degree video transmission apparatus may further include a (transmission side) feedback processor and/or a network interface (not shown) as internal/external elements. The network interface can receive feedback information from a 360-degree video reception apparatus according to the present disclosure and forward the feedback information to the transmission side feedback processor. The transmission side feedback processor can forward the feedback information to the stitcher, the projection processor, the region-wise packing processor, the data encoder, the encapsulation processor, the metadata processor and/or the transmission processor. According to an embodiment, the feedback information may be delivered to the metadata processor and then delivered to each internal element. Internal elements which have received the feedback information can reflect the feedback information in the following 360-degree video data processing.

According to another embodiment of the 360-degree video transmission apparatus according to the present disclosure, the region-wise packing processor may rotate regions and map the rotated regions on a 2D image. Here, the regions may be rotated in different directions at different angles and mapped on the 2D image. Region rotation may be performed in consideration of neighboring parts and stitched parts of 360-degree video data on a spherical surface before projection. Information about region rotation, that is, rotation directions, angles and the like may be signaled through 360-degree video related metadata. According to another embodiment of the 360-degree video transmission apparatus according to the present disclosure, the data encoder may perform encoding differently for respective regions. The data encoder may encode a specific region in high quality and encode other regions in low quality. The transmission side feedback processor may forward feedback information received from the 360-degree video reception apparatus to the data encoder such that the data encoder can use encoding methods differentiated for respective regions. For example, the transmission side feedback processor may forward viewport information received from a reception side to the data encoder. The data encoder may encode regions including an area indicated by the viewport information in higher quality (UHD and the like) than that of other regions.

According to another embodiment of the 360-degree video transmission apparatus according to the present disclosure, the transmission processor may perform processing for transmission differently for respective regions. The transmission processor may apply different transmission parameters (modulation orders, code rates, and the like) to the respective regions such that data delivered to the respective regions have different robustness.

Here, the transmission side feedback processor may forward feedback information received from the 360-degree video reception apparatus to the transmission processor such that the transmission processor can perform transmission processes differentiated for respective regions. For example, the transmission side feedback processor may forward viewport information received from a reception side to the transmission processor. The transmission processor may perform a transmission process on regions including an area indicated by the viewport information such that the regions have higher robustness than other regions.

The above-described internal/external elements of the 360-degree video transmission apparatus according to the present disclosure may be hardware elements. According to an embodiment, the internal/external elements may be changed, omitted, replaced by other elements or integrated.

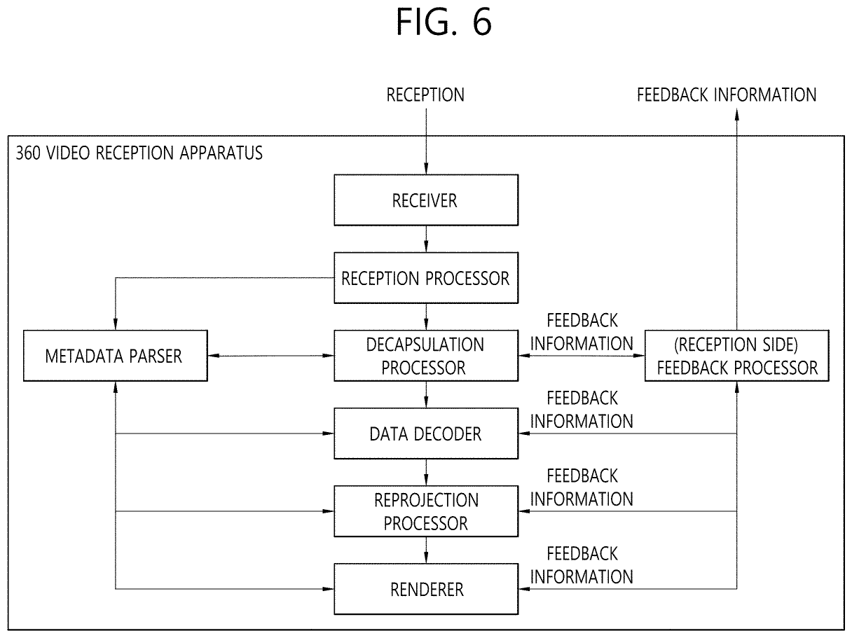

FIG. 6 is a view schematically illustrating a configuration of a 360-degree video reception apparatus to which the present disclosure is applicable.

The 360-degree video reception apparatus according to the present disclosure can perform operations related to the above-described processing process and/or the rendering process. The 360-degree video reception apparatus may include a receiver, a reception processor, a decapsulation processor, a data decoder, a metadata parser, a (reception side) feedback processor, a re-projection processor and/or a renderer as internal/external elements. A signaling parser may be called the metadata parser.

The receiver can receive 360-degree video data transmitted from the 360-degree video transmission apparatus according to the present disclosure. The receiver may receive the 360-degree video data through a broadcast network or a broadband depending on a channel through which the 360-degree video data is transmitted.

The reception processor can perform processing according to a transmission protocol on the received 360-degree video data. The reception processor may perform a reverse process of the process of the aforementioned transmission processor such that the reverse process corresponds to processing for transmission performed at the transmission side. The reception processor can forward the acquired 360-degree video data to the decapsulation processor and forward acquired 360-degree video related metadata to the metadata parser. The 360-degree video related metadata acquired by the reception processor may have the form of a signaling table.

The decapsulation processor can decapsulate the 360-degree video data in a file format received from the reception processor. The decapsulation processor can acquired 360-degree video data and 360-degree video related metadata by decapsulating files in ISOBMFF or the like. The decapsulation processor can forward the acquired 360-degree video data to the data decoder and forward the acquired 360-degree video related metadata to the metadata parser. The 360-degree video related metadata acquired by the decapsulation processor may have the form of a box or a track in a file format. The decapsulation processor may receive metadata necessary for decapsulation from the metadata parser as necessary.

The data decoder can decode the 360-degree video data. The data decoder may receive metadata necessary for decoding from the metadata parser. The 360-degree video related metadata acquired in the data decoding process may be forwarded to the metadata parser.

The metadata parser can parse/decode the 360-degree video related metadata. The metadata parser can forward acquired metadata to the data decapsulation processor, the data decoder, the re-projection processor and/or the renderer.

The re-projection processor can perform re-projection on the decoded 360-degree video data. The re-projection processor can re-project the 360-degree video data on a 3D space. The 3D space may have different forms depending on 3D models. The re-projection processor may receive metadata necessary for re-projection from the metadata parser. For example, the re-projection processor may receive information about the type of a used 3D model and detailed information thereof from the metadata parser. According to an embodiment, the re-projection processor may re-project only 360-degree video data corresponding to a specific area of the 3D space on the 3D space using metadata necessary for re-projection.

The renderer can render the re-projected 360-degree video data. As described above, re-projection of 360-degree video data on a 3D space may be represented as rendering of 360-degree video data on the 3D space. When two processes simultaneously occur in this manner, the re-projection processor and the renderer may be integrated and the renderer may perform the processes. According to an embodiment, the renderer may render only a part viewed by a user according to viewpoint information of the user.

The user may view a part of the rendered 360-degree video through a VR display or the like. The VR display is a device which reproduces 360-degree video and may be included in a 360-degree video reception apparatus (tethered) or connected to the 360-degree video reception apparatus as a separate device (un-tethered).

According to an embodiment of the 360-degree video reception apparatus according to the present disclosure, the 360-degree video reception apparatus may further include a (reception side) feedback processor and/or a network interface (not shown) as internal/external elements. The reception side feedback processor can acquire feedback information from the renderer, the re-projection processor, the data decoder, the decapsulation processor and/or the VR display and process the feedback information. The feedback information may include viewport information, head orientation information, gaze information, and the like. The network interface can receive the feedback information from the reception side feedback processor and transmit the feedback information to a 360-degree video transmission apparatus.

As described above, the feedback information may be consumed at the reception side as well as being transmitted to the transmission side. The reception side feedback processor may forward the acquired feedback information to internal elements of the 360-degree video reception apparatus such that the feedback information is reflected in processes such as rendering. The reception side feedback processor can forward the feedback information to the renderer, the re-projection processor, the data decoder and/or the decapsulation processor. For example, the renderer can preferentially render an area viewed by the user using the feedback information. In addition, the decapsulation processor and the data decoder can preferentially decapsulate and decode an area being viewed or will be viewed by the user.

The above-described internal/external elements of the 360-degree video reception apparatus according to the present disclosure may be hardware elements. According to an embodiment, the internal/external elements may be changed, omitted, replaced by other elements or integrated. According to an embodiment, additional elements may be added to the 360-degree video reception apparatus.

Another aspect of the present disclosure may pertain to a method for transmitting a 360-degree video and a method for receiving a 360-degree video. The methods for transmitting/receiving a 360-degree video according to the present disclosure may be performed by the above-described 360-degree video transmission/reception apparatuses or embodiments thereof.

Embodiments of the above-described 360-degree video transmission/reception apparatuses and transmission/reception methods and embodiments of the internal/external elements of the apparatuses may be combined. For example, embodiments of the projection processor and embodiments of the data encoder may be combined to generate as many embodiments of the 360-degree video transmission apparatus as the number of cases. Embodiments combined in this manner are also included in the scope of the present disclosure.

There may be a panorama video or a 360 video service as a utilization example in which the present disclosure may be implemented. In the panorama video and the 360 video service, a region which can be actually watched by a user may be present out of a region (i.e., a displayed region) which may be seen on a screen. In this case, there may be a problem in that picture quality of an image is deteriorated because a large amount of video data is forwarded compared to a limited transmission bandwidth.

As one of schemes for solving the above-described problem, a scheme for segmenting an input image into a plurality of regions, differently encoding video quality of each of the regions and transmitting the image may be taken into consideration. Specifically, for example, in the case of high efficiency video coding (HEVC), there may be a method of compressing major regions of regions at a compression ratio and compressing the remaining regions at a high compression ratio based on motion-constrained tile sets (MCTS). Furthermore, if encoding is performed using scalable high efficiency video coding (SHVC), there may be a method of producing a high picture quality video using the enhancement layer with respect to major regions only by encoding the enhancement layer based on the MCTS.

Meanwhile, if a transmission bandwidth is very limited or a picture quality difference between a high picture quality region and a low picture quality region is large in order to maximize picture quality of major videos, unwanted problems, such as a problem in that a region boundary appears if a displayed region gets out of the major regions, may occur.

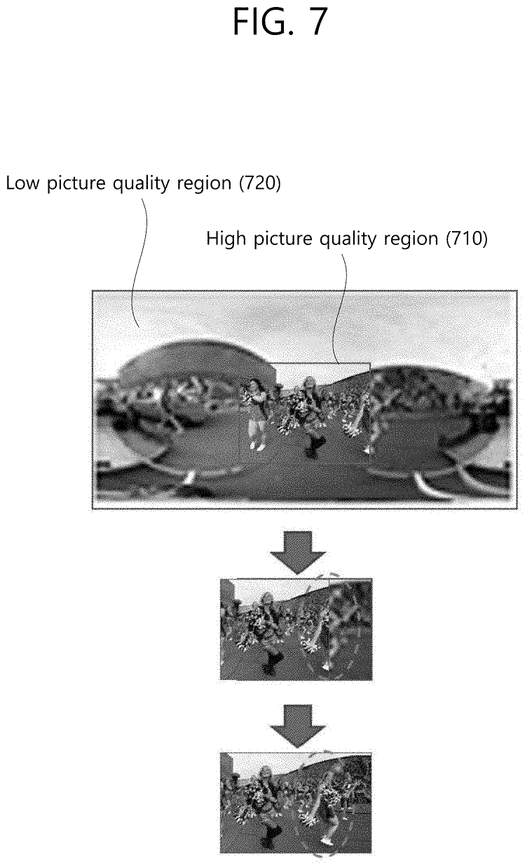

FIG. 7 illustrates an example in which a boundary artifact between a high picture quality region and a low picture quality region in a picture projected through equirectangular projection (EPR) is prevented. Referring to FIG. 7, 360-degree video data may be projected through the ERP. The ERP may be indicated as an equirectangular projection scheme. Metadata indicating the projection scheme may include a projection_scheme field. That is, the projection_scheme field may indicate a projection scheme of a picture to which 360-degree video data has been mapped. The projection_scheme field may be indicated as a projection_type field.

Meanwhile, if 360-degree video data is projected through the ERP, for example, stitched 360-degree video data may be indicated on a spherical surface. The 360-degree video data may be projected as a single picture whose continuity on the spherical surface is maintained. Furthermore, as shown in FIG. 7, the 360-degree video data may be mapped to at least one region within the projected picture. Referring to FIG. 7, the picture may include a high picture quality region 710 and a low picture quality region 720. A viewport including the high picture quality region 710 and the low picture quality region 720 may be generated. The viewport may indicate a region which is now watched by a user in a 360-degree video. The viewport may include a boundary artifact occurring due to a picture quality difference between the high picture quality region 710 and the low picture quality region 720.

Meanwhile, schemes for preventing the above-described problems including the boundary artifact may include the following schemes.

1) There may be a scheme for enhancing picture quality of a newly displayed low picture quality region 720 into high picture quality using information by which the low picture quality region 720 can be produced into high picture quality. For example, if an SHVC-based service is provided, the enhancement layer of the low picture quality region 720 may be requested or the enhancement layer of the low picture quality region 720 may be decoded to improve picture quality of the low picture quality region 720.

2) Alternatively, a deteriorated portion may be reconstructed through post-processing for the low picture quality region 720. In this case, the post-processing may include image enhancement, restoration, and compensation.

3) Alternatively, blending or smoothing processing may be performed so that a boundary between the low picture quality region 720 and existing displayed major regions (i.e., the high picture quality region) is seen naturally.

In order for the schemes to be performed, information regarding that each region within a picture has which picture quality deterioration may be used and may be necessary. The present disclosure proposes a method of encoding information regarding that each region has which picture quality deterioration, that is, region-wise quality information, and providing the information in a video level and/or a system level.

For example, as a method of transmitting the region-wise quality information, metadata for region-wise quality indication information may be transmitted.

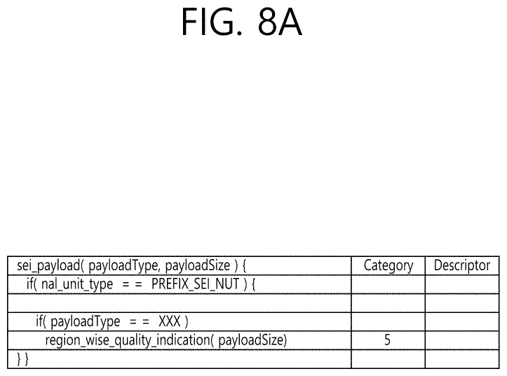

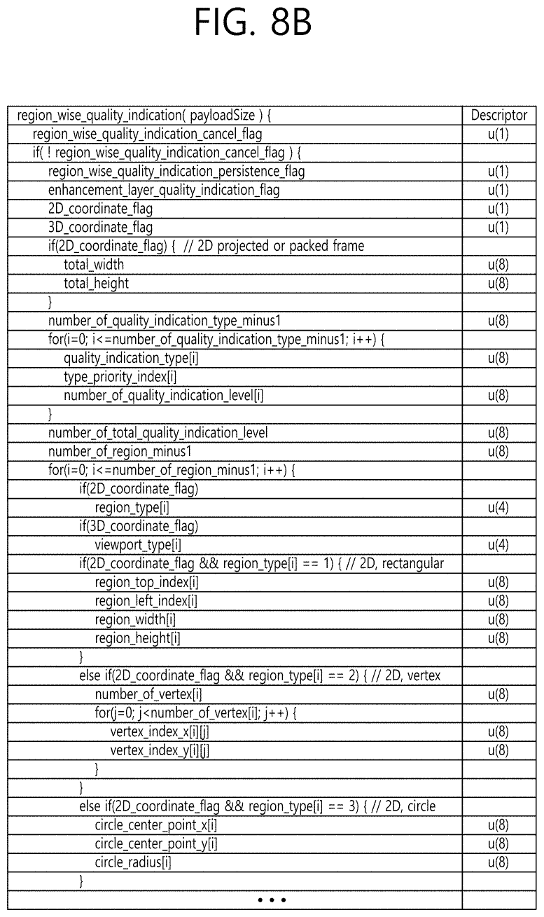

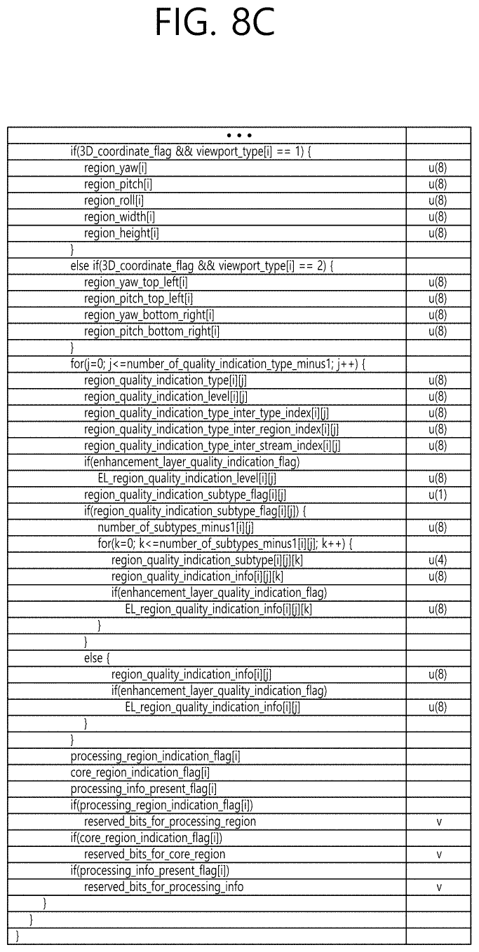

FIGS. 8a to 8c illustrate examples of the metadata for region-wise quality indication information. As shown in FIGS. 8a to 8c, region-wise quality indication information may be transmitted in the metadata form of a video codec. For example, specifically, the metadata for region-wise quality indication information may be transmitted through the SEI message of an HEVC codec. Furthermore, if region-wise quality indication information is information essentially used in a video level, the region-wise quality indication information may be transmitted through a video parameter set (VPS), a sequence parameter set (SPS), or a picture parameter set (PPS). Furthermore, information identical or similar to the region-wise quality indication information may be transmitted through a digital wired/wireless interface or a file format of a system level in addition to the video level.

FIGS. 8a to 8c illustrate examples of the metadata for region-wise quality indication information. Referring to FIG. 8a, if a value of payloadType indicates a specific value, the metadata for region-wise quality indication information may be transmitted. Detailed metadata for region-wise quality indication information may be the same as those shown in FIGS. 8b to 8c.

Furthermore, referring to FIGS. 8b to 8c, the region-wise quality indication information may be included and transmitted in a syntax for information on a region-wise packing process. That is, the metadata for region-wise quality indication information may be included in the metadata for the region-wise packing process. Meanwhile, the metadata for region-wise quality indication information may be transmitted through a separate syntax.

Referring to FIG. 8b, the metadata for region-wise quality indication information may include a region_wise_quality_indication_cancel_flag field. The region_wise_quality_indication_cancel_flag field may indicate whether previously received metadata for region-wise quality indication information is used. That is, the region_wise_quality_indication_cancel_flag field may indicate whether metadata for region-wise quality indication information transmitted through an SEI message prior to the encoding/decoding process of a current picture (or a current frame) is used as metadata for region-wise quality indication information of the current picture. For example, when a value of the region_wise_quality_indication_cancel_flag field is 1, the region_wise_quality_indication_cancel_flag field may indicate that the metadata for region-wise quality indication information transmitted prior to the encoding/decoding process of the current picture is not used as the region-wise quality indication information of the current picture. Furthermore, when a value of the region_wise_quality_indication_cancel_flag field is 0, the region_wise_quality_indication_cancel_flag field may indicate that the metadata for region-wise quality indication information transmitted prior to the encoding/decoding process of the current picture is used as the region-wise quality indication information of the current picture.

Furthermore, referring to FIG. 8b, the metadata for region-wise quality indication information may include a region_wise_quality_indication_persistence_flag field. The region_wise_quality_indication_persistence_flag field may indicate whether metadata for region-wise quality indication information of a current picture may be used in pictures (or frames) positioned behind the current picture (or a current frame) in terms of the time sequence, that is, pictures posterior to the current picture (or the current frame) in terms of the time sequence. For example, when a value of the region_wise_quality_indication_persistence_flag field is 1, the metadata for region-wise quality indication information of the current picture may indicate that the metadata may be used in pictures (or frames) posterior to the current picture (or the current frame) in terms of the time sequence. Furthermore, when a value of the region_wise_quality_indication_persistence_flag field is 0, the metadata for region-wise quality indication information of the current picture may indicate that the metadata may be used in pictures (or frames) posterior to the current picture (or the current frame) in terms of the time sequence.

Furthermore, referring to FIG. 8b, the metadata for region-wise quality indication information may include an enhancement_layer_quality_indication_flag field. The enhancement_layer_quality_indication_flag field may indicate whether layered coding has been performed. In other words, the enhancement_layer_quality_indication_flag field may indicate whether metadata for region-wise quality indication information on a base layer and region-wise quality indication information on an enhancement layer are transmitted. For example, when a value of the enhancement_layer_quality_indication_flag field is 1, the enhancement_layer_quality_indication_flag field may indicate that metadata for region-wise quality indication information on a base layer and metadata for region-wise quality indication information on an enhancement layer are transmitted.

Meanwhile, in order to represent the position of a region within a current picture, two schemes may be supported. The schemes may include a scheme indicating a position on a 2D image (i.e., the current picture) to which 360-degree video data has been mapped and a scheme indicating a position on a 3D space, for example a spherical surface. Both the schemes may be used or only any one of the two schemes may be selected and used.

For example, referring to FIG. 8b, the metadata for region-wise quality indication information may include a 2D_coordinate_flag field. The 2D_coordinate_flag field may indicate whether a position on a 2D image, that is, information on a 2D coordinate system is transmitted. The 2D image indicated by the 2D coordinate system, that is, a current picture may indicate an image defined in a rectangle frame. The current picture may indicate a projected picture produced by projecting 360-degree video data on to a 2D plane or a packed picture of the projected picture redisposed in a rectangle frame according to purposes. The projected picture may also be indicated as a projected frame. Furthermore, the packed picture may be also indicated as a packed frame. A detailed expression method of indicating the 2D coordinate system may be different depending on region_type. Meanwhile, for example, when a value of the 2D_coordinate_flag field is 1, the 2D_coordinate_flag field may indicate information on the 2D coordinate system is transmitted. Furthermore, when a value of the 2D_coordinate_flag field is 0, the 2D_coordinate_flag field may indicate that information on a 2D coordinate system is not transmitted.

Furthermore, referring to FIG. 8b, the metadata for region-wise quality indication information may include a total_width field and a total_height field. The total_width field and the total_height field may be transmitted when the 2D_coordinate_flag field indicates that information on a 2D coordinate system is transmitted. That is, when a value of the 2D_coordinate_flag field is 1, the total_width field and the total_height field may be transmitted. The total_width field and the total_height field may indicate the width and height of a current picture, respectively.

Furthermore, referring to FIG. 8b, the metadata for region-wise quality indication information may include a region_type field. The region_type field may be transmitted when the 2D_coordinate_flag field indicates that information on a 2D coordinate system is transmitted. That is, when a value of the 2D_coordinate_flag field is 1, the region_type field may be transmitted. The region_type field may indicate the type of region included in a current picture. The type of region indicated by a value of the region_type field may be derived like the following table.

TABLE 1

| region_type | Descriptor |
|---|---|
| 0 | reserved |
| 1 | rectangular |
| 2 | vertex |
| 3 | circle |
| 4-15 | reserved |

When a value of the region_type field is 1, the region_type field may indicate the type of the region of the current picture as a rectangle. When a value of the region_type field is 2, the region_type field may indicate the type of the region of the current picture as a given closed figure. When a value of the region_type field is 3, the region_type field may indicate the type of the region of the current picture as a circle.

In other words, when a value of the region_type field is 1, the type of the region of the current picture may be derived as a rectangle. When a value of the region_type field is 2, the type of the region of the current picture may be derived as a given closed figure. When a value of the region_type field is 3, the type of the region of the current picture may be derived as a circle.

Furthermore, referring to FIG. 8b, the metadata for region-wise quality indication information may include a 3D_coordinate_flag field. The 3D_coordinate_flag field may indicate whether a position on a 3D space, that is, information on a 3D coordinate system is transmitted. The 3D space indicated by the 3D coordinate system may indicate a 3D space itself taken into consideration in a 360-degree video. For example, the 3D space may indicate a sphere surface to which 360-degree video data included in a current picture is mapped. A detailed expression method of indicating the 3D coordinate system may be different depending on viewport_type to be described later. Meanwhile, for example, if a value of the 3D_coordinate_flag field is 1, the 3D_coordinate_flag field may indicate that information on a 3D coordinate system is transmitted. Furthermore, if a value of the 3D_coordinate_flag field is 0, the 3D_coordinate_flag field may indicate that information on a 3D coordinate system is not transmitted.

Furthermore, referring to FIG. 8b, the metadata for region-wise quality indication information may include a viewport_type field. The viewport_type field may be transmitted if the 3D_coordinate_flag field indicates information on a 3D coordinate system is transmitted. That is, if a value of the 3D_coordinate_flag field is 1, the viewport_type field may be transmitted. The viewport_type field may indicate a type indicating a position on the 3D space, that is, the type of the 3D coordinate system. The type of the 3D coordinate system indicated by a value of the viewport_type field may be derived like the following table.

TABLE 2

| viewport_type | Descriptor |
|---|---|
| 0 | reserved |
| 1 | four great circle |
| 2 | two great circle tow small circle |
| 3-15 | reserved |

If a value of the viewport_type field is 1, the viewport_type field may indicate the type of the 3D coordinate system as a type indicating a sphere surface based on four circles having the center of a sphere indicating the 3D space as the center of a circle. In this case, the circle having the center of the sphere as the center of the circle may be called a great circle. In other words, if a value of the viewport_type field is 1, the viewport_type field may indicate the type of the 3D coordinate system as the type indicating a sphere surface based on four great circles. That is, if a value of the viewport_type field is 1, the type of the 3D coordinate system may be derived as a type indicating a sphere surface based on four circles having the center of a sphere indicating the 3D space as the center of a circle. In other words, if a value of the viewport_type field is 1, the type of the 3D coordinate system may be derived as a type indicating a sphere surface based on four great circles.

Furthermore, if a value of the viewport_type field is 2, the viewport_type field may indicate the type of the 3D coordinate system as a type indicating a sphere surface based on two circles having the center of the sphere indicating the 3D space as the center of a circle, that is, two great circles, and two circles horizontal to a plane configured with the equator. In this case, the circle horizontal to the plane configured with the equator may be called a small circle. In other words, if a value of the viewport_type field is 2, the viewport_type field may indicate the type of the 3D coordinate system as a type indicating the sphere surface based on two great circles and two small circles. That is, if a value of the viewport_type field is 2, the type of the 3D coordinate system may be derived as a type indicating the sphere surface based on two circles having the center of a sphere indicating the 3D space as the center of a circle, that is, two great circles, and two circles horizontal to a plane configured with the equator. In other words, if a value of the viewport_type field is 2, the type of the 3D coordinate system may be derived as a type indicating the sphere surface based on two great circles and two small circles.

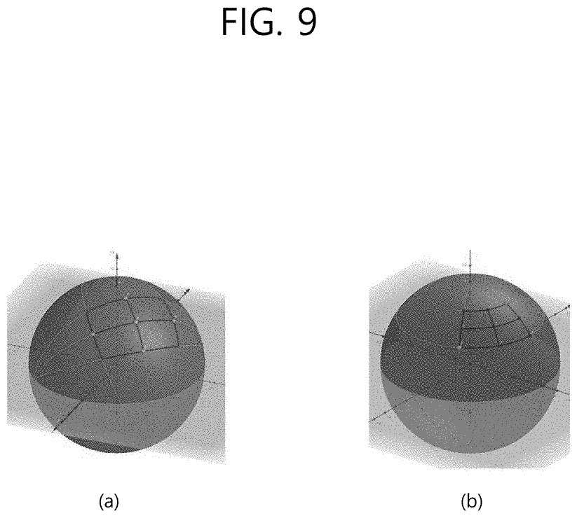

FIG. 9 illustrates examples of types indicating the 3D space. Referring to FIG. 9(a), a region on a sphere surface to which the current picture has been mapped may be indicated based on four circles having the center of a sphere indicating the 3D space as the center of a circle, that is, four great circles. Furthermore, referring to FIG. 9(b), a region on a sphere surface to which the current picture has been mapped may be indicated based on two circles having the center of a sphere indicating the 3D space as the center of a circle and two circles horizontal to a plane configured with the equator. In other words, a region on a sphere surface to which the current picture has been mapped may be indicated based on two great circles and two small circles.

Meanwhile, methods of representing a region on a spherical surface different from those of the above-described types and methods of indicating a region on a different 3D space, such as a cubic, in addition to a spherical surface as a type indicating the 3D space may be additionally defined. The methods of representing a region on a spherical surface different from those of the above-described types may include a method of indicating a region on a sphere surface to which the current picture has been mapped based on a center and a yaw, a pitch range and a method of representing coordinates corresponding to the intersection point of great circles and/or small circles.

Referring back to FIG. 8b, the metadata for region-wise quality indication information may include a number_of_quality_indication_type_minus1 field. The number_of_quality_indication_type_minus1 field may indicate the number of picture quality classification criteria of the current picture. In this case, the picture quality classification criterion may also be indicated as a quality type. In other words, the picture quality classification criterion may indicate the number of picture quality classification criteria indicated by quality indication information on the current picture. The picture quality classification criteria may include spatial resolution, a degree of compression, a bit depth, a color space or a color, a brightness range, a frame rate, etc. Picture quality of the current picture may be different depending on spatial resolution, a degree of compression, a bit depth, a color space or a color, a brightness range or a frame rate. Quality indication information of the current picture based on a plurality of picture quality classification criteria of the current picture may be transmitted. A value obtained by adding 1 to a value of the number_of_quality_indication_type_minus1 field may indicate the number of quality indication information of the current picture. Meanwhile, if quality indication information on the current picture is transmitted through an SEI message, quality indication information of the current picture may have included information based on at least one picture quality classification criterion.

Furthermore, referring to FIG. 8b, the metadata for region-wise quality indication information may include a quality_indication_type[i] field. The quality_indication_type[i] field may indicate the i-th picture quality classification criterion of the current picture. That is, in other words, the quality_indication_type[i] field may indicate the i-th picture quality classification criterion of the current picture. Picture quality classification criteria indicated by values of the quality_indication_type[i] field may be derived like the following table.

TABLE 3

| quality_indication_type | Descriptor |
|---|---|
| 0 | reserved |
| 1 | spatial scaling |
| 2 | compression |
| 3 | bitdepth |
| 4 | color |
| 5 | dynamic range |
| 6 | frame rate |
| 7 | detail |
| 8-15 | reserved |

Quality indication information on a plurality of picture quality classification criteria for the current picture may be transmitted. The quality_indication_type[i] field indicating a picture quality classification criterion for each of the pieces of the quality indication information may be transmitted.

If a value of the quality_indication_type[i] is 1, the i-th picture quality classification criterion of the current picture may be derived as spatial resolution. If a value of the quality_indication_type[i] is 2, the i-th picture quality classification criterion of the current picture may be derived as a degree of compression. If a value of the quality_indication_type[i] is 3, the i-th picture quality classification criterion of the current picture may be derived as a bit depth. If a value of the quality_indication_type[i] is 4, the i-th picture quality classification criterion of the current picture may be derived as a color. If a value of the quality_indication_type[i] is 5, the i-th picture quality classification criterion of the current picture may be derived as a brightness range. If a value of the quality_indication_type[i] is 6, the i-th picture quality classification criterion of the current picture may be derived as a frame rate.

Furthermore, referring to FIG. 8b, the metadata for region-wise quality indication information may include a total_quality_indication_level[i] field. The total_quality_indication_level[i] field may indicate the number of classification branches of the i-th picture quality classification criterion of the current picture. In other words, the total_quality_indication_level[i] field may indicate a total number of levels classified by the i-th picture quality classification criterion of the current picture. For example, if levels classified by the i-th picture quality classification criterion are 1 to n, a value of the total_quality_indication_level[i] field may be derived as n.

Furthermore, referring to FIG. 8b, the metadata for region-wise quality indication information may include a number_of_quality_indication_level[i] field. The number_of_quality_indication_level[i] field may indicate a level of the i-th picture quality classification criterion of the current picture. The level of the i-th picture quality classification criterion of the current picture may be derived based on the quality_indication_type[i] field and the number_of_quality_indication_level[i] field. For example, if a value of the quality_indication_type[i] field of the current picture is 2 and a value of the number_of_quality_indication_level[i] field is 1, a level of picture quality indicated based on a degree of compression of the current picture may be derived as 2. Quality information on the current picture may be derived based on the quality_indication_type[i] field and the number_of_quality_indication_level[i] field.

Furthermore, referring to FIG. 8b, the metadata for region-wise quality indication information may include a number_of_total_quality_indication_level field. The number_of_total_quality_indication_level field may indicate information on which picture quality is classified, that is, a total number of pieces of quality indication information. In other words, the number_of_total_quality_indication_level field may indicate a total number of pieces of quality indication information on the current picture.

Furthermore, referring to FIG. 8b, the metadata for region-wise quality indication information may include a number_of_region_minus1 field. The number_of_region_minus1 field may indicate information on a picture quality difference, that is, the number of regions of the current picture in which the quality indication information is signaled. The number of regions of the current picture in which the quality indication information is signaled may be derived as a value obtained by adding 1 to a value indicated by the number_of_region_minus1 field.

Furthermore, referring to FIG. 8b, the metadata for region-wise quality indication information may include a region_top_index field, a region_left_index field, a region_width field and a region_height field. The region_top_index field, the region_left_index field, the region_width field and the region_height field may be transmitted if the 2D_coordinate_flag field indicates that information on a 2D coordinate system is transmitted and the region_type field indicates that a type of the region of the current picture as a rectangle. Specifically, for example, if a value of the 2D_coordinate_flag field is 1 and a value of the region_type field is 1, the region_top_index field, the region_left_index field, the region_width field and the region_height field for the region of the current picture may be transmitted. The region_top_index field and the region_left_index field may indicate the x component and y component of a left top sample of a region within the current picture. Furthermore, the region_width field and the region_height field may indicate the width and height of the region within the current picture.

Furthermore, referring to FIG. 8b, the metadata for region-wise quality indication information may include a number_of_vertex field, a vertex_index_x field and a vertex_index_y field. The number_of_vertex field, the vertex_index_x field and the vertex_index_y field may be transmitted if the 2D_coordinate_flag field indicates that information on a 2D coordinate system is transmitted and the region_type field indicates that a type of the region of the current picture is a given closed figure. Specifically, for example, if a value of the 2D_coordinate_flag field is 1 and a value of the region_type field is 2, the number_of_vertex field, the vertex_index_x field and the vertex_index_y field for the region of the current picture may be transmitted. The number_of_vertex field may indicate the number of points of a given closed figure indicating the region of the current picture, that is, the number of vertexes of the region. The vertex_index_x field and the vertex_index_y field may indicate the x component and y component of a vertex of the region. That is, the vertex_index_x field and the vertex_index_y field may indicate the x coordinates and y coordinates of a vertex location of the region.

Furthermore, referring to FIG. 8b, the metadata for region-wise quality indication information may include a circle_center_point_x field, a circle_center_point_y field and a circle_radius field. The circle_center_point_x field, the circle_center_point_y field and the circle_radius field may be transmitted if the 2D_coordinate_flag field indicates that information on a 2D coordinate system is transmitted and that the region_type field indicates a type of the region of the current picture as a circle. Specifically, for example, if a value of the 2D_coordinate_flag field is 1 and a value of the region_type field is 3, the circle_center_point_x field, the circle_center_point_y field and the circle_radius field for the region of the current picture may be transmitted. The circle_center_point_x field and the circle_center_point_x field may indicate the x component and y component of the center of a circle indicating the region of the current picture. That is, the circle_center_point_x field and the circle_center_point_x field may indicate the x component and y component of the center of the region of the current picture. Furthermore, the circle_radius field may indicate the radius of a circle indicating the region of the current picture, that is, the radius of the region.

Furthermore, referring to FIG. 8b, the metadata for region-wise quality indication information may include a region_yaw field, a region_pitch field, a region_roll field, a region_width field and a region_height field. The region_yaw field, the region_pitch field, the region_roll field, the region_width field and the region_height field may be transmitted if the 3D_coordinate_flag field indicates that information on a 3D coordinate system is transmitted and the viewport_type field indicates that a type of the 3D coordinate system is a type indicating the sphere surface based on four great circles. Specifically, for example, if a value of the 3D_coordinate_flag field is 1 and a value of the viewport_type field is 1, the region_yaw field, the region_pitch field, the region_roll field, the region_width field and the region_height field for the region of the current picture may be transmitted. The region_yaw field, the region_pitch field and the region_roll field may indicate the position of the center of the region of the current picture on a 3D space, for example, a spherical surface. Specifically, the location of each point on the spherical surface may be indicated based on aircraft principal axes. For example, axes forming a 3D may be called a pitch axis, a yaw axis, and a roll axis, respectively, and the location of each point on the spherical surface may be represented through a pitch, a yaw, and a roll. In this specification, they may be abbreviated and represented as a pitch, a yaw, and a roll to a pitch direction, a yaw direction, and a roll direction. The region_yaw field may indicate a yaw value of the center of the region on the spherical surface. The region_pitch field may indicate a pitch value of the center of the region on the spherical surface. The region_roll field may indicate a roll value of the center of the region on the spherical surface. Furthermore, the region_width field and the region_height field may indicate the width and height of the region on the spherical surface. Alternatively, the region_width field and the region_height field may indicate a yaw range (i.e., a horizontal range) and pitch range (i.e., vertical range) of the region on the spherical surface.

Furthermore, referring to FIG. 8b, the metadata for region-wise quality indication information may include a region_yaw_top_left field, a region_pitch_top_left field, a region_yaw_bottom_right field and a region_pitch_bottom_right field. The region_yaw_top_left field, the region_pitch_top_left field, the region_yaw_bottom_right field and the region_pitch_bottom_right field may be transmitted if the 3D_coordinate_flag field indicates that information on a 3D coordinate system is transmitted and the viewport_type field indicates that a type of the 3D coordinate system is a type indicating the sphere surface based on two great circles and two small circles. Specifically, for example, if a value of the 3D_coordinate_flag field is 1 and a value of the viewport_type field is 2, the region_yaw_top_left field, the region_pitch_top_left field, the region_yaw_bottom_right field and the region_pitch_bottom_right field for the region of the current picture may be transmitted. The region_yaw_top_left field and the region_pitch_top_left field may indicate a yaw value and pitch value of the left top sample of the region of the current picture on a 3D space, for example, a spherical surface. Furthermore, the region_yaw_bottom_right field and the region_pitch_bottom_right field may indicate a yaw value and pitch value of the right bottom sample of the region on the spherical surface. Meanwhile, metadata for the yaw value and pitch value of the left bottom sample of the region and/or the yaw value and pitch value of the right top sample on the spherical surface may be transmitted. Alternatively, metadata for the coordinates of a position, that is, a reference for the region, and metadata for the yaw range and pitch range of the region may be transmitted.

Furthermore, referring to FIG. 8b, the metadata for region-wise quality indication information may include a region_quality_indication_type[i][j] field. The region_quality_indication_type[i][j] field may indicate a meaning similar to that of the quality_indication_type[i] field for the current picture. That is, the region_quality_indication_type[i][j] field may indicate the j-th picture quality classification criterion of the i-th region of the current picture.

Specifically, for example, if a value of the region_quality_indication_type[i][j] field is 1, the region_quality_indication_type[i][j] field may indicate that the j-th picture quality classification criterion of the i-th region is spatial resolution. That is, if a value of the region_quality_indication_type[i][j] field is 1, the j-th picture quality classification criterion of the i-th region may be derived as spatial resolution.

Furthermore, if a value of the region_quality_indication_type[i][j] field is 2, the region_quality_indication_type[i][j] field may indicate that the j-th picture quality classification criterion of the i-th region is a degree of compression. That is, if a value of the region_quality_indication_type[i][j] field is 2, the j-th picture quality classification criterion of the i-th region may be derived as a degree of compression.

Furthermore, if a value of the region_quality_indication_type[i][j] field is 3, the region_quality_indication_type[i][j] field may indicate that the j-th picture quality classification criterion of the i-th region is a bit depth. That is, if a value of the region_quality_indication_type[i][j] field is 3, the j-th picture quality classification criterion of the i-th region may be derived as a bit depth.

Furthermore, if a value of the region_quality_indication_type[i][j] field is 4, the region_quality_indication_type[i][j] field may indicate that the j-th picture quality classification criterion of the i-th region is a color. That is, if a value of the region_quality_indication_type[i][j] field is 4, the j-th picture quality classification criterion of the i-th region may be derived as a color.

Furthermore, if a value of the region_quality_indication_type[i][j] field is 5, the region_quality_indication_type[i][j] field may indicate that the j-th picture quality classification criterion of the i-th region is a brightness range. That is, if a value of the region_quality_indication_type[i][j] field is 5, the j-th picture quality classification criterion of the i-th region may be derived as a brightness range.

Furthermore, if a value of the region_quality_indication_type[i][j] field is 6, the region_quality_indication_type[i][j] field may indicate that the j-th picture quality classification criterion of the i-th region is a frame rate. That is, if a value of the region_quality_indication_type[i][j] field is 6, the j-th picture quality classification criterion of the i-th region may be derived as a frame rate.

Furthermore, referring to FIG. 8b, the metadata for region-wise quality indication information may include a region_quality_indication_level[i][j] field. The region_quality_indication_level field is detailed information of the region_quality_indication_type[i][j] field, and may indicate order based on a picture quality difference according to a picture quality classification criterion indicated by the region_quality_indication_type field. That is, the region_quality_indication_level field may indicate a level of the j-th picture quality classification criterion of the i-th region. For example, a level of a region having the best picture quality according to the j-th picture quality classification criterion may be designated as 1. The region may be set as a reference for a picture quality comparison based on the j-th picture quality classification criterion with another region. The order of 2, 3, 4, that is, levels, may be set based on a picture quality difference with the region having the best picture quality. The region that is the reference may be indicated as a primary region. That is, the region having the best picture quality based on the j-th picture quality classification criterion may be designated as a primary region. A level of the primary region may be set to 1. A level according to the j-th picture quality classification criterion of the region of the current picture may be set based on the primary region. Meanwhile, the metadata for region-wise quality indication information may include a region_quality_indication_info[i][j] field. The region_quality_indication_info[i][j] field may indicate a picture quality difference value, that is, a reference for a level. That is, the region_quality_indication_info[i][j] field may indicate the range of a level. A range corresponding to a difference value between picture quality according to the j-th picture quality classification criterion of the primary region and picture quality indicated by the region_quality_indication_info[i][j] field may be set as one level. Alternatively, several steps of a picture quality difference value indicated by the region_quality_indication_info[i][j] field, in other words, an n multiple of a picture quality difference value indicated by the region_quality_indication_info[i][j] field may be set as a range of a level. In this case, although a picture quality difference between the primary region and a target region is a picture quality difference value or more indicated by the region_quality_indication_info[i][j] field, a receiving stage may interpret that separate processing is not necessary when frames are composed and played back.

Furthermore, referring to FIG. 8b, the metadata for region-wise quality indication information may include an EL_region_quality_indication_level[i][j] field. The EL_region_quality_indication_level[i][j] field may be transmitted if the enhancement_layer_quality_indication_flag field indicates that layered coding has been performed, that is, the region-wise quality indication information on an enhancement layer is transmitted. Specifically, for example, if a value of the enhancement_layer_quality_indication_flag field is 1, the EL_region_quality_indication_level[i][j] field for the i-th region of the current picture may be transmitted. The EL_region_quality_indication_level[i][j] field may indicate an order attributable to a picture quality difference occurring through an enhancement layer. In other words, the EL_region_quality_indication_level[i][j] field may indicate an order according to a picture quality difference by interlayer prediction for the i-th region, which has been performed based on the enhancement layer, that is, a level for the j-th picture quality classification criterion of the corresponding region. Meanwhile, the picture quality classification criterion of a level indicated by the EL_region_quality_indication_level[i][j] field may be the same as the picture quality classification criterion of a level indicated by a region_quality_indication_level[i][j] field according to the region_quality_indication_type[i][j] field of the i-th region.

Furthermore, referring to FIG. 8b, the metadata for region-wise quality indication information may include a region_quality_indication_subtype_flag[i][j] field. The region_quality_indication_subtype_flag[i][j] field may be transmitted if the enhancement_layer_quality_indication_flag field indicates that layered coding has been performed, that is, if the region-wise quality indication information on an enhancement layer is transmitted. Specifically, for example, if a value of the enhancement_layer_quality_indication_flag field is 1, the region_quality_indication_subtype_flag[i][j] field for the i-th region of the current picture may be transmitted. The region_quality_indication_subtype_flag[i][j] field may indicate whether additional quality indication information on the j-th picture quality classification criterion of the i-th region is transmitted. If a value of the region_quality_indication_subtype_flag[i][j] field is 1, the region_quality_indication_subtype_flag[i][j] field may indicate that additional quality indication information on the j-th picture quality classification criterion of the i-th region is transmitted. That is, if a value of the region_quality_indication_subtype_flag[i][j] field is 1, additional quality indication information on the j-th picture quality classification criterion of the i-th region may be transmitted. The additional quality indication information on the j-th picture quality classification criterion of the i-th region may include a number_of_subtypes_minus1[i][j] field, a region_quality_indication_subtype[i][j][k] field, a region_quality_indication_info field and/or a EL_region_quality_indication_info[i] [j][k] field, which will be described later.

For example, referring to FIG. 8b, the metadata for region-wise quality indication information may include a number_of subtypes_minus1[i][j] field. The number_of_subtypes_minus1[i][j] field may be transmitted if the region_quality_indication_subtype_flag[i][j] field indicates that additional quality indication information on the j-th picture quality classification criterion of the i-th region is transmitted. Specifically, for example, if a value of the region_quality_indication_subtype_flag[i][j] field is 1, the umber_of_subtypes_minus 1[i][j] field for the j-th picture quality classification criterion of the i-th region of the current picture may be transmitted. The umber_of_subtypes_minus1[i][j] field may indicate the number of additional quality indication information types for the j-th picture quality classification criterion of the i-th region of the current picture. In other words, the umber_of_subtypes_minus1[i][j] field may indicate the number of subtypes for the j-th picture quality classification criterion of the i-th region of the current picture.

Furthermore, referring to FIG. 8b, the metadata for region-wise quality indication information may include a region_quality_indication_subtype[i][j][k] field. The region_quality_indication_subtype[i][j][k] field may be transmitted if the region_quality_indication_subtype_flag[i][j] field indicates that additional quality indication information on the j-th picture quality classification criterion of the i-th region is transmitted. Specifically, for example, if a value of the region_quality_indication_subtype_flag[i][j] field is 1, the region_quality_indication_subtype[i] [j][k] field for the j-th picture quality classification criterion of the i-th region of the current picture may be transmitted. The region_quality_indication_subtype[i][j][k] field may indicate the k-th subtype of the j-th picture quality classification criterion of the i-th region.

For example, if a value of the region_quality_indication_type[i][j] field is 1, that is, if the region_quality_indication_type[i][j] field indicates that the j-th picture quality classification criterion of the i-th region is spatial resolution, the region_quality_indication_subtype[i][j][k] field may indicate a subtype for the spatial resolution. The subtype for the spatial resolution may include horizontal down scaling, vertical down scaling, and similar figure scaling. In this case, the similar figure may indicate a circle, a triangle or a rectangle.

Furthermore, the scaling of a trapezoid form may be defined as the subtype for the spatial resolution. The scaling of the trapezoid form may indicate scaling in which distortion occurs with directivity as if a rectangle changes into a trapezoid.

If a value of the region_quality_indication_type[i][j] field is 1, the k-th subtype of the j-th picture quality classification criterion of the i-th region indicated by a value of the region_quality_indication_subtype[i][j][k] field may be derived like the following table.

TABLE 4

| region_quality_indication_subtype | Descriptor |
|---|---|
| 0 | original resolution |
| 1 | horizontal down scaling |
| 2 | vertical down scaling |
| 3 | similar figure down scaling |
| 4-7 | trapezoid - top/bottom/left/right |
| 8 | atypical down scaling |
| 8-15 | reserved |

Specifically, for example, if a value of the region_quality_indication_subtype[i][j][k] field is 1, the region_quality_indication_subtype[i][j][k] field may indicate that the k-th subtype is horizontal down scaling. That is, if a value of the region_quality_indication_subtype[i][j][k] field is 1, the k-th subtype of the j-th picture quality classification criterion of the i-th region may be derived as horizontal down scaling. In this case, quality indication information on the region_quality_indication_subtype[i][j][k] field, that is, a region_quality_indication_info[i][j][k] field to be described later may indicate a picture quality difference according to the horizontal down scaling of the i-th region. That is, the region_quality_indication_info[i][j][k] field may indicate a degree of picture quality according to the horizontal down scaling of the i-th region.

Furthermore, if a value of the region_quality_indication_subtype[i][j][k] field is 2, the region_quality_indication_subtype[i][j][k] field may indicate that the k-th subtype is vertical down scaling. That is, if a value of the region_quality_indication_subtype[i][j][k] field is 2, the k-th subtype of the j-th picture quality classification criterion of the i-th region may be derived as vertical down scaling. In this case, quality indication information on the region_quality_indication_subtype[i][j][k] field, that is, a region_quality_indication_info[i][j][k] field to be described later may indicate a picture quality difference according to the vertical down scaling of the i-th region. That is, the region_quality_indication_info[i][j][k] field may indicate a degree of picture quality according to the vertical down scaling of the i-th region.

Furthermore, if a value of the region_quality_indication_subtype[i][j][k] field is 3, the region_quality_indication_subtype[i][j][k] field may indicate that the k-th subtype is similar figure scaling. That is, if a value of the region_quality_indication_subtype[i][j][k] field is 3, the k-th subtype of the j-th picture quality classification criterion of the i-th region may be derived as similar figure scaling. In this case, the similar figure may indicate a circle, a triangle or a rectangle. Meanwhile, if the region_quality_indication_subtype[i][j][k] field indicates that the k-th subtype is similar figure scaling, quality indication information on the region_quality_indication_subtype[i][j][k] field, that is, a region_quality_indication_info[i][j][k] field to be described later may indicate a picture quality difference according to the similar figure scaling of the i-th region. That is, the region_quality_indication_info[i][j][k] field may indicate a degree of picture quality according to the similar figure scaling of the i-th region.

Furthermore, if a value of the region_quality_indication_type[i][j] field is 4 to 7, the region_quality_indication_subtype[i][j][k] field may indicate that the k-th subtype is trapezoid scaling. Specifically, if a value of the region_quality_indication_type[i][j] field is 4, the region_quality_indication_subtype[i][j][k] field may indicate that the k-th subtype is scaling in which the upper base of a trapezoid is changed. That is, the region_quality_indication_subtype[i][j][k] field may indicate scaling in which a rectangle is distorted with directivity in which the rectangle is derived as a trapezoid through a change in the upper base of the rectangle.

Furthermore, if a value of the region_quality_indication_type[i][j] field is 5, the region_quality_indication_subtype[i][j][k] field may indicate that the k-th subtype is scaling in which the lower base of a trapezoid is changed. If a value of the region_quality_indication_type[i][j] field is 6, the region_quality_indication_subtype [i][j][k] field may indicate that the k-th subtype is scaling in which the left base of a trapezoid is changed. If a value of the region_quality_indication_type[i][j] field is 7, the region_quality_indication_subtype[i][j][k] field may indicate that the k-th subtype is scaling in which the right base of a trapezoid is changed.

Meanwhile, if the region_quality_indication_subtype[i][j][k] field indicates that the k-th subtype is trapezoid scaling, quality indication information on the region_quality_indication_subtype [i][j][k] field, that is, a region_quality_indication_info[i][j][k] field to be described later may indicate the length of a base (upper base, lower base, left base or right base) changed in trapezoid scaling. Or a plurality of pieces of quality indication information on the region_quality_indication_subtype[i][j][k] field may be transmitted. The quality indication information may indicate the start point of the changing base and the length of the changing base.

Furthermore, if a value of the region_quality_indication_subtype[i][j][k] field is 8, the region_quality_indication_subtype[i][j][k] field may indicate that the k-th subtype is atypical scaling. The atypical scaling may indicate scaling that is atypically performed on a region, that is, a given closed figure. That is, if a type of the i-th region indicated by the region_type field is a given closed figure, scaling for the i-th region may be performed atypically. If a value of the region_quality_indication_subtype[i][j][k] field is 8, a region_quality_indication_info[i][j][k] field for the region_quality_indication_subtype[i][j][k] field may not be transmitted. Scaling for the i-th region may be inferred based on a vertex of the i-th region. Meanwhile, although the region_quality_indication_type[i][j] field indicates that the j-th picture quality classification criterion of the i-th region is a type other than spatial resolution, the region_quality_indication_subtype[i][j][k] field that indicates the k-th subtype as atypical scaling may be used. Detailed information on the j-th picture quality classification criterion of the i-th region, that is, a subtype, may be derived through the region_quality_indication_subtype[i][j][k] field.

Meanwhile, referring to FIG. 8b, the metadata for region-wise quality indication information may include a region_quality_indication_info[i][j][k] field. The region_quality_indication_info[i][j][k] field may be transmitted if the region_quality_indication_subtype_flag[i][j] field indicates that additional quality indication information on the j-th picture quality classification criterion of the i-th region is transmitted. The region_quality_indication_subtype_flag[i][j] field may indicate detailed information on the region_quality_indication_type[i][j] field and region_quality_indication_subtype[i][j][k] field of the i-th region. That is, the region_quality_indication_subtype_flag[i][j] field may indicate detailed information on the k-th subtype of the j-th picture quality classification criterion of the i-th region. For example, if a value of the region_quality_indication_type[i][j] field of the i-th region is 2, the region_quality_indication_info[i][j][k] field may indicate a detail damage degree attributable to a compression ratio according to a quantization parameter (QT) used in a compression process. As the QP increases, the compression ratio of the i-th region may be improved, but the damage degree may increase because more information of the original data for the i-th region is lost, and a corresponding picture quality difference may also occur. Accordingly, if a value of the region_quality_indication_type[i][j] field of the i-th region is 2, the region_quality_indication_info[i][j][k] field may indicate the damage degree of the i-th region according to the QP.

Furthermore, for another example, if a value of the region_quality_indication_type[i][j] field of the i-th region is 1 and a value of the region_quality_indication_subtype[i][j][k] field is 1, the region_quality_indication_info[i][j][k] field may indicate a scaling ratio of spatial resolution in a horizontal direction. That is, if a value of the region_quality_indication_type[i][j] field of the i-th region is 1, the region_quality_indication_info[i][j][k] field may indicate a scaling factor. For example, if a value of the region_quality_indication_info[i][j][k] field is 0.5, the region_quality_indication_info[i][j][k] field may indicate that resolution of the i-th region in the horizontal direction has been lost by 0.5 compared to resolution of a region (i.e., primary region), that is, a reference, in the horizontal direction. Furthermore, a case where a value of the region_quality_indication_info[i][j][k] field is 1 may indicate a case where there is no scaling for the i-th region. Furthermore, a down-scale factor may also be derived as a value of a 1/region_quality_indication_info[i][j][k] field.

Furthermore, referring to FIG. 8b, the metadata for region-wise quality indication information may include an EL_region_quality_indication_info[i][j][k] field. The EL_region_quality_indication_info[i][j][k] field may be transmitted if the enhancement_layer_quality_indication_flag field indicates that layered coding has been performed, that is, the region-wise quality indication information on an enhancement layer is transmitted. Specifically, for example, if a value of the enhancement_layer_quality_indication_flag field is 1, the EL_region_quality_indication_info[i][j][k] field may be transmitted. The EL_region_quality_indication_info[i][j][k] field may indicate information on a picture quality difference that occurs through an enhancement layer. In other words, the EL_region_quality_indication_info[i][j][k] field may indicate detailed information on the k-th subtype of the j-th picture quality classification criterion of the i-th region based on interlayer prediction performed based on the enhancement layer. Meanwhile, the picture quality classification criterion of information indicated by the EL_region_quality_indication_info[i][j][k] field may be the same as the picture quality classification criterion of the region_quality_indication_info[i][j][k] field according to the region_quality_indication_type[i][j] field and region_quality_indication_subtype[i][j][k] field of the i-th region. That is, the EL_region_quality_indication_info[i][j][k] field may indicate information on the k-th subtype of the j-th picture quality classification criterion.

Furthermore, referring to FIG. 8b, the metadata for region-wise quality indication information may include a type_priority_index[i] field. The type_priority_index[i] field may indicate priority of the picture quality classification criteria of the current picture. That is, the type_priority_index[i] field may indicate priority of the i-th picture quality classification criterion indicated by a quality_indication_type[i] field among picture quality classification criteria, that is, a reference for a picture quality difference between regions within a current frame. For example, if priority is given to a picture quality difference based on the size of a region, that is, priority is given to spatial resolution among picture quality classification criteria, the type_priority_index[i] field may indicate the highest priority. In this case, a value of the quality_indication_type[i] field may be 1, and the quality_indication_type[i] field may indicate that an i-th picture quality classification criterion is spatial resolution. If a plurality of picture quality classification criteria for a plurality of regions or video streams has been defined, that is, if a plurality of quality_indication_type fields for the plurality of regions or video streams is transmitted, an image having a quality difference preferred in a decoding apparatus may be selected based on the type_priority_index field for each of the picture quality classification criteria.

Furthermore, referring to FIG. 8b, the metadata for region-wise quality indication information may include a region_quality_indication_type_inter_type_index[i][j] field. The region_quality_indication_type_inter_type_index[i][j] field may indicate priority of the j-th picture quality classification criterion of the i-th region of the current picture. A plurality of picture quality classification criteria may be defined for the i-th region. That is, a plurality of region_quality_indication_type fields may be transmitted for the i-th region. The region_quality_indication_type_inter_type_index field may indicate priority of quality indication information on each of the region_quality_indication_type fields. For example, if spatial resolution, a degree of compression and a bit depth have been defined for picture quality classification criteria for the i-th region, that is, if the region_quality_indication_type field having a value of 1, the region_quality_indication_type field having a value of 2, and the region_quality_indication_type field having a value of 3 are transmitted with respect to the i-th region with respect to the i-th region, priority of quality indication information on the region_quality_indication_type field may be derived based on each of the picture quality classification criteria, that is, a region_quality_indication_type_inter_type_index field for each region_quality_indication_type field. The region_quality_indication_type_inter_type_index field may indicate 1, 2 or 3. A picture quality classification criterion indicated by a region_quality_indication_type field for a region_quality_indication_type_inter_type_index field having a value of 1 may be derived as top priority. If a region or stream is selected by comparing the characteristics of regions through priority of quality indication information, a reference first determined in a decoding apparatus (or receiver) may be derived. A region or stream may be selected through the reference. Alternatively, a reference first determined through priority of quality indication information may be derived. Priority of quality indication information is used as a signal for preparing post-processing in a decoding apparatus for a region or stream selected through the reference.

Furthermore, referring to FIG. 8b, the metadata for region-wise quality indication information may include a region_quality_indication_type_inter_region_index[i][j] field. The region_quality_indication_type_inter_region_index[i][j] field may indicate priority between regions having quality indication information on the same picture quality classification criteria within a current picture, which is derived based on the j-th picture quality classification criterion of an i-th region indicated by a region_quality_indication_type[i][j] field. In other words, the region_quality_indication_type_inter_region_index[i][j] field may indicate priority of the i-th region in regions having quality indication information on the j-th picture quality classification criterion within the current picture.

For example, if a current picture is a picture onto which 360-degree video data has been projected based on cube map projection (CMP), the current picture may include regions indicating the faces of a cube, and may be set to have a different compression error, spatial scaling or a dynamic range for each region. In this case, the spatial scaling may also be called spatial resolution. The dynamic range may also be called a brightness range. In this case, a region_quality_indication_type_inter_region_index[i][j] field for an i-th region and a degree of compression may be transmitted. The region_quality_indication_type_inter_region_index[i][j] field may indicate priority of the i-th region derived by comparing regions based on a degree of compression. A video stream can be selected based on order (i.e., priority) of a specific picture quality classification criterion without taking into consideration a quality difference according to various picture quality classification criteria within an image based on the region_quality_indication_type_inter_region_index[i][j] field.

Furthermore, referring to FIG. 8b, the metadata for region-wise quality indication information may include a region_quality_indication_type_inter_stream_index[i][j] field. The region_quality_indication_type_inter_stream_index[i][j] field may indicate priority of an i-th region derived based on the j-th picture quality classification criterion of the i-th region indicated by a region_quality_indication_type[i][j] field and the i-th region within other video streams and among corresponding regions.

For example, if 360-degree video data for a current frame is projected based on cube map projection (CMP) and there are video streams having various packing formats and picture quality classification criteria, a region_quality_indication_type_inter_stream_index[i][j] field for each of regions indicating the front face of a cube within the video streams may be transmitted. The region_quality_indication_type_inter_stream_index[i][j] field may indicate priority of the cube of an i-th region for the region_quality_indication_type_inter_stream_index[i][j] field derived based on a j-th picture quality classification criterion among regions indicating the front face. If the j-th picture quality classification criterion is spatial resolution, that is, if a value of the region_quality_indication_type[i][j] field is 1, the region_quality_indication_type_inter_stream_index[i][j] field may indicate the priority of an i-th region among the regions indicating the front face. The receiver that prefers a region having a value of 1 of the region_quality_indication_type field, that is, quality indication information on spatial resolution and indicating a front face may determine whether a stream is the best video stream based on the region_quality_indication_type_inter_stream_index field. That is, a video stream having more improved picture quality, among a plurality of video streams having the region_quality_indication_type field having a value of 1 and including regions indicating a front face, may be selected based on the region_quality_indication_type_inter_stream_index field.

Meanwhile, region boundary processing may be performed on a region. In this case, information indicating an area in which region boundary processing is performed within the region, information indicating an area in which the region boundary processing is not performed within the region, and information for the region boundary processing may be transmitted as additional information on the region. In this case, the region boundary processing may indicate method of performing filtering based on a smoothing filter, a blending filter, an enhancement filter and a restoration filter as processing for solving a problem (e.g., the occurrence of a boundary attributable to a picture quality difference between the regions) occurring at the boundary between the regions.

Specifically, a processing_region_indication_flag[i] field illustrated in FIG. 8b may be transmitted. The processing_region_indication_flag[i] field may indicate whether information indicating the area in which the region boundary processing is performed within an i-th region is transmitted. The area in which the region boundary processing is performed may be indicated as a processing region. For example, if a value of the processing_region_indication_flag[i] field is 1, information indicating the area in which the region boundary processing is performed within the i-th region may be transmitted. If a value of the processing_region_indication_flag[i] field is 0, information indicating the area in which the region boundary processing is performed within the i-th region may not be transmitted.

Furthermore, a core_region_indication_flag[i] field illustrated in FIG. 8b may be transmitted. The core_region_indication_flag[i] field may indicate whether information indicating the area in which the region boundary processing is not performed within the i-th region is transmitted. The area in which the region boundary processing is not performed may be indicated as a core region. For example, if a value of the core_region_indication_flag[i] field is 1, information indicating the area in which the region boundary processing is not performed within the i-th region may be transmitted. If a value of the core_region_indication_flag[i] field is 0, information indicating the area in which the region boundary processing is not performed within the i-th region may not be transmitted.

Furthermore, a processing_info_present_flag[i] field illustrated in FIG. 8b may be transmitted. The processing_info_present_flag[i] field may indicate whether information for the region boundary processing of an i-th region is transmitted. The information for the region boundary processing may include information indicating the filter of the region boundary processing and information on the parameter of the filter.

Meanwhile, the information indicating the area in which the region boundary processing is performed, the information indicating the area in which the region boundary processing is not performed, and the detailed information for the region boundary processing may be the same as those described later.

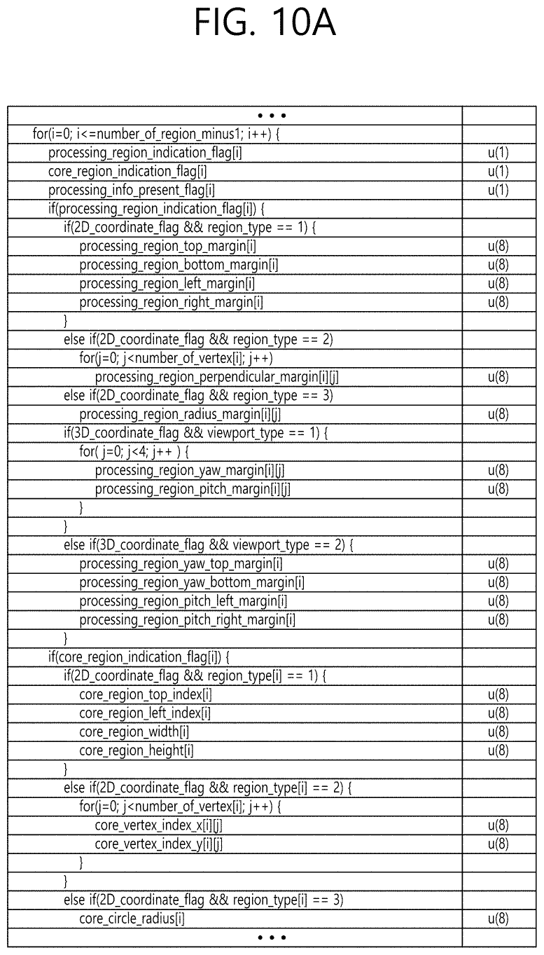

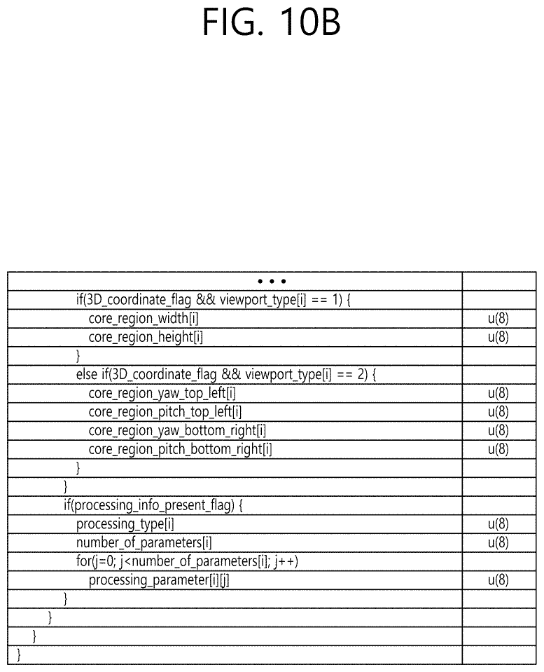

FIGS. 10a and 10b illustrate examples of information for the region boundary processing of a region. Referring to FIG. 10a, a processing_region_indication_flag[i] field, a core_region_indication_flag[i] field and a processing_info_present_flag[i] field may be transmitted. The processing_region_indication_flag[i] field, the core_region_indication_flag[i] field and the processing_info_present_flag[i] field may be the same as those described above.

Furthermore, referring to FIG. 10a, a processing_region_top_margin[i] field, a processing_region_bottom_margin[i] field, a processing_region_left_margin[i] field, and a processing_region_right_margin[i] field may be transmitted. The processing_region_top_margin[i] field, the processing_region_bottom_margin[i] field, the processing_region_left_margin[i] field, and the processing_region_right_margin[i] field may be transmitted if the 2D_coordinate_flag field indicates that information on a 2D coordinate system is transmitted and the region_type[i] field indicates a type of an i-th region as a rectangle. That is, if a value of the 2D_coordinate_flag field is 1 and a value of the region_type[i] field is 1, the processing_region_top_margin[i] field, the processing_region_bottom_margin[i] field, the processing_region_left_margin[i] field, and the processing_region_right_margin[i] field may be transmitted. The processing_region_top_margin[i] field, the processing_region_bottom_margin[i] field, the processing_region_left_margin[i] field, and the processing_region_right_margin[i] field may indicate an area in which the region boundary processing is performed. Specifically, the processing_region_top_margin[i] field may indicate a distance from the top boundary of the i-th region. In this case, the region boundary processing may be performed on an area from the top boundary to a value of the processing_region_top_margin[i] field, that is, an area neighboring the top boundary and having the top boundary as the width and the value of the processing_region_top_margin[i] field as the height.

Furthermore, the processing_region_bottom_margin[i] field may indicate a distance from the bottom boundary of the i-th region. In this case, the region boundary processing may be performed an area from the bottom boundary to a value of the processing_region_bottom_margin[i] field, that is, an area neighboring the bottom boundary and having the bottom boundary as the width and the value of the processing_region_bottom_margin[i] field as the height.

Furthermore, the processing_region_left_margin[i] field may indicate a distance from the left boundary of the i-th region. In this case, the region boundary processing may be performed on an area from the left boundary to a value of the processing_region_left_margin[i] field, that is, an area neighboring the left boundary and having the left boundary as the height and the value of the processing_region_left_margin[i] field as the width.

Furthermore, the processing_region_right_margin[i] field may indicate a distance from the right boundary of the i-th region. In this case, the region boundary processing may be performed on an area from the right boundary to a value of the processing_region_right_margin[i] field, that is, an area neighboring the right boundary and having the right boundary as the height and the value of the processing_region_right_margin[i] field as the width.

Furthermore, referring to FIG. 10a, a processing_region_perpendicular_margin[i][j] field may be transmitted. The processing_region_perpendicular_margin[i][j] field may be transmitted if the 2D_coordinate_flag field indicates that information on a 2D coordinate system is transmitted and the region_type[i] field indicate a type of the i-th region as a given closed figure. That is, if a value of the 2D_coordinate_flag field is 1 and a value of the region_type[i] field is 2, the processing_region_perpendicular_margin[i][j] field may be transmitted. The processing_region_perpendicular_margin[i][j] field may indicate the area in which the region boundary processing is performed. Specifically, the processing_region_perpendicular_margin[i][j] field may indicate a distance from a boundary configured with the j-th vertex and (j+1)-th vertex of an i-th region. In this case, the region boundary processing may be performed on an area from the boundary configured with the j-th vertex and the (j+1)-th vertex to a value of the processing_region_perpendicular_margin[i][j] field, that is, an area neighboring the boundary configured with the j-th vertex and the (j+1)-th vertex and having the boundary as the width and the value of the processing_region_perpendicular_margin[i][j] field as the height.

Furthermore, referring to FIG. 10a, a processing_region_radius_margin[i][j] field may be transmitted. The processing_region_radius_margin[i][j] field may be transmitted if the 2D_coordinate_flag field indicates that information on a 2D coordinate system is transmitted and the region_type[i] field indicates a type of an i-th region as a circle. That is, if a value of the 2D_coordinate_flag field is 1 and a value of the region_type[i] field is 3, the processing_region_radius_margin[i][j] field may be transmitted. The processing_region_radius_margin[i][j] field may indicate an area in which the region boundary processing is performed. Specifically, the processing_region_radius_margin[i][j] field may indicate a distance from the boundary of an i-th region. In this case, the region boundary processing may be performed on an area from the boundary to a value of the processing_region_perpendicular_margin[i][j] field, that is, an area of a doughnut shape from the boundary to the value of the processing_region_perpendicular_margin[i][j] field.

Furthermore, referring to FIG. 10a, a processing_region_yaw_margin[i][j] field and a processing_region_pitch_margin[i] field may be transmitted. The processing_region_yaw_margin[i][j] field and the processing_region_pitch_margin[i][j] field may be transmitted if the 3D_coordinate_flag field indicates that information on a 3D coordinate system is transmitted and the viewport_type field indicates a type of the 3D coordinate system as a type indicating a sphere surface based on four great circles. That is, if a value of the 3D_coordinate_flag field is 1 and a value of the viewport_type field is 1, the processing_region_yaw_margin[i][j] field and the processing_region_pitch_margin[i][j] field may be transmitted. The processing_region_yaw_margin[i][j] field and the processing_region_pitch_margin[i][j] field may indicate an area in which the region boundary processing is performed. Specifically, the position of the i-th region may be indicated based on the center of the i-th region and the width and height of the i-th region. The processing_region_yaw_margin[i][j] field and the processing_region_pitch_margin[i][j] field may indicate coordinates on a vertical line and horizontal line that pass through the center of the i-th region. That is, the processing_region_yaw_margin[i][j] field and the processing_region_pitch_margin[i][j] field may indicate a distance from the boundary of the i-th region. Meanwhile, the position of the center of the i-th region may be derived based on the region_yaw[i] field, the region_pitch[i] field, and the region_roll[i] field. The width and height of the i-th region may be derived based on the region_width[i] field and region_height[i] field.

Furthermore, referring to FIG. 10a, a processing_region_yaw_top_margin[i] field, a processing_region_yaw_bottom_margin[i] field, a processing_region_pitch_left_margin[i] field, and a processing_region_pitch_right_margin[i] field may be transmitted. The processing_region_yaw_top_margin[i] field, the processing_region_yaw_bottom_margin[i] field, the processing_region_pitch_left_margin[i] field, and the processing_region_pitch_right_margin[i] field may be transmitted if the 3D_coordinate_flag field indicates that information on a 3D coordinate system is transmitted and the viewport_type field indicates a type of the 3D coordinate system as a type indicating a sphere surface based on two great circles and two small circles. That is, if a value of the 3D_coordinate_flag field is 1 and a value of the viewport_type field is 2, the processing_region_yaw_top_margin[i] field, the processing_region_yaw_bottom_margin[i] field, the processing_region_pitch_left-margin[i] field, and the processing_region_pitch_right_margin[i] field may be transmitted. The processing_region_yaw_top_margin[i] field, the processing_region_yaw_bottom_margin[i] field, the processing_region_pitch_left_margin[i] field, and the processing_region_pitch_right_margin[i] field may indicate an area in which the region boundary processing is performed.

Specifically, the processing_region_yaw_top_margin[i] field may indicate a distance from the top boundary of the i-th region. Furthermore, the processing_region_yaw_bottom_margin[i] field may indicate a distance from the bottom boundary of the i-th region. Furthermore, the processing_region_pitch_left_margin[i] field may indicate a distance from the left boundary of the i-th region. Furthermore, the processing_region_pitch_right_margin[i] field may indicate a distance from the right boundary of the i-th region.

Furthermore, referring to FIG. 10a, a core_region_top_index[i] field, a core_region_left_index[i] field, a core_region_width[i] field, and a core_region_height[i] field may be transmitted. The core_region_top_index[i] field, the core_region_left_index[i] field, the core_region_width[i] field, and the core_region_height[i] field may be transmitted if the 2D_coordinate_flag field indicates that information on a 2D coordinate system is transmitted and the region_type[i] field indicates a type of an i-th region as a rectangle. That is, if a value of the 2D_coordinate_flag field is 1 and a value of the region_type [i] field is 1, the core_region_top_index[i] field, the core_region_left_index[i] field, the core_region_width[i] field, and the core_region_height[i] field may be transmitted. The core_region_top_index[i] field, the core_region_left_index[i] field, the core_region_width[i] field, and the core_region_height[i] field may indicate an area in which the region boundary processing is not performed. Specifically, the core_region_top_index[i] field and the core_region_left_index[i] field may indicate an area in which the region boundary processing is not performed in the i-th region, that is, the y component and x component of the left top sample of the core region of the i-th region. Furthermore, the core_region_width[i] field and the core_region_height[i] field may indicate an area in which the region boundary processing is not performed in the i-th region, that is, the width and height of the core region of the i-th region.

Furthermore, referring to FIG. 10a, a core_vertex_index_x[i][j] field and a core_vertex_index_y[i][j] field may be transmitted. The core_vertex_index_x[i][j] field and the core_vertex_index_y[i] [j] field may be transmitted if the 2D_coordinate_flag field indicates that information on a 2D coordinate system is transmitted and the region_type[i] field indicates a type of an i-th region as a given closed figure. That is, if a value of the 2D_coordinate_flag field is 1 and a value of the region_type[i] field is 2, the core_vertex_index_x[i][j] field and the core_vertex_index_y[i][j] field may be transmitted. The core_vertex_index_x[i][j] field and the core_vertex_index_y[i][j] field may indicate an area in which the region boundary processing is not performed in the i-th region. Specifically, the core_vertex_index_x[i][j] field and the core_vertex_index_y[i][j] field may indicate an area in which the region boundary processing is not performed in the i-th region, that is, the vertex of the core region of the i-th region. In this case, the region boundary processing may not be performed on an area of a given closed figure form configured with a vertex indicated by the core_vertex_index_x[i][j] field and the core_vertex_index_y[i][j] field.

Furthermore, referring to FIG. 10a, a core_circle_radius[i] field may be transmitted. The core_circle_radius[i] field may be transmitted if the 2D_coordinate_flag field indicates that information on a 2D coordinate system is transmitted and the region_type[i] field indicates a type of an i-th region as a circle. That is, if a value of the 2D_coordinate_flag field is 1 and a value of the region_type[i] field is 3, the core_circle_radius[i] field may be transmitted. The core_circle_radius[i] field may indicate an area in which the region boundary processing is not performed. Specifically, the core_circle_radius[i] field may indicate an area in which the region boundary processing is not performed, that is, the radius of the core region of the i-th region. In this case, the core region of the i-th region may be derived as an area having the center of the i-th region as the center and a value of the core_circle_radius[i] field as a radius. The region boundary processing may not be performed on the core region.

Furthermore, referring to FIG. 10b, a core_region_width[i] field and a core_region_height[i] field may be transmitted. The core_region_width[i] field and the core_region_height[i] field may be transmitted if the 3D_coordinate_flag field indicates that information on a 3D coordinate system is transmitted and the viewport_type field indicates a type of the 3D coordinate system as a type indicating a sphere surface based on four great circles. That is, if a value of the 3D_coordinate_flag field is 1 and a value of the viewport_type field is 1, the core_region_width[i] field and the core_region_height[i] field may be transmitted. The core_region_width[i] field and the core_region_height[i] field may indicate an area in which the region boundary processing is not performed. Specifically, the core_region_width[i] field and the core_region_height[i] field may indicate an area in which the region boundary processing is not performed in the i-th region, that is, the width and the height of the core region of the i-th region. In this case, the core region of the i-th region may be derived as an area having the center of the i-th region as the center and a value of the core_region_width[i] field and a value of the core_region_height[i] field as the width and the height. The region boundary processing may not be performed on the core region. In this case, the position of the center of the i-th region may be derived based on the region_yaw[i] field, the region_pitch[i] field, and the region_roll[i] field.

Furthermore, referring to FIG. 10b, a core_region_yaw_top_left[i] field, a core_region_pitch_top_left[i] field, a core_region_yaw_bottom_right[i] field, and a core_region_pitch_bottom_right[i] field may be transmitted. The core_region_yaw_top_left[i] field, the core_region_pitch_top_left[i] field, the core_region_yaw_bottom_right[i] field, and the core_region_pitch_bottom_right[i] field may be transmitted if the 3D_coordinate_flag field indicates that information on a 3D coordinate system is transmitted and the viewport_type field indicates a type of the 3D coordinate system as a type indicating a sphere surface based on two great circles and two small circles. That is, if a value of the 3D_coordinate_flag field is 1 and a value of the viewport_type field is 2, the core_region_yaw_top_left[i] field, the core_region_pitch_top_left[i] field, the core_region_yaw_bottom_right[i] field, and the core_region_pitch_bottom_right[i] field may be transmitted. The core_region_yaw_top_left[i] field, the core_region_pitch_top_left[i] field, the core_region_yaw_bottom_right[i] field, and the core_region_pitch_bottom_right[i] field may indicate an area in which the region boundary processing is not performed. Specifically, the core_region_yaw_top_left[i] field and the core_region_pitch_top_left[i] field may indicate an area in which the region boundary processing is not performed in the i-th region, that is, a yaw value and pitch value of the left top sample of the core region of the i-th region. Furthermore, the core_region_yaw_bottom_right[i] field and the core_region_pitch_bottom_right[i] field may indicate a yaw value and pitch value of the right bottom sample of the core region of the i-th region.

Furthermore, referring to FIG. 10b, a processing_type[i] field may be transmitted. The processing_type[i] field may indicate a filter used in the region boundary processing of the i-th region. For example, filters for the region boundary processing of the i-th region indicated by values of the processing_type[i] field may be derived like the following table.

TABLE 5

| processing_type | Descriptor |
|---|---|
| 0 | no processing |
| 1 | smoothing filter |
| 2 | blending filter |
| 3 | enhancement filter |
| 4 | restoration filter |
| 5-15 | reserved |

If a value of the processing_type[i] field is 1, the processing_type[i] field may indicate a smoothing filter. That is, if a value of the processing_type[i] field is 1, a filter for the region boundary processing of the i-th region may be derived as a smoothing filter.

Furthermore, if a value of the processing_type[i] field is 2, the processing_type[i] field may indicate a blending filter. That is, if a value of the processing_type[i] field is 2, a filter for the region boundary processing of the i-th region may be derived as a blending filter.

Furthermore, if a value of the processing_type[i] field is 3, the processing_type[i] field may indicate an enhancement filter. That is, if a value of the processing_type[i] field is 3, a filter for the region boundary processing of the i-th region may be derived as an enhancement filter.

Furthermore, if a value of the processing_type[i] field is 4, the processing_type[i] field may indicate a restoration filter. That is, if a value of the processing_type[i] field is 4, a filter for the region boundary processing of the i-th region may be derived as a restoration filter.

Furthermore, referring to FIG. 10b, a number_of_parameters[i] field and a processing_parameter[i][j] field may be transmitted. The number_of_parameters[i] field and the processing_parameter[i][j] field may indicate detailed information on a filter for the region boundary processing of the i-th region. The number_of_parameters[i] field may indicate the number of filter parameters of the filter for the i-th region. The processing_parameter[i][j] field may indicate a parameter value of the filter.

As described above, metadata for region-wise quality indication information may be transmitted. Embodiments in which a picture quality difference within a current picture is classified based on the metadata for region-wise quality indication information may be derived in the following various forms.

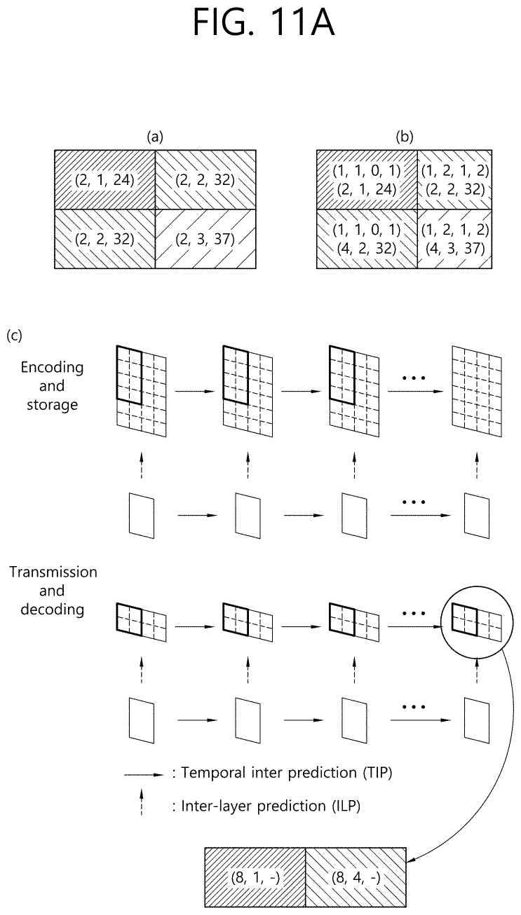

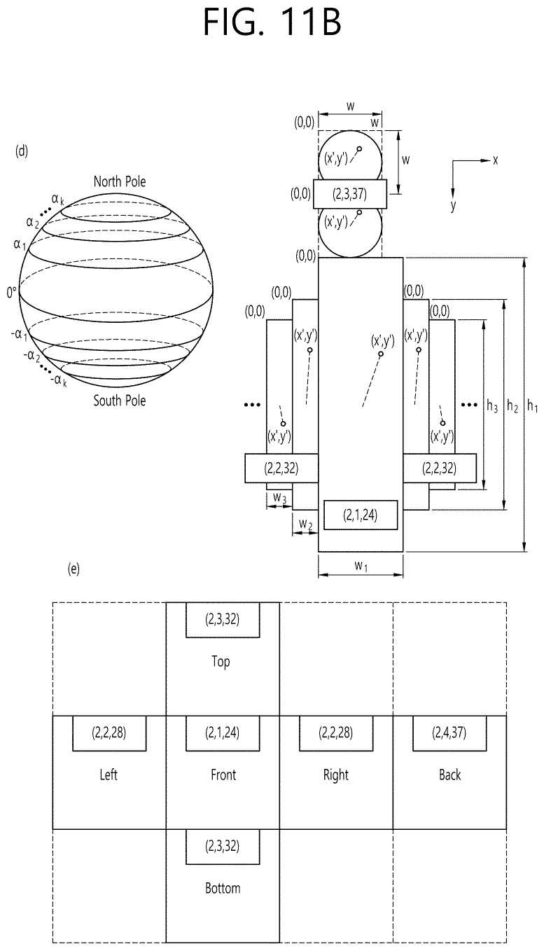

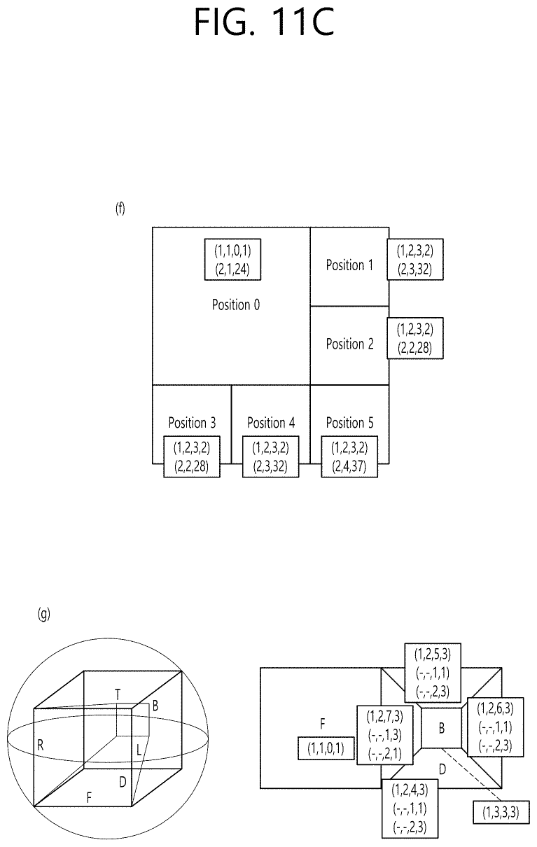

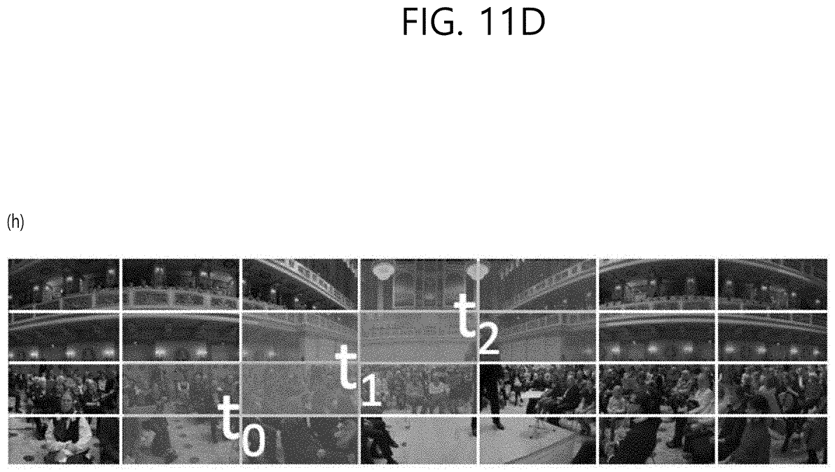

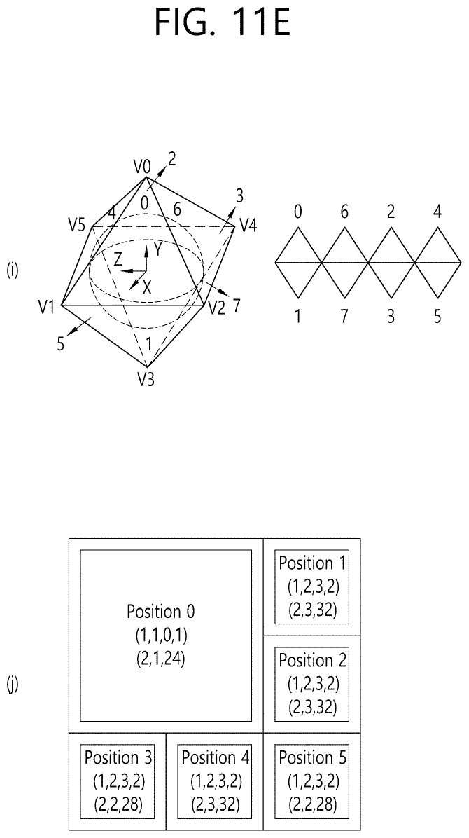

FIGS. 11a to 11e illustrate embodiments in which a picture quality difference within a current picture is classified based on the metadata for region-wise quality indication information. Referring to (a) of FIG. 11a, the encoding apparatus/decoding apparatus may determine a picture quality difference between regions based on metadata for quality indication information of the regions within a current picture. Numbers within parentheses illustrated in (a) of FIG. 1 la may indicate a value of the region_quality_indication_type field, a value of the region_quality_indication_level field, and a value of the region_quality_indication_info field of each region in order from the left to the right. That is, referring to (a) of FIG. 11a, a value of the region_quality_indication_type field of the first region may be derived as 2, a value of the region_quality_indication_level field of the first region may be derived as 1, and a value of the region_quality_indication_info field of the first region may be derived as 24. A value of the region_quality_indication_type field of the second region may be derived as 2, a value of the region_quality_indication_level field of the second region may be derived as 2, and a value of the region_quality_indication_info field of the second region may be derived as 32. A value of the region_quality_indication_type field of the third region may be derived as 2, a value of the region_quality_indication_level field of the third region may be derived as 2, and a value of the region_quality_indication_info field of the third region may be derived as 32. A value of the region_quality_indication_type field of the fourth region may be derived as 2, a value of the region_quality_indication_level field of the fourth region may be derived as 3, and a value of the region_quality_indication_info field of the fourth region may be derived as 37. In this case, the first region may indicate a left top region, the second region may indicate a right top region, the third region may indicate a left bottom region, and the fourth region may indicate a right bottom region. A type of quality indication information of the first region to the fourth region may be derived as a degree of compression because values of the region_quality_indication_type fields of the first region to the fourth region are 2. Accordingly, picture quality differences appearing based on the degrees of compression of the first region to the fourth region may be compared based on metadata for quality indication information of the first region to the fourth region.

Furthermore, as shown in (b) of FIG. 11a, the metadata of quality indication information for a plurality of picture quality classification criteria may be transmitted with respect to each region. For example, as shown in (b) of FIG. 11a, metadata for first quality indication information and metadata for second quality indication information for each region may be transmitted. Referring to (b) of FIG. 11a, a value of a region_quality_indication_type field included in the metadata for the first quality indication information of the first region may be derived as 1, a value of a region_quality_indication_level field included in the metadata may be derived as 1, a value of a region_quality_indication_subtype field included in the metadata may be derived as 0, and a value of a region_quality_indication_info field included in the metadata may be derived as 1. A value of a region_quality_indication_type field included in the metadata for first quality indication information of the second region may be derived as 1, a value of a region_quality_indication_level field included in the metadata may be derived as 2, a value of region_quality_indication_subtype field included in the metadata may be derived as 1, and a value of a region_quality_indication_info field included in the metadata may be derived as 2. A value of a region_quality_indication_type field included in the metadata for the first quality indication information of the third region may be derived as 1, a value of a region_quality_indication_level field included in the metadata may be derived as 1, a value of region_quality_indication_subtype field included in the metadata may be derived as 0, and a value of a region_quality_indication_info field included in the metadata may be derived as 1. A value of a region_quality_indication_type field included in the metadata for the first quality indication information of the fourth region may be derived as 1, a value of a region_quality_indication_level field included in the metadata may be derived as 2, a value of region_quality_indication_subtype field included in the metadata may be derived as 1, and a value of a region_quality_indication_info field included in the metadata may be derived as 2. In this case, the first region may indicate a left top region, the second region may indicate a right top region, the third region may indicate a left bottom region, and the fourth region may indicate a right bottom region. A type of first quality indication information of the first region to the fourth region may be derived as spatial resolution because values of the region_quality_indication_type fields for the first quality indication information of the first region to the fourth region are 1. Accordingly, picture quality differences appearing based on the spatial resolutions of the first region to the fourth region may be compared based on the metadata for the first quality indication information of the first region to the fourth region.

Furthermore, referring to (b) of FIG. 11a, a value of the region_quality_indication_type field included in the metadata for the second quality indication information of the first region may be derived as 2, a value of the region_quality_indication_level field may be derived as 1, and a value of the region_quality_indication_info field may be derived as 24. A value of the region_quality_indication_type field included in the metadata for the second quality indication information of the second region may be derived as 2, a value of the region_quality_indication_level field may be derived as 2, and a value of the region_quality_indication_info field may be derived as 32. A value of the region_quality_indication_type field included in the metadata for the second quality indication information of the third region may be derived as 4, a value of the region_quality_indication_level field may be derived as 2, and a value of the region_quality_indication_info field may be derived as 32. A value of the region_quality_indication_type field of the fourth region may be derived as 4, a value of the region_quality_indication_level field may be derived as 3, and a value of the region_quality_indication_info field may be derived as 37. In this case, a type of the quality indication information of the first region and the second region may be derived as a degree of compression because the values of the region_quality_indication_type fields for the second quality indication information of the first region and the second region are 2. Furthermore, a type of the quality indication information of the third region and the second region may be derived as a color because the values of the region_quality_indication_type fields for the second quality indication information of the third region and the fourth region are 4. Accordingly, picture quality differences appearing based on the degree of compression of the first region and the second region may be compared based on the metadata for the second quality indication information of the first region and the second region. Picture quality differences appearing based on the color of the third region and the fourth region may be compared based on the metadata for the second quality indication information of the third region and the fourth region.

Furthermore, as shown in (c) of FIG. 11a, metadata for quality indication information may be transmitted with respect to each region. For example, as shown in (c) of FIG. 11a, a picture quality difference between regions may occur according to the enhancement layer. The coding apparatus may compare a picture quality difference between regions according to the enhancement layer based on metadata for quality indication information with respect to each region. In other words, as shown in (c) of FIG. 11a, in the first region, interlayer prediction may be performed based on the enhancement layer, and detailed information (detail) included in the enhancement layer may be added. In the second region, interlayer prediction may not be performed. In this case, the first region may indicate a left region, and the second region may indicate a right region. Accordingly, picture quality of the first region may be better than picture quality of the second region. In this case, referring to (c) of FIG. 11a, a value of the region_quality_indication_type field of the first region may be derived as 8, a value of the region_quality_indication_level field may be derived as 1, a value of the region_quality_indication_type field of the second region may be derived as 8, and a value of the region_quality_indication_level field may be derived as 4. Meanwhile, in this case, a value of the enhancement_layer_quality_indication_flag field may be 1.

Furthermore, as shown in (d) of FIG. 11b, metadata for quality indication information may be transmitted with respect to each region. (d) of FIG. 11b may show metadata for quality indication information of each region within a current picture onto which 360-degree video data has been projected through segmented sphere projection (SSP). In this case, the SSP may indicate a projection type in which the 360-degree video data of two pole portions of a spherical surface is mapped to regions of a circular type and the 360-degree video data of the remaining portions is mapped to regions of a rectangular type.

Referring to (d) of FIG. 11b, a value of the region_quality_indication_type field of the first region may be derived as 2, a value of the region_quality_indication_level field may be derived as 3, and a value of the region_quality_indication_info field may be derived as 37. A value of the region_quality_indication_type field of the second region may be derived as 2, a value of the region_quality_indication_level field may be derived as 2, and a value of the region_quality_indication_info field may be derived as 32. A value of the region_quality_indication_type field of the third region may be derived as 2, a value of the region_quality_indication_level field may be derived as 1, and a value of the region_quality_indication_info field may be derived as 24. A value of the region_quality_indication_type field of the fourth region may be derived as 2, a value of the region_quality_indication_level field may be derived as 2, and a value of the region_quality_indication_info field may be derived as 32. In this case, the first region may indicate regions of a circular type to which the 360-degree video data of two pole portions has been mapped. The second region may indicate regions to which 360-degree video data between the North Pole portion and the equator portion has been mapped. The third region may indicate a region of a rectangular type to which the 360-degree video data of the equator portion has been mapped. The fourth region may indicate regions to which 360-degree video data between the South Pole portion and the equator portion has been mapped. A type of the quality indication information of the first region to the fourth region may be derived as a degree of compression because the values of the region_quality_indication_type fields of the first region to the fourth region are 2. Accordingly, picture quality differences appearing based on degrees of compression of the first region to the fourth region may be compared based on the metadata for the quality indication information of the first region to the fourth region.

Furthermore, as shown in (e) of FIG. 11b, metadata for quality indication information may be transmitted with respect to each region. (e) of FIG. 11b may show metadata for quality indication information of each region within a current picture onto which 360-degree video data has been projected through cube map projection (CMP). In this case, the CMP may indicate a projection type in which 360-degree video data shown on a spherical surface is projected onto a 2D image in accordance with a region showing each face of a cube.

Referring to (e) of FIG. 11b, a value of the region_quality_indication_type field of the first region may be derived as 2, a value of the region_quality_indication_level field may be derived as 3, and a value of the region_quality_indication_info field may be derived as 32. A value of the region_quality_indication_type field of the second region may be derived as 2, a value of the region_quality_indication_level field may be derived as 2, and a value of the region_quality_indication_info field may be derived as 28. A value of the region_quality_indication_type field of the third region may be derived as 2, a value of the region_quality_indication_level field may be derived as 1, and a value of the region_quality_indication_info field may be derived as 24. A value of the region_quality_indication_type field of the fourth region may be derived as 2, a value of the region_quality_indication_level field may be derived as 2, and a value of the region_quality_indication_info field may be derived as 28. A value of the region_quality_indication_type field of the fifth region may be derived as 2, a value of the region_quality_indication_level field may be derived as 4, and a value of the region_quality_indication_info field may be derived as 37. A value of the region_quality_indication_type field of the sixth region may be derived as 2, a value of the region_quality_indication_level field may be derived as 3, and a value of the region_quality_indication_info field may be derived as 32. In this case, in the first region may indicate a region indicating a top face, the second region may indicate a region indicating a left face, the third region may indicate a region indicating a front face, the fourth region may indicate a region indicating a right face, the fifth region may indicate a region indicating a back face, and the sixth region may indicate a region indicating a bottom face. A type of the quality indication information of the first region to the sixth region may be derived as a degree of compression because the values of the region_quality_indication_type fields of the first region to the sixth region are 2. Accordingly, picture quality differences appearing based on the degrees of compression of the first region to the sixth region may be compared based on the metadata for the quality indication information of the first region to the sixth region.

Furthermore, as shown in (f) of FIG. 11c, metadata for quality indication information may be transmitted with respect to each region. (f) of FIG. 11c may show metadata for quality indication information of each region within a current picture to which 360-degree video data is projected through cube map projection (CMP) and which includes regions having an adjusted size through down-sampling. Furthermore, as shown in (f) of FIG. 11c, the metadata of quality indication information for a plurality of picture quality classification criteria may be transmitted with respect to each region.

Referring to (f) of FIG. 11c, a value of a region_quality_indication_type field included in metadata for the first quality indication information of a first region may be derived as 1, a value of a region_quality_indication_level field may be derived as 1, a value of a region_quality_indication_subtype field may be derived as 0, and a value of a region_quality_indication_info field may be derived as 1. A value of a region_quality_indication_type field included in metadata for first quality indication information of a second region may be derived as 1, a value of a region_quality_indication_level field may be derived as 2, a value of a region_quality_indication_subtype field may be derived as 3, and a value of a region_quality_indication_info field may be derived as 2. A value of a region_quality_indication_type field included in metadata for first quality indication information of a third region may be derived as 1, a value of a region_quality_indication_level field may be derived as 2, a value of a region_quality_indication_subtype field may be derived as 3, and a value of a region_quality_indication_info field may be derived as 2. A value of a region_quality_indication_type field included in metadata for first quality indication information of a fourth region may be derived as 1, a value of a region_quality_indication_level field may be derived as 2, a value of a region_quality_indication_subtype field may be derived as 3, and a value of a region_quality_indication_info field may be derived as 2. A value of a region_quality_indication_type field included in metadata for first quality indication information of a fifth region may be derived as 1, a value of a region_quality_indication_level field may be derived as 2, a value of a region_quality_indication_subtype field may be derived as 3, and a value of a region_quality_indication_info field may be derived as 2. A value of a region_quality_indication_type field included in metadata for first quality indication information of a sixth region may be derived as 1, a value of a region_quality_indication_level field may be derived as 2, a value of a region_quality_indication_subtype field may be derived as 3, and a value of a region_quality_indication_info field may be derived as 2. In this case, the first region may indicate a left top region (Position 0 in (f) of FIG. 11c), the second region may indicate a right top region (Position 1 in (f) of FIG. 11c), the third region may indicate a right region (Position 2 in (f) of FIG. 11c), the fourth region may indicate a left bottom region (Position 3 in (f) of FIG. 11c), the fifth region may indicate a lower region (Position 4 in (f) of FIG. 11c), and the sixth region may indicate a right bottom region (Position 5 in (f) of FIG. 11c). Types of the first quality indication information of the first region to the sixth region may be derived as spatial resolution because the values of the region_quality_indication_type fields for the first quality indication information of the first region to the sixth region are 1. Accordingly, picture quality differences appearing based on the spatial resolutions of the first region to the sixth region may be compared based on the metadata for the first quality indication information of the first region to the sixth region.

Furthermore, referring to (f) of FIG. 11c, a value of a region_quality_indication_type field included in metadata for second quality indication information of the first region may be derived as 2, a value of a region_quality_indication_level field may be derived as 1, and a value of a region_quality_indication_info field may be derived as 24. A value of a region_quality_indication_type field included in metadata for second quality indication information of the second region may be derived as 2, a value of a region_quality_indication_level field may be derived as 3, and a value of a region_quality_indication_info field may be derived as 32. A value of a region_quality_indication_type field included in metadata for second quality indication information of the third region may be derived as 2, a value of a region_quality_indication_level field may be derived as 2, and a value of a region_quality_indication_info field may be derived as 28. A value of a region_quality_indication_type field included in metadata for second quality indication information of the fourth region may be derived as 2, a value of a region_quality_indication_level field may be derived as 2, and a value of a region_quality_indication_info field may be derived as 28. A value of a region_quality_indication_type field included in metadata for second quality indication information of the fifth region may be derived as 2, a value of a region_quality_indication_level field may be derived as 3, and a value of a region_quality_indication_info field may be derived as 32. A value of a region_quality_indication_type field included in metadata for second quality indication information of the sixth region may be derived as 2, a value of a region_quality_indication_level field may be derived as 4, and a value of a region_quality_indication_info field may be derived as 37. In this case, a type of the quality indication information of the first region to the sixth region may be derived as a degree of compression because the values of the region_quality_indication_type fields for the second quality indication information of the first region to the sixth region are 2. Accordingly, picture quality differences appearing based on the degrees of compression of the first region to the sixth region may be compared based on the metadata for the second quality indication information of the first region to the sixth region.

Furthermore, as shown in (g) of FIG. 11c, metadata for quality indication information may be transmitted with respect to each region. (g) of FIG. 11c may show metadata for quality indication information of each region within a current picture onto which 360-degree video data has been projected through truncated square pyramid (TSP) projection. In this case, the TSP may indicate a projection type in which 360-degree video data displayed on a spherical surface is divided in a 3D projection structure of a truncated square pyramid form and projected onto a 2D image. Meanwhile, if 360-degree video data is a current picture projected through the TSP, it may include a region of a trapezoid type. Metadata for quality indication information of the region of a trapezoid type may include a plurality of pieces of subtype information. For example, if quality indication information for spatial resolution of the region is transmitted, metadata for the quality indication information of the region may include information regarding that the trapezoid is formed in which direction, subtype information for scale information of an upper base (or, a base on which trapezoid scaling is performed), subtype information for scale information of a lower base (or, a base parallel to the base on which trapezoid scaling is performed), and subtype information for scale information of the height. In this case, the upper base of the region may indicate a boundary between the region and a region indicating a front face on a 3D space. The lower base of the region may indicate a boundary between the region and a region indicating a back face on the 3D space.

Specifically, referring to (g) of FIG. 11c, a value of the region_quality_indication_type field of the first region may be derived as 1, a value of the region_quality_indication_level field may be derived as 1, a value of region_quality_indication_subtype field may be derived as 0, and a value of the region_quality_indication_info field may be derived as 1. A value of the region_quality_indication_type field of the second region may be derived as 1, a value of the region_quality_indication_level field may be derived as 3, a value of region_quality_indication_subtype field may be derived as 3, and a value of the region_quality_indication_info field may be derived as 3. In this case, the first region may indicate a region indicating a front face, and the second region may include a region indicating a back face.

In this case, a type of the quality indication information of the first region may be derived as spatial resolution because the value of the region_quality_indication_type field of the first region is 1. Accordingly, picture quality differences appearing based on the spatial resolution of the first region may be compared based on the metadata for quality indication information of the first region. Furthermore, a quality level of spatial resolution of the first region may be derived as the highest level because the value of the region_quality_indication_level field of the first region is 1. Resolution of the first region may be derived as the original resolution or resolution, that is, a reference, because the value of region_quality_indication_subtype field of the first region is 0. Furthermore, a type of the quality indication information of the second region may be derived as spatial resolution because the value of the region_quality_indication_type field of the second region is 1. Furthermore, a quality level of the spatial resolution of the second region may be derived as the lowest level because a value of the region_quality_indication_level field of the second region is 3. Resolution of the second region may be derived as the original resolution or resolution scaled in a similar figure as that of resolution, that is, a reference because the value of the region_quality_indication_subtype field of the second region is 3. A scaling factor may be derived as 1/3 because the value of the region_quality_indication_info field of the second region is 3. That is, the region_quality_indication_subtype field and region_quality_indication_info field of the second region may indicate that the resolution of the second region is the original resolution or resolution down-scaled in a similar figure having a ratio of 1/3 from resolution, that is, a reference.

Furthermore, referring to (g) of FIG. 11c, a value of the region_quality_indication_type field of a third region may be derived as 1, a value of the region_quality_indication_level field may be derived as 2, a value of the first region_quality_indication_subtype field may be derived as 7, a value of the first region_quality_indication_info field may be derived as 3, a value of the second region_quality_indication_subtype field may be derived as 1, a value of the second region_quality_indication_info field may be derived as 3, a value of the third region_quality_indication_subtype field may be derived as 2, and a value of the third region_quality_indication_info field may be derived as 1. Furthermore, a value of the region_quality_indication_type field of the fourth region may be derived as 1, a value of the region_quality_indication_level field may be derived as 2, a value of the first region_quality_indication_subtype field may be derived as 5, a value of the first region_quality_indication_info field may be derived as 3, a value of the second region_quality_indication_subtype field may be derived as 1, a value of the second region_quality_indication_info field may be derived as 1, a value of the third region_quality_indication_subtype field may be derived as 2, and a value of the third region_quality_indication_info field may be derived as 3. Furthermore, a value of the region_quality_indication_type field of the fifth region may be derived as 1, a value of the region_quality_indication_level field may be derived as 2, a value of the first region_quality_indication_subtype field may be derived as 6, a value of the first region_quality_indication_info field may be derived as 3, a value of the second region_quality_indication_subtype field may be derived as 1, a value of the second region_quality_indication_info field may be derived as 1, a value of the third region_quality_indication_subtype field may be derived as 2, and a value of the third region_quality_indication_info field may be derived as 3. Furthermore, a value of the region_quality_indication_type field of the sixth region may be derived as 1, a value of the region_quality_indication_level field may be derived as 2, a value of the first region_quality_indication_subtype field may be derived as 4, a value of the first region_quality_indication_info field may be derived as 3, a value of the second region_quality_indication_subtype field may be derived as 1, a value of the second region_quality_indication_info field may be derived as 1, a value of the third region_quality_indication_subtype field may be derived as 2, and a value of the third region_quality_indication_info field may be derived as 3. In this case, the third region may indicate a region indicating a right face, the fourth region may indicate a region indicating a top face, the fifth region may indicate a region indicating a left face, and the sixth region may indicate a region indicating a down face.

In this case, for example, in the case of the sixth region, a type of the quality indication information of the sixth region may be derived as spatial resolution because the value of the region_quality_indication_type field of the sixth region is 1. Accordingly, picture quality differences appearing based on the spatial resolution of the sixth region may be compared based on the metadata for the quality indication information of the sixth region. Furthermore, a quality level of the spatial resolution of the sixth region may be derived as an intermediate level because the value of the region_quality_indication_level field of the sixth region is 2. Furthermore, resolution of the sixth region may be derived as resolution on which scaling has been performed in a trapezoid form having a narrow top because the value of the first region_quality_indication_subtype field of the sixth region is 4. That is, the first region_quality_indication_subtype field of the sixth region may indicate that a form of the sixth region is a trapezoid narrowed in an upper direction. Furthermore, the length of the upper base (i.e., the top boundary) of the sixth region may be derived as 1/3 of the length in the original resolution because the value of the first region_quality_indication_info field is 3. Furthermore, the second region_quality_indication_subtype field of the sixth region and the second region_quality_indication_info field of the sixth region may indicate scale information of the lower base of the sixth region. Specifically, the scaling of the lower base of the sixth region may be derived as horizontal direction scaling because the value of the second region_quality_indication_subtype field of the sixth region is 1. The length of the base line of the sixth region may be derived as the same length as the original resolution or resolution, that is, a reference, because the value of the second region_quality_indication_info field is 1. That is, the second region_quality_indication_info field may indicate that the scaling of the base line of the sixth region is not performed. Furthermore, the third region_quality_indication_subtype field and third region_quality_indication_info field of the sixth region may indicate scale information of the height of the sixth region. Specifically, the scaling of the height of the sixth region may be derived as vertical direction scaling because the value of the third region_quality_indication_subtype field of the sixth region is 2. The height of the sixth region may indicate the height 1/3 down-scaled in a vertical direction from the original resolution or resolution, that is, a reference, because the value of the third region_quality_indication_info field is 3.

As in the sixth region, quality information indicated based on the spatial resolution of each of the third region and the fifth region may be derived based on the metadata for quality indication information of each of the third region to the fifth region.

As described above, if region-wise quality indication information is transmitted, in a receiving stage, a video stream suitable for a receiving stage characteristic may be selected based on the region-wise quality indication information.

Furthermore, as shown in (h) of FIG. 11d, picture quality for a specific picture quality classification criterion for each region of a panorama video may be different. For example, each of regions t₀ to t₂ shown in (h) of FIG. 11d may have different picture quality for a degree of compression. In this case, the metadata of quality indication information for the degree of compression of each of the regions t₀ to t₂ may be transmitted. The receiver may select a region having the best quality level for a degree of compression based on the metadata of quality indication information for compression for each of the regions t₀ to t₂, and may display the selected region. Alternatively, the receiver may perform post-processing for preventing a boundary phenomenon occurring between the regions based on the metadata of quality indication information for the degree of compression of each of the regions t₀ to t₂.

Furthermore, as shown in (i) of FIG. 11e, 360-degree video data may have different picture quality for a specific picture quality classification criterion for each region of a picture projected through octahedron projection (OHP). In this case, the OHP may indicate a projection type in which 360-degree video data shown on a spherical surface is projected onto a 2D image in accordance with a region indicating each face of an octahedron. In this case, the metadata of quality indication information for each of regions 0 to 7 shown in (i) of FIG. 11e may be transmitted. Furthermore, the metadata of quality indication information for a plurality of picture quality classification criteria of each of the regions 0 to 7 may be transmitted. The receiver may perform post-processing for preventing a boundary phenomenon occurring between the regions based on the metadata of quality indication information for each of the regions 0 to 7.

Furthermore, as shown in (j) of FIG. 11e, metadata for quality indication information may be transmitted with respect to each region. (j) of FIG. 11e may indicate metadata for quality indication information of each region within a current picture onto which 360-degree video data has been projected through cube map projection (CMP) and which includes regions having adjusted sizes through down-sampling. Furthermore, as shown in (j) of FIG. 11e, the metadata of quality indication information for a plurality of picture quality classification criteria may be transmitted with respect to each region.

Referring to (j) of FIG. 11e, a value of a region_quality_indication_type field included in metadata for the first quality indication information of a first region may be derived as 1, a value of a region_quality_indication_level field may be derived as 1, a value of a region_quality_indication_subtype field may be derived as 0, and a value of a region_quality_indication_info field may be derived as 1. A value of a region_quality_indication_type field included in the metadata for the first quality indication information of a second region may be derived as 1, a value of a region_quality_indication_level field may be derived as 2, a value of a region_quality_indication_subtype field may be derived as 3, and a value of a region_quality_indication_info field may be derived as 2. A value of a region_quality_indication_type field included in metadata for the first quality indication information of a third region may be derived as 1, a value of a region_quality_indication_level field may be derived as 2, a value of a region_quality_indication_subtype field may be derived as 3, and a value of a region_quality_indication_info field may be derived as 2. A value of a region_quality_indication_type field included in metadata for the first quality indication information of a fourth region may be derived as 1, a value of a region_quality_indication_level field may be derived as 2, a value of a region_quality_indication_subtype field may be derived as 3, and a value of a region_quality_indication_info field may be derived as 2. A value of a region_quality_indication_type field included in metadata for the first quality indication information of a fifth region may be derived as 1, a value of a region_quality_indication_level field may be derived as 2, a value of a region_quality_indication_subtype field may be derived as 3, and a value of a region_quality_indication_info field may be derived as 2. A value of the region_quality_indication_type field included in metadata for the first quality indication information of a sixth region may be derived as 1, a value of a region_quality_indication_level field may be derived as 2, a value of a region_quality_indication_subtype field may be derived as 3, and a value of a region_quality_indication_info field may be derived as 2. In this case, the first region may indicate a left top region (Position 0 in (j) of FIG. 11e), the second region may indicate a right top region (Position 1 in (j) of FIG. 11e), the third region may indicate a right region (Position 2 in (j) of FIG. 11e), the fourth region may indicate a left bottom region (Position 3 in (j) of FIG. 11e), the fifth region may indicate a lower region (Position 4 in (j) of FIG. 11e), and the sixth region may indicate a right bottom region (Position 5 in (j) of FIG. 11e). A type of the first quality indication information of the first region to the sixth region may be derived as spatial resolution because the values of the region_quality_indication_type fields for the first quality indication information of the first region to the sixth region are 1. Accordingly, picture quality differences appearing based on the spatial resolution of the first region to the sixth region may be compared based on the metadata for the first quality indication information of the first region to the sixth region.

Furthermore, referring to (j) of FIG. 11e, a value of a region_quality_indication_type field included in metadata for the second quality indication information of the first region may be derived as 2, a value of a region_quality_indication_level field may be derived as 1, and a value of a region_quality_indication_info field may be derived as 24. A value of a region_quality_indication_type field included in metadata for the second quality indication information of the second region may be derived as 2, a value of a region_quality_indication_level field may be derived as 3, and a value of a region_quality_indication_info field may be derived as 32. A value of a region_quality_indication_type field included in metadata for the second quality indication information of the third region may be derived as 2, a value of a region_quality_indication_level field may be derived as 3, and a value of a region_quality_indication_info field may be derived as 32. A value of a region_quality_indication_type field included in metadata for the second quality indication information of the fourth region may be derived as 2, a value of a region_quality_indication_level field may be derived as 2, and a value of a region_quality_indication_info field may be derived as 28. A value of a region_quality_indication_type field included in metadata for the second quality indication information of the fifth region may be derived as 2, a value of a region_quality_indication_level field may be derived as 3, and a value of a region_quality_indication_info field may be derived as 32. A value of a region_quality_indication_type field included in metadata for the second quality indication information of the sixth region may be derived as 2, a value of a region_quality_indication_level field may be derived as 2, and a value of a region_quality_indication_info field may be derived as 28. In this case, a type of the quality indication information of the first region to the sixth region may be derived as a degree of compression because the values of the region_quality_indication_type fields for the second quality indication information of the first region to the sixth region are 2. Accordingly, picture quality differences appearing based on the degrees of compression of the first region to the sixth region may be compared based on the metadata for the second quality indication information of the first region to the sixth region.

Meanwhile, metadata for quality indication information for each of the core region and processing region of each region illustrated in (j) of FIG. 11e may be transmitted. That is, a region_quality_indication_type field, a region_quality_indication_level field, a region_quality_indication_subtype field, and a region_quality_indication_info field for the core region of each region may be transmitted. A region_quality_indication_type field, a region_quality_indication_level field, a region_quality_indication_subtype field, and a region_quality_indication_info field for the processing region of each region may be transmitted. In this case, the region_quality_indication_type field, the region_quality_indication_level field, region_quality_indication_subtype field, and the region_quality_indication_info field for the core region, and the region_quality_indication_type field, the region_quality_indication_level field, the region_quality_indication_subtype field, and the region_quality_indication_info field for the processing region may have different values. Meanwhile, in this case, the core region may indicate an area in which the region boundary processing is not performed in each region, and the processing region may indicate an area in which the region boundary processing is performed within each region.

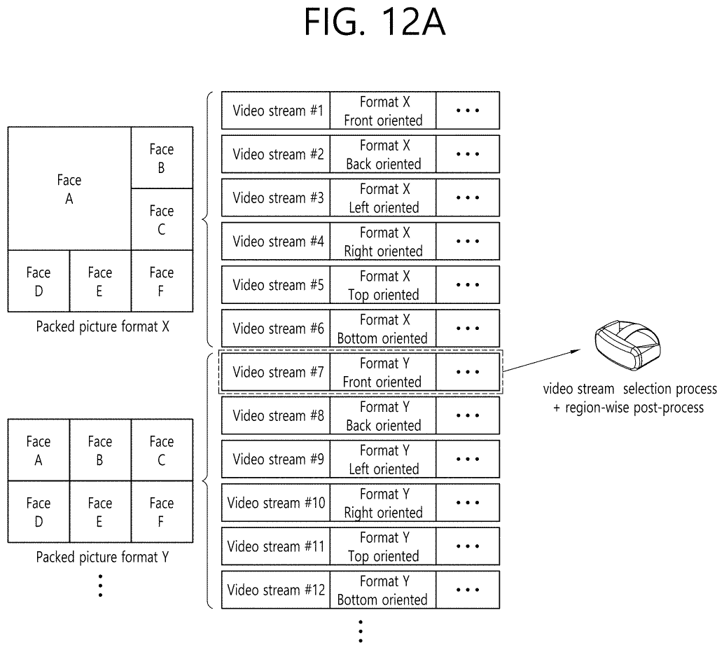

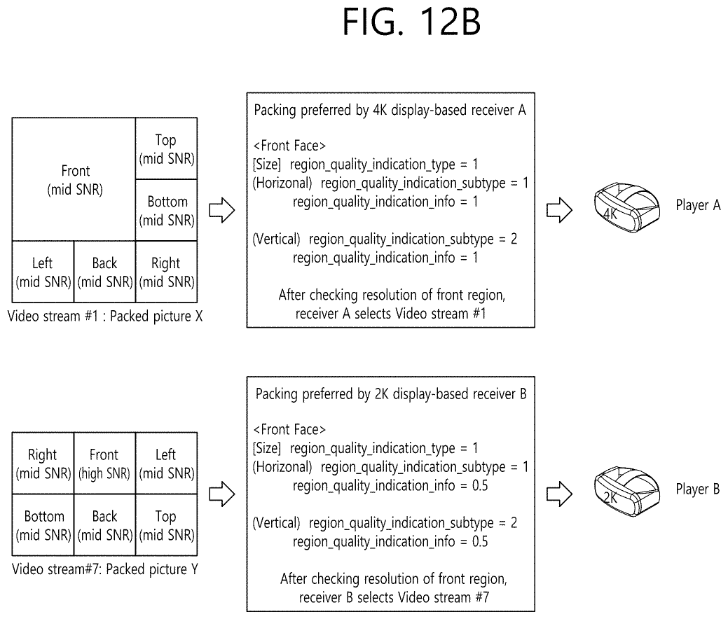

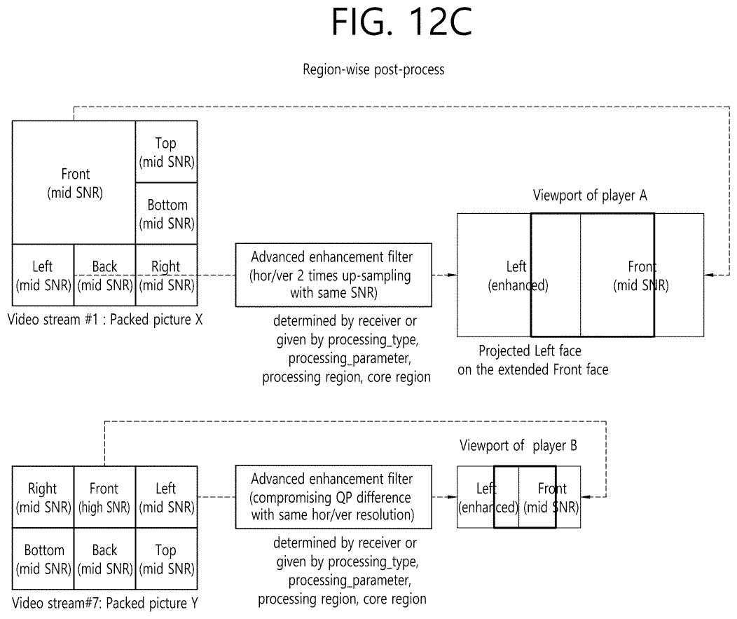

FIGS. 12a to 12c illustrate embodiments in which a video stream is selected based on region-wise quality indication information. FIG. 12a may show an example in which the receiver selects a video stream based on the region-wise quality indication information. For example, if a front face region has been selected as a region in the receiver, if only information on relative quality priority between regions within a picture is present without information on a type to classify differences between detailed picture qualities, both a video stream 1 (video stream #1) and a video stream 7 (video stream #7) shown in FIG. 12a may become the subject of selection of the receiver. In this case, the front face region may be a region indicating the front face of a cube on a 3D space. A face A region within the packed picture X of the video stream 1 shown in FIG. 12a may indicate the front face region of the packed picture X. A Face A region within the packed picture Y of the video stream 7 may indicate the front face region of the packed picture Y. However, in the present disclosure, as described above, if detailed information on picture quality of each of the regions within the picture is present, each of the 4 k display-based receiver and the 2 k display-based receiver may select and use a video stream most suitable for the hardware characteristic of the receiver. As shown in FIG. 12a, there may be the video stream 1, including the packed picture X configured to have its front face region having higher resolution than surrounding areas, and the video stream 7, including the packed picture Y configured to have its front face region having the same resolution as surrounding areas, but have a higher SNR. The video stream 7 complying with a characteristic preferred by the receiver may be selected.

FIG. 12b may show another example in which the 4 k display-based receiver and the 2 k display-based receiver select a video stream based on the region-wise quality indication information. Referring to FIG. 12b, a value of the region_quality_indication_type field of the front face region of the packed picture X may be 1, a value of the first region_quality_indication_subtype field may be 1, a value of the first region_quality_indication_info field may be 1, a value of the second region_quality_indication_subtype field is 2, and a value of the second region_quality_indication_info field may be 1. A value of the region_quality_indication_type field of the front face region of the packed picture Y may be 1, a value of the first region_quality_indication_subtype field may be 1, a value of the first region_quality_indication_info field may be 0.5, a value of the second region_quality_indication_subtype field is 2, and a value of the second region_quality_indication_info field may be 0.5. The 4 k display-based receiver and the 2 k display-based receiver may determine that spatial resolution (a value of the region_quality_indication_type field is 1) of the front face region of the packed picture X is resolution that has been horizontally down-scaled one times compared to the original resolution (a value of the first region_quality_indication_subtype field is 1, and a value of the first region_quality_indication_info field is 1) and that has been vertically down-scaled one times (a value of the second region_quality_indication_subtype field is 1 and a value of the second region_quality_indication_info field is 1) based on metadata for the region-wise quality indication information of the front face region of the packed picture X and metadata for region-wise quality indication information of the packed picture Y of the front face region, and may determine that spatial resolution of the front face region of the packed picture Y (a value of the region_quality_indication_type field is 1) is resolution that has been horizontally down-scaled ½ times compared to the original resolution (a value of the first region_quality_indication_subtype field is 1, and a value of the first region_quality_indication_info field is 0.5) and that has been vertically down-scaled ½ times (a value of the second region_quality_indication_subtype field is 1 and a value of the second region_quality_indication_info field is 0.5), that is, that has been down-scaled ¼ times compared to the original resolution, based on the metadata. Accordingly, the 4 k display-based receiver may select the video stream 1 including the packed picture X having great spatial resolution of the front face region because display resolution is great. The 4 k display-based receiver may select the video stream 7 including the packed picture Y having small spatial resolution of the front face region because display resolution is small.

Meanwhile, a video stream preferred by the receiver, that is, having quality_indication_type or region_quality_indication_type of top priority may be rapidly selected based on the type_priority_index[i] field or the region_quality_indication_type_inter_type_index[i][j] field. Furthermore, the receiver may determine whether there is another video stream, including a region having a preference (i.e., priority) indicated by the region_quality_indication_type_inter_stream_index[i][j] field, based on the region_quality_indication_type_inter_stream_index[i][j] field, and may determine whether there is a video stream having a higher position with respect to a picture quality classification type indicated by a specific region_quality_indication_type field of a specific region, thus improving the accuracy of selection.

FIG. 12c may show another example in which the 4 k display-based receiver and the 2 k display-based receiver select a video stream based on the region-wise quality indication information. Referring to FIG. 12c, a value of the region_quality_indication_type field of the front face region of a packed picture X may be 1, a value of the first region_quality_indication_subtype field may be 1, a value of the first region_quality_indication_info field may be 1, a value of the second region_quality_indication_subtype field may be 2, and a value of the second region_quality_indication_info field may be 1. A value of the region_quality_indication_type field of the left face region of the packed picture X may be 1, a value of the first region_quality_indication_subtype field may be 1, a value of the first region_quality_indication_info field may be 0.5, a value of the second region_quality_indication_subtype field may be 2, and a value of the second region_quality_indication_info field may be 0.5. Furthermore, a value of the region_quality_indication_type field of the front face region of the packed picture Y may be 2, and a value of the region_quality_indication_info field may be 24. A value of the region_quality_indication_type field of the left face region of a packed picture Y may be 2, and a value of the region_quality_indication_info field may be 32. A region other than the front face region may enter a viewport if an angle of view of the receiver is wide or due to a change in the viewpoint of a viewer. At this time, a surrounding area having relatively low picture quality is included and displayed to the viewer. In this case, the receiver can reduce a picture quality difference between the front face region and the surrounding area by performing filtering on an image of the surrounding area.

For example, the viewpoint of a viewer may move to the left, and images of the front face region and the left face region may be included in the viewport. In the case of the video stream 1, filtering performed based on an up-sampling filter in order to increase resolution of the image included in the left face region may be more effective in reducing a picture quality difference between the front face region and the left face region compared to filtering performed based on a normal filter. The receiver may derive size information for the front face region and the left face region in a horizontal direction and size information for the front face region and the left face region in a vertical direction based on metadata of quality indication information (the region_quality_indication_type field, the region_quality_indication_subtype field, and the region_quality_indication_info field for the front face region and the left face region) for the front face region and left face region of the video stream, and may adjust a filter coefficient used for the filtering based on the derived information. Alternatively, the receiver may derive a filter used for the filtering based on the filtering information forwarded through a method proposed in the present disclosure, that is, the processing_type field, the processing_parameter field, and information related to the processing region and the core region for the front face region and the left face region.

Furthermore, in the case of the video stream 7, the front face region and the left face region have the same size, but have different SNRs. The receiver can enhance resolution of the left face region by restoring a high frequency component of the left face region having a low SNR using an edge enhancement filter. Specifically, the receiver may obtain the region_quality_indication_type fields of the front face region and the left face region. If a value of the region_quality_indication_type field is 2, the receiver can adjust the strength of the filter coefficient of the edge enhancement filter based on an objective value (e.g., QP) for an SNR difference between the front face region and the left face region, which is derived based on given region_quality_indication_info information. In this case, the receiver may directly adjust the filter coefficient or may derive a filter used for the filtering based on filtering information forwarded through a method proposed in the present disclosure, that is, the processing_type field, the processing_parameter field, and information related to the processing region and the core region for the front face region and the left face region. Accordingly, the receiver can perform filtering on the left face region using a filter intended by a transmitter.

Meanwhile, in order to forward metadata for region-wise quality indication information, RegionWiseQualityIndicationSEIBox may be newly defined. The RegionWiseQualityIndicationSEIBox may include an SEI NAL unit including the metadata for region-wise quality indication information. The SEI NAL unit may include an SEI message including the metadata for region-wise quality indication information. The RegionWiseQualityIndicationSEIBox may be included and forwarded in VisualSampleEntry, AVCSampleEntry, MVCSampleEntry, SVCSampleEntry, HEVCSampleEntry, etc.

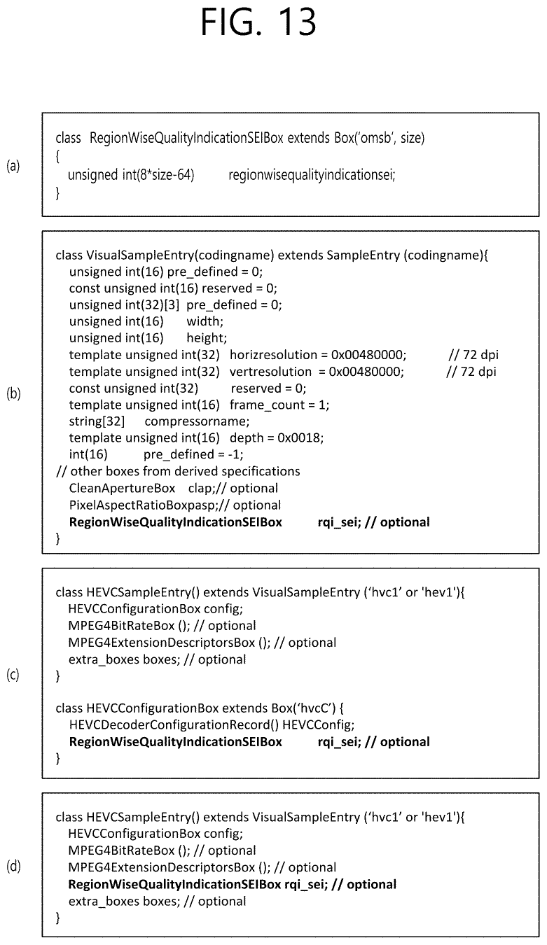

FIG. 13 illustrates RegionWiseQualityIndicationSEIBox included and transmitted in VisualSampleEntry or HEVCSampleEntry. Referring to FIG. 13(a), the RegionWiseQualityIndicationSEIBox may include a regionwisequalityindicationsei field. The regionwisequalityindicationsei field may include an SEI NAL unit including the metadata for region-wise quality indication information. The metadata is the same as that described above. The regionwisequalityindicationsei field may be indicated as an rqi_sei field.

Furthermore, the RegionWiseQualityIndicationSEIBox may be included and forwarded in VisualSampleEntry, AVCSampleEntry, MVCSampleEntry, SVCSampleEntry, HEVCSampleEntry, etc.

For example, referring to FIG. 13(b), the RegionWiseQualityIndicationSEIBox may be included and transmitted in the VisualSampleEntry. The VisualSampleEntry may include an rqi_sei field indicating whether the RegionWiseQualityIndicationSEIBox is applied. If the rqi_sei field indicates that the RegionWiseQualityIndicationSEIBox is applied to the VisualSampleEntry, metadata for region-wise quality indication information included in the RegionWiseQualityIndicationSEIBox may be copied and applied to the VisualSampleEntry without any change.

Furthermore, for example, referring to FIG. 13(c), the RegionWiseQualityIndicationSEIBox may be included and transmitted in HEVCDecoderConfigurationRecord of the HEVCSampleEntry. The HEVCDecoderConfigurationRecord of the HEVCSampleEntry may include an rqi_sei field indicating whether the RegionWiseQualityIndicationSEIBox is applied. If the rqi_sei field indicates that the RegionWiseQualityIndicationSEIBox is applied to the HEVCDecoderConfigurationRecord, metadata for region-wise quality indication information included in the RegionWiseQualityIndicationSEIBox may be copied and applied to the HEVCDecoderConfigurationRecord without any change.

Furthermore, for example, referring to FIG. 13(d), the RegionWiseQualityIndicationSEIBox may be included and transmitted in the HEVCSampleEntry. The HEVCSampleEntrymay include an rqi_sei field indicating whether the RegionWiseQualityIndicationSEIBox is applied. If the rqi_sei field indicates that the RegionWiseQualityIndicationSEIBox is applied to the HEVCSampleEntry, metadata for region-wise quality indication information included in the RegionWiseQualityIndicationSEIBox may be copied and applied to the HEVCSampleEntry without any change.

Meanwhile, the RegionWiseQualityIndicationSEIBox may include supplemental enhancement information (SEI) or video usability information (VUI) of an image including the proposed region-wise quality indication information for a target region. Accordingly, different region-wise quality indication information can be signaled for each region of a video frame forwarded through a file format.

For example, a video may be stored based on an ISO base media file format (ISOBMFF). Metadata for region-wise quality indication information associated with a video track (or bit stream), a sample, or a sample group may be stored and signaled. Specifically, metadata for region-wise quality indication information may be included and stored on a file format of a visual sample entry. Furthermore, metadata for region-wise quality indication information may be included and applied to a file format having a different form, for example, a Common file format. Metadata for region-wise quality indication information associated with a video track or a sample for a video within one file may be stored in the following box form.

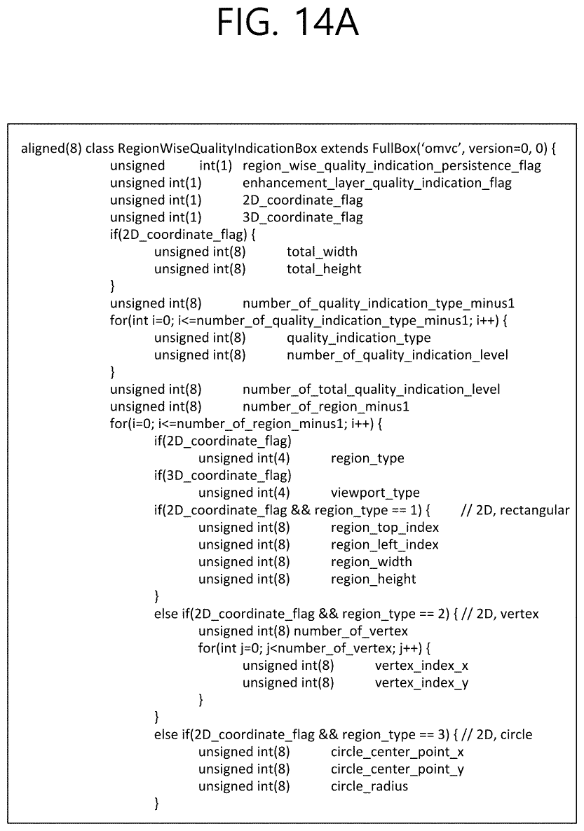

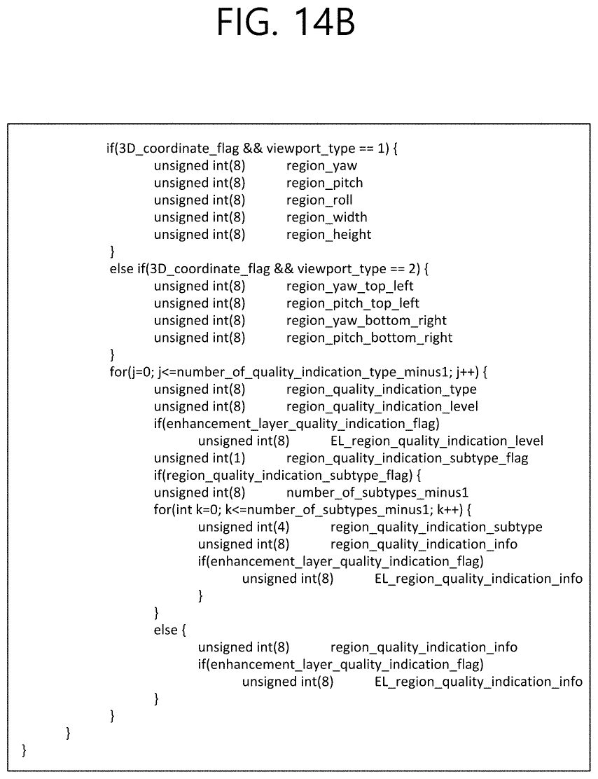

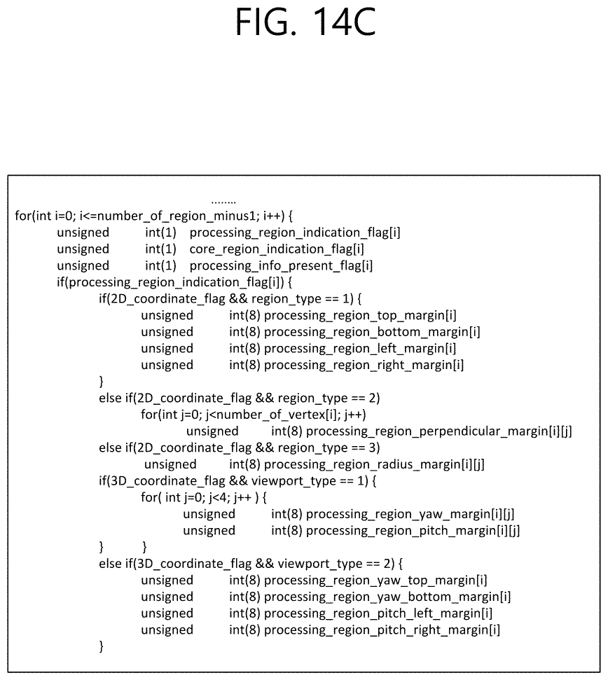

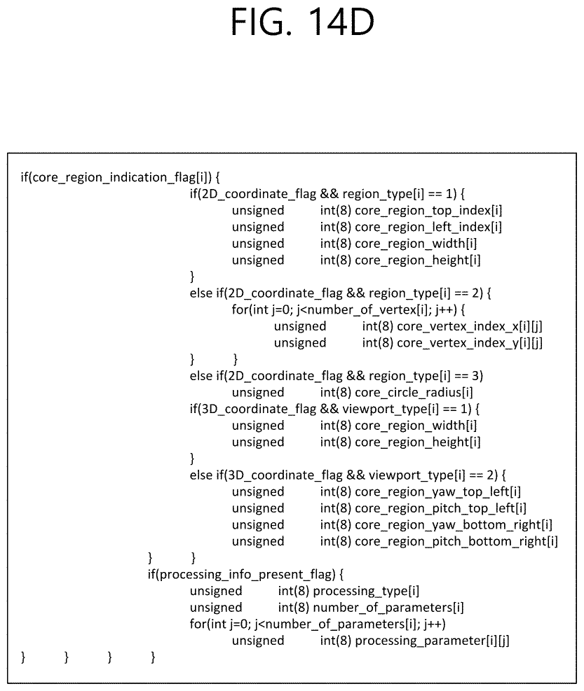

FIGS. 14a to 14d illustrate RegionWiseQualityIndicationBox within ISOBMFF according to an embodiment of the present disclosure.

The RegionWiseQualityIndicationBox may include a region_wise_quality_indication_persistence_flag field, an enhancement_layer_quality_indication_flag field, a 2D_coordinate_flag field and a 3D_coordinate_flag field. The definition of the fields is the same as that described above.

Furthermore, if a value of a 2D_coordinate_flag field for a region of the current picture is 1, the RegionWiseQualityIndicationBox may include a total_width field and total_height field for the current picture. The definition of the fields is the same as that described above. Furthermore, the RegionWiseQualityIndicationBox may include a number_of_quality_indication_type_minus1 field, a quality_indication_type field, a number_of_quality_indication_level field, a number_of_total_quality_indication_level field, and a number_of_region_minus1 field for the current picture. The definition of the fields is the same as that described above.

Furthermore, if a value of the 2D_coordinate_flag field is 1, the RegionWiseQualityIndicationBox may include a region_type field for the region. Furthermore, if a value of the 3D_coordinate_flag field is 1, the RegionWiseQualityIndicationBox may include a viewport_type field for the region.

Furthermore, if a value of the 2D_coordinate_flag field is 1 and a value of the region_type field is 1, the RegionWiseQualityIndicationBox may include a region_top_index field, a region_left_index field, a region_width field and a region_height field for the region. The definition of the fields is the same as that described above.

Furthermore, if a value of the 2D_coordinate_flag field is 1 and a value of the region_type field is 2, the RegionWiseQualityIndicationBox may include a number_of_vertex field, a vertex_index_x field and a vertex_index_y field for the region. The definition of the fields is the same as that described above.

Furthermore, if a value of the 2D_coordinate_flag field is 1 and a value of the region_type field is 3, the RegionWiseQualityIndicationBox may include a circle_center_point_x field, a circle_center_point_y field and a circle_radius field for the region. The definition of the fields is the same as that described above.

Furthermore, if a value of the 3D_coordinate_flag field is 1 and a value of the viewport_type field is 1, the RegionWiseQualityIndicationBox may include a region_yaw field, a region_pitch field, a region_roll field, a region_width field and a region_height field for the region. The definition of the fields is the same as that described above.

Furthermore, if a value of the 3D_coordinate_flag field is 1 and a value of the viewport_type field is 2, the RegionWiseQualityIndicationBox may include a region_yaw_top_left field, a region_pitch_top_left field, a region_yaw_bottom_right field and a region_pitch_bottom_right field for the region. The definition of the fields is the same as that described above.

Furthermore, the RegionWiseQualityIndicationBox may include a region_quality_indication_type field and a region_quality_indication_level field for the region. Furthermore, if a value of the enhancement_layer_quality_indication_flag field is 1, the RegionWiseQualityIndicationBox may include an EL_region_quality_indication_level field for the region. The definition of the fields is the same as that described above.

Furthermore, the RegionWiseQualityIndicationBox may include a region_quality_indication_subtype_flag field for the region. Furthermore, if a value of the region_quality_indication_subtype_flag field is 1, the RegionWiseQualityIndicationBox may include a number_of_subtypes_minus 1 field, a region_quality_indication_subtype field, and a region_quality_indication_info field for the region. Furthermore, if a value of the region_quality_indication_subtype_flag field is 1 and a value of the enhancement_layer_quality_indication_flag field is 1, the RegionWiseQualityIndicationBox may include an EL_region_quality_indication_info field for the region. The definition of the fields is the same as that described above.

Furthermore, the RegionWiseQualityIndicationBox may include a processing_region_indication_flag field, a core_region_indication_flag field and a processing_info_present_flag field for the region of the current picture. Furthermore, if a value of the processing_region_indication_flag field is 1, a value of the 2D_coordinate_flag field is 1, and a value of the region_type field is 1, the RegionWiseQualityIndicationBox may include a processing_region_top_margin field, a processing_region_bottom_margin field, a processing_region_left_margin field and a processing_region_right_margin field for the region. The definition of the fields is the same as that described above.

Furthermore, if a value of the processing_region_indication_flag field is 1, a value of the 2D_coordinate_flag field is 1, and a value of the region_type field is 2, the RegionWiseQualityIndicationBox may include a processing_region_perpendicular_margin field for the region. The definition of the field is the same as that described above.

Furthermore, if a value of the processing_region_indication_flag field is 1, a value of the 2D_coordinate_flag field is 1, and a value of the region_type field is 3, the RegionWiseQualityIndicationBox may include a processing_region_radius_margin field for the region. The definition of the field is the same as that described above.

Furthermore, if a value of the processing_region_indication_flag field is 1, a value of the 3D_coordinate_flag field is 1, and a value of the viewport_type field is 1, the RegionWiseQualityIndicationBox may include a processing_region_yaw_margin field and a processing_region_pitch_margin field for the region. The definition of the fields is the same as that described above.

Furthermore, if a value of the processing_region_indication_flag field is 1, a value of the 3D_coordinate_flag field is 1, and a value of the viewport_type field is 2, the RegionWiseQualityIndicationBox may include a processing_region_yaw_top_margin field, a processing_region_yaw_bottom_margin field, a processing_region_pitch_left_margin field and a processing_region_pitch_right_margin field for the region. The definition of the fields is the same as that described above.

Furthermore, if a value of the core_region_indication_flag field is 1, a value of the 2D_coordinate_flag field is 1, and a value of the region_type field is 1, the RegionWiseQualityIndicationBox may include a core_region_top_index field, a core_region_left_index field, a core_region_width field and a core_region_height field for the region. The definition of the fields is the same as that described above.

Furthermore, if a value of the core_region_indication_flag field is 1, a value of the 2D_coordinate_flag field is 1, and a value of the region_type field is 2, the RegionWiseQualityIndicationBox may include a core_vertex_index_x field and a core_vertex_index_y field for the region. The definition of the field is the same as that described above.

Furthermore, if a value of the core_region_indication_flag field is 1, a value of the 2D_coordinate_flag field is 1, and a value of the region_type field is 3, the RegionWiseQualityIndicationBox may include a core_circle_radius field for the region. The definition of the field is the same as that described above.

Furthermore, if a value of the core_region_indication_flag field is 1, a value of the 3D_coordinate_flag field is 1, and a value of the viewport_type field is 1, the RegionWiseQualityIndicationBox may include a core_region_width field and a core_region_height field for the region. The definition of the fields is the same as that described above.

Furthermore, if a value of the core_region_indication_flag field is 1, a value of the 3D_coordinate_flag field is 1, and a value of the viewport_type field is 2, the RegionWiseQualityIndicationBox may include a core_region_yaw_top_left field, a core_region_pitch_top_left field, a core_region_yaw_bottom_right field and a core_region_pitch_bottom_right field for the region. The definition of the fields is the same as that described above.

Furthermore, a value of the processing_info_present_flag field is 1, the RegionWiseQualityIndicationBox may include a processing_type field, a number_of_parameters field and a processing_parameter field for the region.

Meanwhile, the region-wise quality indication information may be included and transmitted in a RegionWiseAuxiliarylnformationStruct(rwai) class. The RegionWiseAuxiliaryInformationStruct(rwai) class may be defined as timed metadata. The timed metadata may be defined as metadata having a value varying based on a change in time. The RegionWiseAuxiliaryInformationStruct(rwai) class defined as the timed metadata may be derived like the following table.

TABLE 6

class RegionWiseAuxilizryInformationSampleEntry(type) extends

MetadataSampleEntry (type){
RegionWiseAuxiliaryInformationStruct ( );
Box [ ] other_boxes;

}

Table 6 may show an example in which the RegionWiseAuxiliaryInformationStruct class is defined as the timed metadata. If the region-wise quality indication information is identically to all samples regarding 360-degree video data, as shown in Table 6, the RegionWiseAuxiliaryInformationStruct class may be included in MetadataSampleEntry of a timed metadata track or a header (e.g., moov or moof). The definition of the fields of the metadata for region-wise quality indication information included in the RegionWiseAuxiliaryInformationStruct class may be the same as that described above. The fields may be applied to all metadata samples within mdat.

Meanwhile, if the region-wise additional information is differently applied to samples regarding 360-degree video data, the RegionWiseAuxiliaryInformationStruct(rwai) class defined as the timed metadata may be derived like the following table.

TABLE 7

aligned (8) RegionWiseAuxiliaryInformationSample ( ) {

RegionWiseAuxiliarylnformationStruct ( )

}

As shown in Table 7, the RegionWiseAuxiliaryInformationStruct class may be included in the RegionWiseAuxiliaryInformationSample box. Meanwhile, even in this case, the region-wise quality indication information for the entire video sequence within a file format may be forwarded. In this case, as shown in Table 6, the region-wise quality indication information for the entire video sequence may be included in the MetadataSampleEntry of the timed metadata track. The meaning of the fields of the RegionWiseAuxiliaryInformationStruct class may be expanded to indicate the region-wise quality indication information for the entire video sequence.

Meanwhile, if a broadcasting service for 360-degree video is provided through a DASH-based adaptive streaming model or a 360-degree video is streamed through a DASH-based adaptive streaming model, the fields of the metadata for region-wise quality indication information may be signaled in the form of a DASH-based descriptor included in DASH MPD. That is, the embodiments of the metadata for region-wise quality indication information may be rewritten in the DASH-based descriptor form. The DASH-based descriptor form may include an essential property (EssentialProperty) descriptor and a supplemental property (SupplementalProperty) descriptor. A descriptor indicating the fields of the metadata for region-wise quality indication information may be included in the adaptation set (AdaptationSet), representation (Representation) or a sub-representation (SubRepresentation) of an MPD. Accordingly, a client or a 360-degree video reception apparatus can obtain fields related to region-wise quality indication information, and can perform the process of a 360-degree video based on the fields.

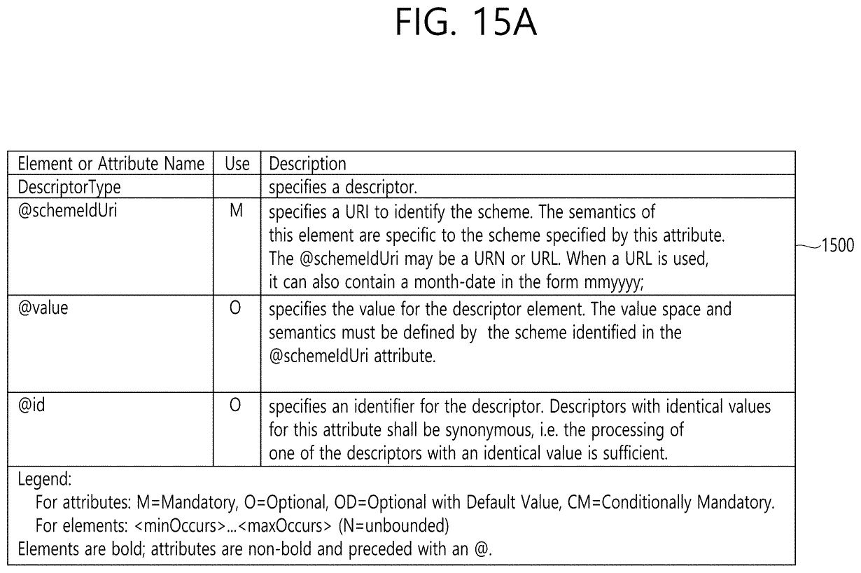

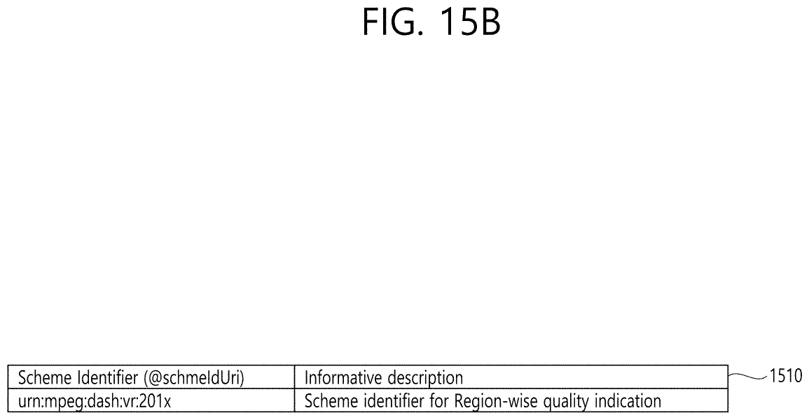

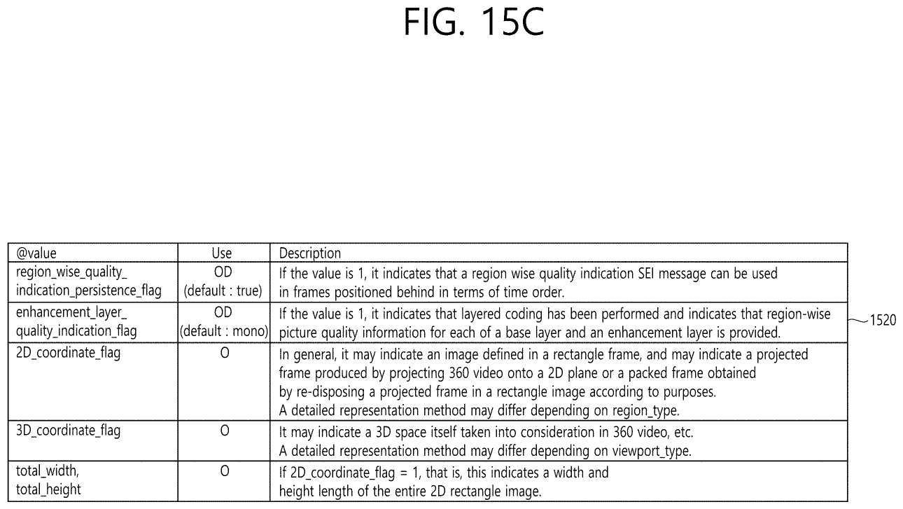

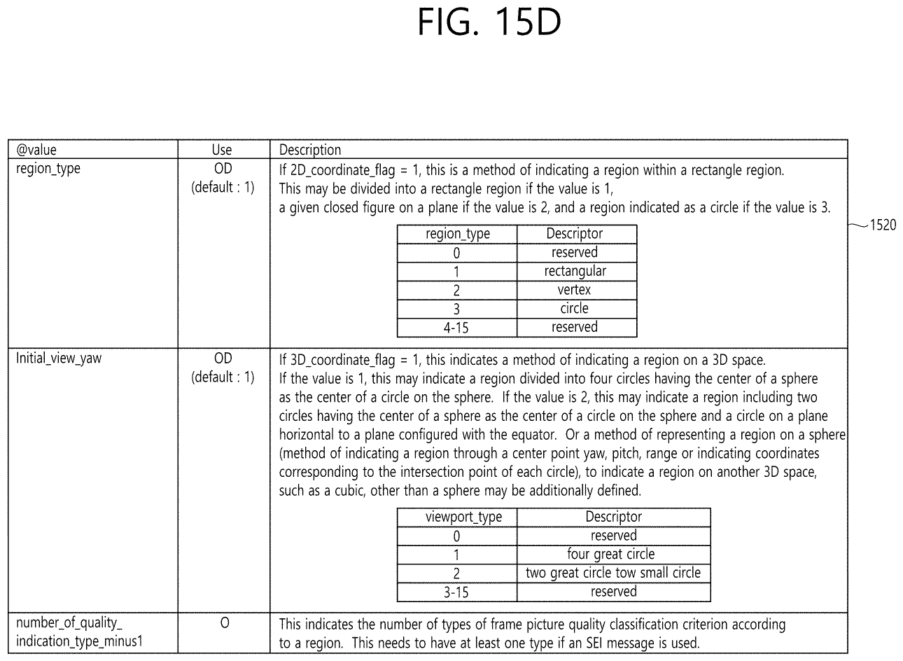

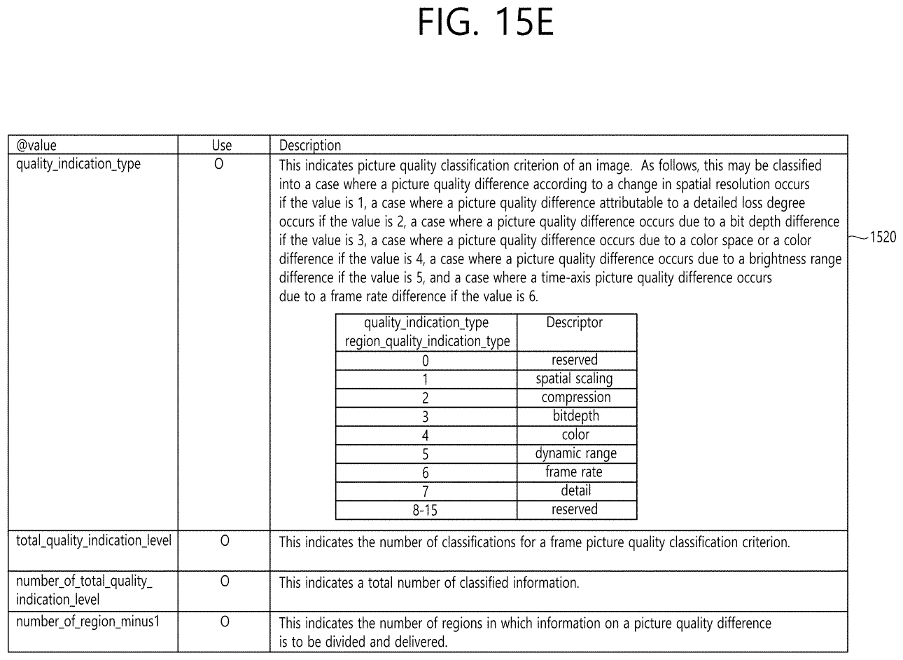

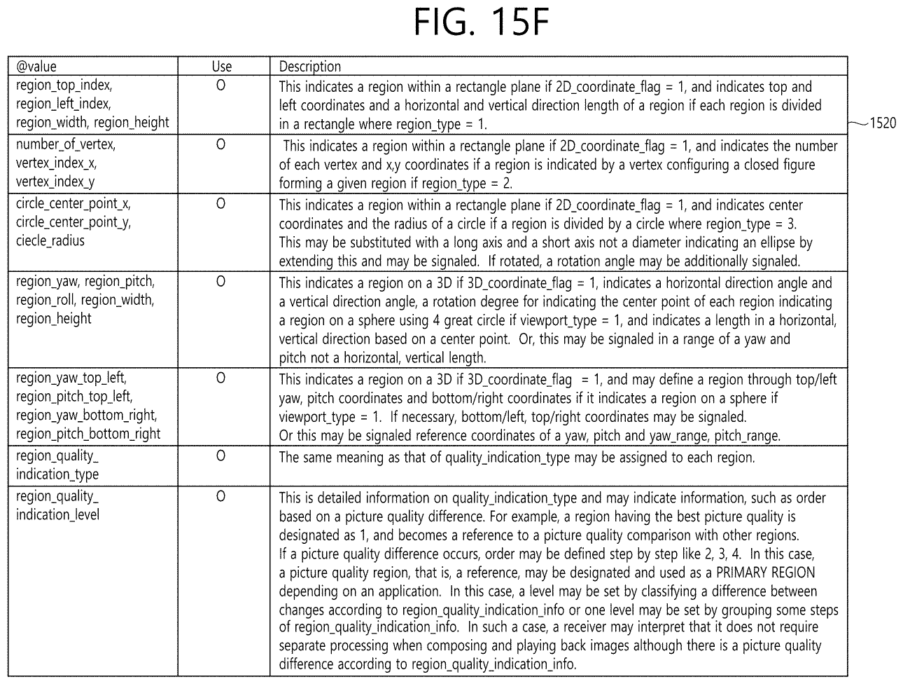

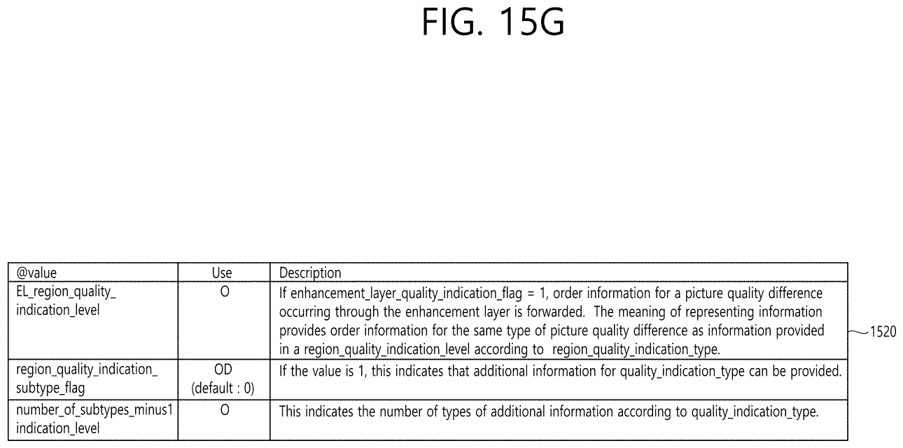

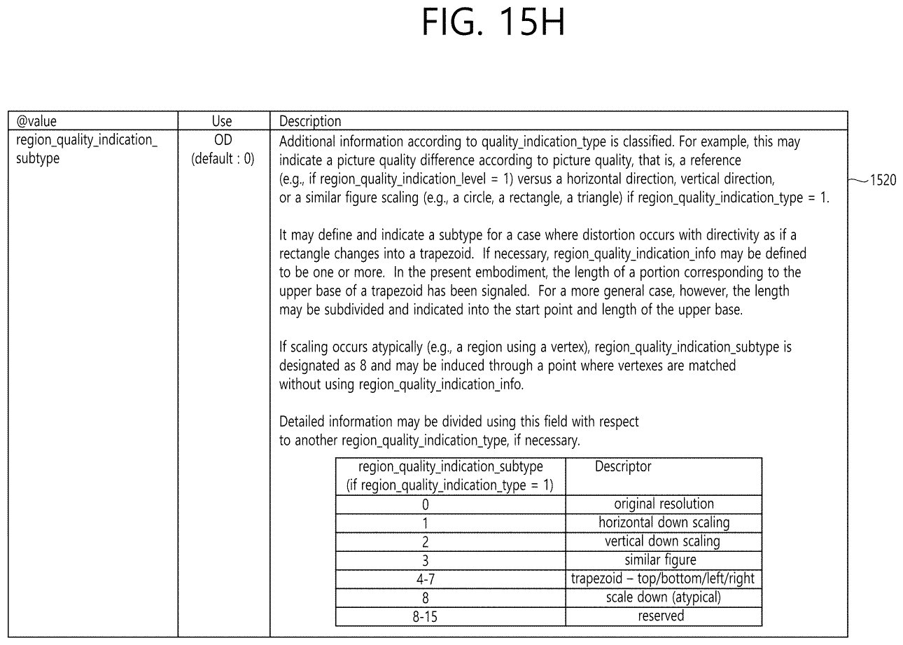

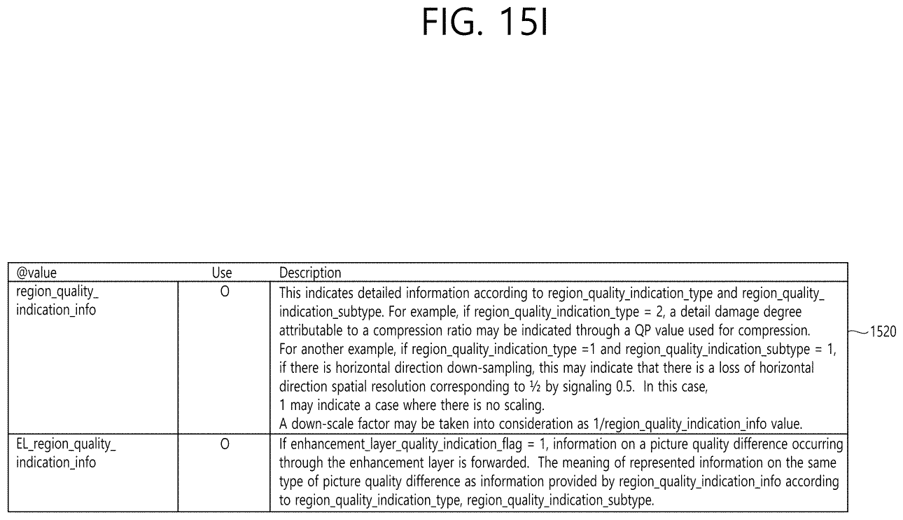

FIGS. 15a to 15i illustrate examples of region-wise quality indication information-related metadata described in a DASH-based descriptor form. As shown in 1500 of FIG. 15a, the DASH-based descriptor may include a @schemeIdUri field, a @value field and/or a @id field. The @ schemeIdUri field may provide a URI for identifying the scheme of the corresponding descriptor. The @value field may have values whose meanings are defined by a scheme indicated by the @schemeIdUri field. That is, the @value field may nave values of descriptor elements according to a corresponding scheme, and the values may be called parameters. The parameters may be classified by “,.” The @id may indicate the identifier of the corresponding descriptor. If the @id has the same identifier, it may include the same scheme identifier, value, and parameter.

Furthermore, as shown in 1510 of FIG. 15b, in the case of a descriptor that forwards metadata related to the region-wise quality indication information, a @ schemeIdURI field may have a urn:mpeg:dash:vr:201x value. The value may be a value to identify that the corresponding descriptor is a descriptor that forwards metadata related to region-wise quality indication information.

The @value field of the descriptor that forwards metadata related to each of pieces of region-wise quality indication information may have values, such as 1520 of FIGS. 15c to 15i. That is, parameters classified by “,” of the @value may correspond to respective fields of the metadata related to region-wise quality indication information. 1520 of FIGS. 15c to 15i describes one of various embodiments of the metadata related to region-wise quality indication information as the parameter of @ value, but all the embodiments of the metadata related to region-wise quality indication information may be described as the parameter of @value by substituting signaling fields with parameters. That is, the metadata related to region-wise quality indication information according to all the embodiment may also be described as a DASH-based descriptor form.

In 1520 of FIGS. 15c to 15i, each of the parameters may have the same meaning as the signaling field having the same name. In this case, M may mean that a corresponding parameter is a mandatory parameter (Mandatory), O may mean that a corresponding parameter is an optional parameter (Optional), and OD may mean that a corresponding parameter is an optional parameter having a default value (Optional with Default). If a parameter value, that is, OD, is not given, a predefined default value may be used as a corresponding parameter value. In the illustrated embodiment, a default value of each OD parameter has been given within parentheses.

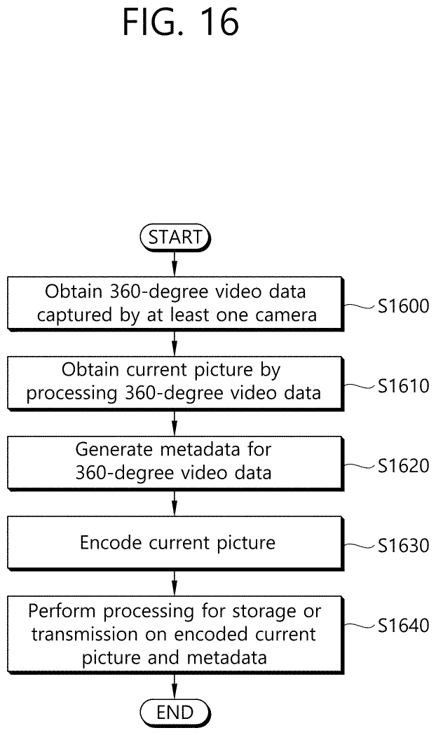

FIG. 16 schematically illustrates a 360-degree video data processing method performed by a 360-degree video transmission apparatus according to the present disclosure. The method disclosed in FIG. 16 may be performed by the 360-degree video transmission apparatus disclosed in FIG. 5. Specifically, for example, in FIG. 16, S1600 may be performed by the input unit of the 360-degree video transmission apparatus, S1610 may be performed by the projection processor of the 360-degree video transmission apparatus, S1620 may be performed by the metadata processor of the 360-degree video transmission apparatus, S1630 may be performed by the input encoder of the 360-degree video transmission apparatus, and S1640 may be performed by the transmission processor of the 360-degree video transmission apparatus. The transmission processor may be included in a transmission unit.

The 360-degree video transmission apparatus obtains 360-degree video data captured by at least one camera (S1600). The 360-degree video transmission apparatus may obtain the 360-degree video data captured by at least one camera. The 360-degree video data may be video captured by at least one camera.

The 360-degree video transmission apparatus obtains a current picture by processing the 360-degree video data (S1610). The 360-degree video transmission apparatus may perform projection on a 2D image according to a projection scheme for the 360-degree video data, among several projection schemes, and may obtain a projected picture. The several projection schemes may include an equirectangular projection scheme, a cubic projection scheme, a cylinder type projection scheme, a tile-based projection scheme, a pyramid projection scheme, a panoramic projection scheme, and a specific scheme for direct projection onto a 2D image without stitching. Furthermore, the projection schemes may include an octahedron projection scheme, an icosahedron projection scheme, and a truncated square pyramid projection scheme. Meanwhile, of the projection scheme information indicates a specific scheme, the at least one camera may be a fish-eye camera. In this case, an image obtained by each of the cameras may be a circular image. The projected picture may include regions indicating the faces of a 3D projection structure of the projection scheme.

Furthermore, the 360-degree video transmission apparatus may perform processing, such as that each of the regions of the projected picture is rotated and rearranged or that resolution of each region is changed. The processing process may be called the region-wise packing process.

The 360-degree video transmission apparatus may not apply a region-wise packing process to the projected picture. In this case, the projected picture may indicate the current picture.

Or, the 360-degree video transmission apparatus may apply a region-wise packing process to the projected picture, and may obtain the packed picture including a region to which the region-wise packing process has been applied. In this case, the packed picture may indicate the current picture.

The 360-degree video transmission apparatus generates metadata for the 360-degree video data (S1620). The metadata may include the region_wise_quality_indication_cancel_flag field, the region_wise_quality_indication_persistence_flag field, the enhancement_layer_quality_indication_flag field, the 2D_coordinate_flag field, the 3D_coordinate_flag field, the total_width field, the total_height field, the number_of_quality_indication_type_minus1 field, the quality_indication_type field, the type_priority_index field, the number_of_quality_indication_level field, the number_of_total_quality_indication_level field, the number_of_region_minus1 field, the region_type field, the viewport_type field, the region_top_index field, the region_left_index field, the region_width field, the region_height field, the number_of_vertex field, the vertex_index_x field, the vertex_index_y field, the circle_center_point_x field, the circle_center_point_y field, the circle_radius field, the region_yaw field, the region_pitch field, the region_roll field, the region_width field, the region_height field, the region_yaw_top_left field, the region_pitch_top_left field, the region_yaw_bottom_right field, the region_pitch_bottom_right field, the region_quality_indication_type field, the region_quality_indication_level field, the region_quality_indication_type_inter_type_index field, the region_quality_indication_type_inter_region_index field, the region_quality_indication_type_inter_stream_index field, the EL_region_quality_indication_level field, the region_quality_indication_subtype_flag field, the number_of_subtypes_minus1 field, the region_quality_indication_subtype field, the region_quality_indication_info field, the EL_region_quality_indication_info field, the region_quality_indication_info field, the EL_region_quality_indication_info field, the processing_region_indication_flag field, the core_region_indication_flag field, the processing_info_present_flag field, the processing_region_top_margin field, the processing_region_bottom_margin field, the processing_region_left_margin field, the processing_region_right_margin field, the processing_region_perpendicular_margin field, the processing_region_radius_margin field, the processing_region_yaw_margin field, the processing_region_pitch_margin field, the processing_region_yaw_top_margin field, the processing_region_yaw_bottom_margin field, the processing_region_pitch_left_margin field, the processing_region_pitch_right_margin field, the core_region_top_index field, the core_region_left_index field, the core_region_width field, the core_region_height field, the core_vertex_index_x field, the core_vertex_index_y field, the core_circle_radius field, the core_region_width field, the core_region_height field, the core_region_yaw_top_left field, the core_region_pitch_top_left field, the core_region_yaw_bottom_right field, the core_region_pitch_bottom_right field, the processing_type field, the number_of_parameters field and/or the processing_parameter field. The meanings of the fields are the same as those described above.

Specifically, for example, the metadata may include information indicating a quality type of a target region within the current picture and information indicating a level of the quality type. The information indicating the quality type may indicate the region_quality_indication_type field. The information indicating the level of the quality type may indicate the region_quality_indication_level field.

For example, the quality type may be one of spatial resolution, a degree of compression, a bit depth, a color, a brightness range, or a frame rate.

Specifically, for example, when a value of the information indicating the quality type is 1, the information indicating the quality type may indicate spatial resolution as the quality type. Furthermore, when a value of the information indicating the quality type is 2, the information indicating the quality type may indicate a degree of compression as the quality type. Furthermore, when a value of the information indicating the quality type is 3, the information indicating the quality type may indicate a bit depth as the quality type. Furthermore, when a value of the information indicating the quality type is 4, the information indicating the quality type may indicate a color as the quality type. Furthermore, when a value of the information indicating the quality type is 5, the information indicating the quality type may indicate a brightness range as the quality type. Furthermore, when a value of the information indicating the quality type is 6, the information indicating the quality type may indicate a frame rate as the quality type.

Furthermore, the metadata may include information indicating priority of the target region, among regions within the current picture indicated based on the quality type. The information indicating the priority of the target region, among the regions within the current picture indicated based on the quality type, may indicate the region_quality_indication_type_inter_region_index field.

Furthermore, the metadata may include information indicating priority of the target region, among the target region indicated based on the quality type and the corresponding regions of the target region. The information indicating the priority of the target region, among the target region indicated based on the quality type and the corresponding regions of the target region, may indicate the region_quality_indication_type_inter_stream_index field. In this case, the corresponding regions may indicate regions at the same position as the target region in video streams other than a video stream including the current picture.

Furthermore, the metadata may include detailed information of the quality type. The detailed information of the quality type may indicate the region_quality_indication_info field. For example, if the information indicating the quality type indicates spatial resolution as the quality type, the detailed information of the quality type may indicate a scaling factor. Specifically, the scaling factor may be derived as a reciprocal of a value indicated by the detailed information of the quality type. Furthermore, if the information indicating the quality type indicates a degree of compression as the quality type, the detailed information of the quality type may indicate a damage degree attributable to a compression ratio.

Furthermore, the metadata may include information indicating a subtype of the quality type. The information indicating the subtype of the quality type may indicate the region_quality_indication_subtype field. For example, if the information indicating the quality type indicates spatial resolution as the quality type, the subtype may be one of horizontal down scaling, vertical down scaling, similar figure down scaling, trapezoid down scaling and atypical down scaling.

Specifically, for example, when a value of the information indicating the subtype of the quality type is 1, the information indicating the subtype of the quality type may indicate horizontal down scaling as a subtype of the quality type. Furthermore, when a value of the information indicating the subtype of the quality type is 2, the information indicating the subtype of the quality type may indicate vertical down scaling as the subtype of the quality type. Furthermore, when a value of the information indicating the subtype of the quality type is 3, the information indicating the subtype of the quality type may indicate similar figure down scaling as the subtype of the quality type. Furthermore, when a value of the information indicating the subtype of the quality type is 4, the information indicating the subtype of the quality type may indicate trapezoid down scaling, performed based on the top boundary of the target region, as the subtype of the quality type. Furthermore, when a value of the information indicating the subtype of the quality type is 5, the information indicating the subtype of the quality type may indicate trapezoid down scaling, performed based on the bottom boundary of the target region, as the subtype of the quality type. Furthermore, when a value of the information indicating the subtype of the quality type is 6, the information indicating the subtype of the quality type may indicate trapezoid down scaling, performed based on the left boundary of the target region, as the subtype of the quality type. Furthermore, when a value of the information indicating the subtype of the quality type is 7, the information indicating the subtype of the quality type may indicate trapezoid down scaling, performed based on the right boundary of the target region, as the subtype of the quality type. Furthermore, when a value of the information indicating the subtype of the quality type is 8, the information indicating the subtype of the quality type may indicate atypical down scaling as the subtype of the quality type.

Furthermore, the metadata may include information indicating a plurality of subtypes of the quality type. In this case, the metadata may include information indicating the number of subtypes of the quality type. The information indicating the number of subtypes of the quality type may indicate the number_of_subtypes_minus1 field.

Furthermore, the metadata may include pieces of information indicating a plurality of quality types of the target region. In this case, the metadata may include information on a quality type indicated of each of the pieces of information indicating the plurality of quality types. That is, the metadata may include information indicating a level of each of the quality types of the target region, information indicating a subtype of each of the quality types and/or detailed information of each of the quality types. In other words, the metadata may include information indicating the level of each of the quality types indicted by the pieces of information indicating the plurality of quality types, and may include detailed information of each of the quality types. Furthermore, the metadata may include information indicating a subtype of each of the quality types. In this case, the metadata may include information indicating the number of quality types of the target region. The information indicating the number of quality types of the target region may indicate the number_of_quality_indication_type_minus1 field.

Furthermore, the metadata may include information indicating priority of each of the quality types. The information indicating the priority of each of the quality types may indicate the region_quality_indication_type_inter_type_index field.

Furthermore, the metadata may include a flag indicating whether information on the area in which post-processing is performed in the target region is forwarded. When a value of the flag is 1, the metadata may include information indicating the area in which post-processing is performed in the target region. The flag indicating whether information on the area in which post-processing is performed in the target region is forwarded may indicate the processing_region_indication_flag field.

Specifically, a flag indicating whether information on a 2D coordinate system is transmitted and information indicating a type of the target region may be transmitted. When a value of the flag indicating whether information on the area in which post-processing is performed in the target region is forwarded is 1, a value of the flag indicating whether information on a 2D coordinate system is transmitted is 1, and information indicating the type of the target region indicates a rectangle as the type of the target region, the metadata may include information indicating a distance from the top boundary of the target region, information indicating a distance from the bottom boundary of the target region, information indicating a distance from the left boundary of the target region, and information indicating a distance from the right boundary of the target region. In this case, the area in which post-processing is performed may be derived as an area from the top boundary to the distance from the top boundary, that is, an area that neighbors the top boundary and that has the top boundary as the width and the distance from the top boundary as the height. Furthermore, the area in which post-processing is performed may be derived as an area from the bottom boundary to the distance from the bottom boundary, that is, an area that neighbors the bottom boundary and that has the bottom boundary as the width and the distance from the bottom boundary as the height. Furthermore, the area in which post-processing is performed may be derived as an area from the left boundary to the distance from the left boundary, that is, an area that neighbors the left boundary and that has the left boundary as the height and the distance from the left boundary as the width. Furthermore, the area in which post-processing is performed may be derived as an area from the right boundary to the distance from the right boundary, that is, an area that neighbors the right boundary and that has the right boundary as the height and the distance from the right boundary as the width.

In this case, the flag indicating whether information on a 2D coordinate system is transmitted may indicate the 2D_coordinate_flag field. The information indicating the type of the target region may indicate the region_type field. Furthermore, the information indicating the distance from the top boundary of the target region may indicate the processing_region_top_margin field. The information indicating the distance from the bottom boundary of the target region may indicate the processing_region_bottom_margin field. The information indicating the distance from the left boundary of the target region may indicate the processing_region_left_margin field. The information indicating the distance from the right boundary of the target region may indicate the processing_region_right_margin field.

Furthermore, When a value of the flag indicating whether information on the area in which post-processing is performed in the target region is forwarded is 1, a value of the flag indicating whether information on a 2D coordinate system is transmitted is 1, and the information indicating the type of the target region indicates a given closed figure as the type of the target region, the metadata may include information indicating a distance from a boundary configured with the j-th vertex and (j+1)-th vertex of the target region. In this case, the area in which post-processing is performed in the target region may be derived as an area from the boundary configured with the j-th vertex and the (j+1)-th vertex to a distance indicated by the information. That is, the area in which post-processing is performed in the target region may be derived as an area that neighbors the boundary configured with the j-th vertex and the (j+1)-th vertex and that has the boundary as the width and the distance indicated by the information as the height.

Furthermore, When a value of the flag indicating whether information on the area in which post-processing is performed in the target region is forwarded is 1, a value of the flag indicating whether information on a 2D coordinate system is transmitted is 1, and the information indicating the type of the target region indicates a circle as the type of the target region, the metadata may include information indicating a distance from a boundary of the target region. In this case, the area in which post-processing is performed in the target region may be derived as an area from the boundary to the distance indicated by the information. That is, the area in which post-processing is performed in the target region may be derived as an area of a doughnut shape from the boundary to the distance indicated by the information.

Furthermore, a flag indicating whether information on a 3D coordinate system is transmitted and information indicating a type of the viewport may be transmitted. When a value of the flag indicating whether information on the area in which post-processing is performed in the target region is forwarded is 1, a value of the flag indicating whether information on a 3D coordinate system is transmitted is 1, and the information indicating the type of the viewport indicates a type indicating the target region based on four great circles, the metadata may include information indicating coordinates on a vertical line passing through the center of the target region and information indicating coordinates on a horizontal line passing through the center of the target region. That is, the information indicating the coordinates on the vertical line passing through the center of the target region may indicate the processing_region_yaw_margin field. The information indicating the coordinates on the horizontal line passing through the center of the target region may indicate the processing_region_pitch_margin field.

Furthermore, a flag indicating whether information on a 3D coordinate system is transmitted and information indicating a type of the viewport may be transmitted. When a value of the flag indicating whether information on the area in which post-processing is performed in the target region is forwarded is 1, a value of the flag indicating whether information on a 3D coordinate system is transmitted is 1, and the information indicating the type of the viewport indicates a type indicating the target region based on two great circles and two small circles, the metadata may include information indicating a distance from the top boundary of the target region, information indicating a distance from the bottom boundary of the target region, information indicating a distance from the left boundary of the target region, and information indicating a distance from the right boundary of the target region. The information indicating the distance from the top boundary of the target region may indicate the processing_region_yaw_top_margin field. The information indicating the distance from the bottom boundary of the target region may indicate the processing_region_yaw_bottom_margin field. The information indicating the distance from the left boundary of the target region may indicate the processing_region_pitch_left_margin field. The information indicating the distance from the right boundary of the target region may indicate the processing_region_pitch_right_margin field.

Furthermore, the metadata may include a flag indicating whether information on the area in which post-processing is not performed in the target region is forwarded. When a value of the flag is 1, the metadata may include information indicating the area in which post-processing is not performed in the target region. The flag indicating whether information on the area in which post-processing is not performed in the target region is forwarded may indicate the core_region_indication_flag field.

Specifically, a flag indicating whether information on a 2D coordinate system is transmitted and information indicating a type of the target region may be transmitted. When a value of the flag indicating whether the information on the area in which post-processing is not performed in the target region is forwarded is 1, a value of the flag indicating whether information on a 2D coordinate system is transmitted is 1, and information indicating the type of the target region indicates a rectangle as the type of the target region, the metadata may include information indicating the x component of the left top sample of the area in which post-processing is not performed in the target region, information indicating the y component of the left top sample of the area in which post-processing is not performed in the target region, information indicating the width of the area in which post-processing is not performed in the target region, and information indicating the height of the area in which post-processing is not performed in the target region. The information indicating the y component of the left top sample of the area in which post-processing is not performed in the target region may indicate the core_region_top_index field. The information indicating the x component of the left top sample of the area in which post-processing is not performed in the target region may indicate the core_region_left_index field. The information indicating the width of the area in which post-processing is not performed in the target region may indicate the core_region_width field. The information indicating the height of the area in which post-processing is not performed in the target region may indicate the core_region_height field.

Furthermore, When a value of the flag indicating whether information on the area in which post-processing is not performed in the target region is forwarded is 1, a value of the flag indicating whether information on a 2D coordinate system is transmitted is 1, and the information indicating the type of the target region indicates a given closed figure as the type of the target region, the metadata may include information indicating the x component of a vertex of the area in which post-processing is not performed in the target region and information indicating the y component of a vertex of the area in which post-processing is not performed. The information indicating the x component of the vertex of the area in which post-processing is not performed in the target region may indicate the core_vertex_index_x field. The information indicating the y component of the vertex of the area in which post-processing is not performed in the target region may indicate the core_vertex_index_y field.

Furthermore, When a value of the flag indicating whether information on the area in which post-processing is not performed in the target region is forwarded is 1, a value of the flag indicating whether information on a 2D coordinate system is transmitted is 1, and the information indicating the type of the target region indicates a circle as the type of the target region, the metadata may include information indicating the radius of the area in which post-processing is not performed in the target region. The information indicating the radius of the area in which post-processing is not performed in the target region may indicate the core_circle_radius field.

Furthermore, a flag indicating whether information on a 3D coordinate system is transmitted and information indicating the type of the viewport may be transmitted. When a value of the flag indicating whether information on the area in which post-processing is not performed in the target region is forwarded is 1, a value of the flag indicating whether information on a 3D coordinate system is transmitted is 1, and the information indicating the type of the viewport indicates a type indicating the target region based on four great circles, the metadata may include information indicating the width of the area in which post-processing is not performed in the target region and information indicating the height of the area in which post-processing is not performed in the target region. The information indicating the width of the area in which post-processing is not performed in the target region may indicate the core_region_width field. The information indicating the height of the area in which post-processing is not performed in the target region may indicate the core_region_height field.

Furthermore, a flag indicating whether information on a 3D coordinate system is transmitted and information indicating the type of the viewport may be transmitted. When a value of the flag indicating whether information on the area in which post-processing is not information on a 3D coordinate system is transmitted is 1, and information indicating the type of the viewport indicates a type indicating the target region based on two great circles and two small circles, the metadata may include information indicating a yaw value of the left top sample of the area in which post-processing is not performed in the target region, information indicating a pitch value of the left top sample of the area in which post-processing is not performed in the target region, information indicating a yaw value of the right bottom sample of the area in which post-processing is not performed in the target region, and information indicating a pitch value of the right bottom sample of the area in which post-processing is not performed in the target region. The information indicating a yaw value of the left top sample of the area in which post-processing is not performed in the target region may indicate the core_region_yaw_top_left field. The information indicating a pitch value of the left top sample of the area in which post-processing is not performed in the target region may indicate the core_region_pitch_top_left field. The information indicating a yaw value of the right bottom sample of the area in which post-processing is not performed in the target region may indicate the core_region_yaw_bottom_right field. The information indicating a pitch value of the right bottom sample of the area in which post-processing is not performed in the target region may indicate the core_region_pitch_bottom_right field.

Furthermore, the metadata may include a flag indicating whether detailed information on the post-processing is forwarded. When a value of the flag is 1, the metadata may include information indicating a filter used in the post-processing, information indicating the number of filter coefficients of the filter, and information indicating a value of each of the filter coefficients. The filter used in the post-processing may be one of a smoothing filter, a blending filter, an enhancement filter and a restoration filter.

Specifically, for example, when a value of the information indicating the filter used in the post-processing is 1, the information indicating a filter used in the post-processing may indicate a smoothing filter as the filter used in the post-processing. Furthermore, when a value of the information indicating the filter used in the post-processing is 2, the information indicating a filter used in the post-processing may indicate a blending filter as the filter used in the post-processing. Furthermore, when a value of the information indicating the filter used in the post-processing is 3, the information indicating a filter used in the post-processing may indicate an enhancement filter as the filter used in the post-processing. Furthermore, when a value of the information indicating the filter used in the post-processing is 4, the information indicating a filter used in the post-processing may indicate a restoration filter as a filter used in the post-processing.

The information indicating a filter used in the post-processing may indicate the processing_type field. The information indicating the number of filter coefficients of the filter may indicate the number_of_parameters field. The information indicating a value of each of the filter coefficients may indicate the processing_parameter field.

Meanwhile, the metadata may be transmitted through an SEI message. Furthermore, the metadata may be included in an adaptation set (AdaptationSet), representation (Representation) or sub-representation (SubRepresentation) of a media presentation description (MPD). In this case, the SEI message may be used to assist the decoding of a 2D image or the display of a 2D image in a 3D space.

The 360-degree video transmission apparatus encodes the current picture (S1630). The 360-degree video transmission apparatus may encode the current picture. Furthermore, the 360-degree video transmission apparatus may encode the metadata.

The 360-degree video transmission apparatus performs processing for storage or transmission on the encoded current picture and metadata (S1640). The 360-degree video transmission apparatus may encapsulate the encoded 360-degree video data and/or metadata in a form, such as a file. The 360-degree video transmission apparatus may encapsulate the encoded 360-degree video data and/or metadata in a file format, such as an ISOBMFF or a CFF, or in a form, such as other DASH segment, in order to store or transmit the encoded 360-degree video data and/or metadata. The 360-degree video transmission apparatus may include the metadata in a file format. For example, the metadata may be included in the box of various levels in the ISOBMFF file format or may be included as data within a separate track. Furthermore, the 360-degree video transmission apparatus may encapsulate the metadata itself as a file. The 360-degree video transmission apparatus may apply processing for transmission to the 360-degree video data encapsulated according to a file format. The 360-degree video transmission apparatus may process the 360-degree video data according to a given transport protocol. The processing for transmission may include processing for forwarding over a broadcast network, processing for forwarding over a communication network, such as a broadband, etc. Furthermore, the 360-degree video transmission apparatus may apply processing for transmission to the metadata. The 360-degree video transmission apparatus may transmit the 360-degree video data and metadata on which processing for transmission has been performed over a broadcast network and/or through a broadband.

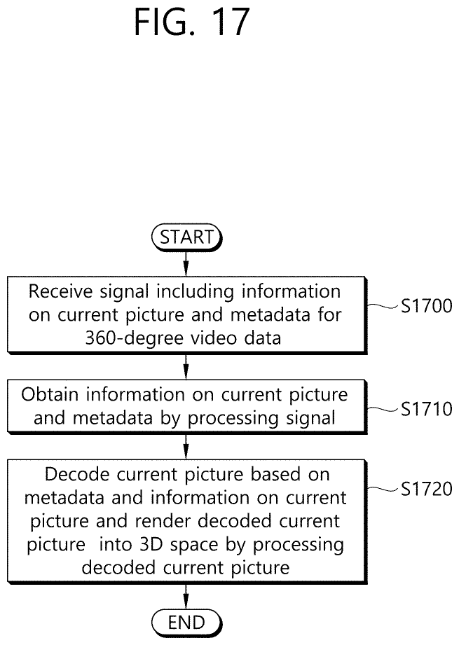

FIG. 17 schematically illustrates a 360-degree video data processing method performed by the 360-degree video reception apparatus according to the present disclosure. The method disclosed in FIG. 17 may be performed by the 360-degree video reception apparatus disclosed in FIG. 6. Specifically, for example, in FIG. 17, S1700 may be performed by the reception unit of the 360-degree video reception apparatus, S1710 may be performed by the reception processor of the 360-degree video reception apparatus, and S1720 may be performed by the data decoder and renderer of the 360-degree video reception apparatus.

The 360-degree video reception apparatus receives a signal, including information on a current picture related to 360-degree video data and metadata for the 360-degree video data (S1700). The 360-degree video reception apparatus may receive the information on the current picture and the metadata for the 360-degree video data, signaled by the 360-degree video transmission apparatus, over a broadcast network. Furthermore, the 360-degree video reception apparatus may receive the information on the current picture and the metadata over a communication network, such as a broadband, or through a storage medium.

The 360-degree video reception apparatus obtains the information on the current picture and the metadata by processing the received signal (S1710). The 360-degree video reception apparatus may perform processing according to a transport protocol on the received information on the current picture and the received metadata. Furthermore, the 360-degree video reception apparatus may perform a process opposite the processing for the transmission of the 360-degree video transmission apparatus.

The metadata may include the region_wise_quality_indication_cancel_flag field, the region_wise_quality_indication_persistence_flag field, the enhancement_layer_quality_indication_flag field, the 2D_coordinate_flag field, the 3D_coordinate_flag field, the total_width field, the total_height field, the number_of_quality_indication_type_minus1 field, the quality_indication_type field, the type_priority_index field, the number_of_quality_indication_level field, the number_of_total_quality_indication_level field, the number_of_region_minus1 field, the region_type field, the viewport_type field, the region_top_index field, the region_left_index field, the region_width field, the region_height field, the number_of_vertex field, the vertex_index_x field, the vertex_index_y field, the circle_center_point_x field, the circle_center_point_y field, the circle_radius field, the region_yaw field, the region_pitch field, the region_roll field, the region_width field, the region_height field, the region_yaw_top_left field, the region_pitch_top_left field, the region_yaw_bottom_right field, the region_pitch_bottom_right field, the region_quality_indication_type field, the region_quality_indication_level field, the region_quality_indication_type_inter_type_index field, the region_quality_indication_type_inter_region_index field, the region_quality_indication_type_inter_stream_index field, the EL_region_quality_indication_level field, the region_quality_indication_subtype_flag field, the number_of_subtypes_minus 1 field, the region_quality_indication_subtype field, the region_quality_indication_info field, the EL_region_quality_indication_info field, the region_quality_indication_info field, the EL_region_quality_indication_info field, the processing_region_indication_flag field, the core_region_indication_flag field, the processing_info_present_flag field, the processing_region_top_margin field, the processing_region_bottom_margin field, the processing_region_left_margin field, the processing_region_right_margin field, the processing_region_perpendicular_margin field, the processing_region_radius_margin field, the processing_region_yaw_margin field, the processing_region_pitch_margin field, the processing_region_yaw_top_margin field, the processing_region_yaw_bottom_margin field, the processing_region_pitch_left_margin field, the processing_region_pitch_right_margin field, the core_region_top_index field, the core_region_left_index field, the core_region_width field, the core_region_height field, the core_vertex_index_x field, the core_vertex_index_y field, the core_circle_radius field, the core_region_width field, the core_region_height field, the core_region_yaw_top_left field, the core_region_pitch_top_left field, the core_region_yaw_bottom_right field, the core_region_pitch_bottom_right field, the processing_type field, the number_of_parameters field and/or the processing_parameter field. The meanings of the fields are the same as those described above.

Specifically, for example, the metadata may include information indicating a quality type of a target region within the current picture and information indicating a level of the quality type. The information indicating the quality type may indicate the region_quality_indication_type field. The information indicating a level of the quality type may indicate the region_quality_indication_level field.

For example, the quality type may be one of spatial resolution, a degree of compression, a bit depth, a color, a brightness range, or a frame rate.

Specifically, for example, when a value of the information indicating the quality type is 1, the information indicating the quality type may indicate spatial resolution as the quality type. Furthermore, when a value of the information indicating the quality type is 2, the information indicating the quality type may indicate a degree of compression as the quality type. Furthermore, when a value of the information indicating the quality type is 3, the information indicating the quality type may indicate a bit depth as the quality type. Furthermore, when a value of the information indicating the quality type is 4, the information indicating the quality type may indicate a color as the quality type. Furthermore, when a value of the information indicating the quality type is 5, the information indicating the quality type may indicate a brightness range as the quality type. Furthermore, when a value of the information indicating the quality type is 6, the information indicating the quality type may indicate a frame rate as the quality type.

Furthermore, the metadata may include information indicating priority of a target region, among regions within the current picture indicated based on the quality type. The information indicating priority of the target region among regions within the current picture indicated based on the quality type may indicate the region_quality_indication_type_inter_region_index field.

Furthermore, the metadata may include information indicating priority of the target region, among the target region indicated based on the quality type and the corresponding regions of the target region. The information indicating priority of the target region, among the target region indicated based on the quality type and the corresponding regions of the target region, may indicate the region_quality_indication_type_inter_stream_index field. In this case, the corresponding regions may indicate regions at the same position as the target region in video streams other than a video stream including the current picture.

Furthermore, the metadata may include detailed information of the quality type. The detailed information of the quality type may indicate the region_quality_indication_info field. For example, if the information indicating the quality type indicates spatial resolution as the quality type, the detailed information of the quality type may indicate a scaling factor. Specifically, the scaling factor may be derived as a reciprocal of a value indicated by the detailed information of the quality type. Furthermore, if the information indicating the quality type indicates a degree of compression as the quality type, the detailed information of the quality type may indicate a damage degree attributable to a compression ratio.

Furthermore, the metadata may include information indicating a subtype of the quality type. The information indicating a subtype of the quality type may indicate the region_quality_indication_subtype field. For example, if the information indicating the quality type indicates spatial resolution as the quality type, the subtype may be one of horizontal down scaling, vertical down scaling, similar figure down scaling, trapezoid down scaling or atypical down scaling.

Specifically, for example, when a value of the information indicating the subtype of the quality type is 1, the information indicating the subtype of the quality type may indicate horizontal down scaling as the subtype of the quality type. Furthermore, when a value of the information indicating the subtype of the quality type is 2, the information indicating the subtype of the quality type may indicate vertical down scaling as the subtype of the quality type. Furthermore, when a value of the information indicating the subtype of the quality type is 3, the information indicating the subtype of the quality type may indicate similar figure down scaling as the subtype of the quality type. Furthermore, when a value of the information indicating the subtype of the quality type is 4, the information indicating the subtype of the quality type may indicate trapezoid down scaling, performed based on the top boundary of the target region, as the subtype of the quality type. Furthermore, when a value of the information indicating the subtype of the quality type is 5, the information indicating the subtype of the quality type may indicate trapezoid down scaling, performed based on the bottom boundary of the target region, as the subtype of the quality type. Furthermore, when a value of the information indicating the subtype of the quality type is 6, the information indicating the subtype of the quality type may indicate trapezoid down scaling, performed based on the left boundary of the target region, as the subtype of the quality type. Furthermore, when a value of the information indicating the subtype of the quality type is 7, the information indicating the subtype of the quality type may indicate trapezoid down scaling, performed based on the right boundary of the target region, as the subtype of the quality type. Furthermore, when a value of the information indicating the subtype of the quality type is 8, the information indicating the subtype of the quality type may indicate atypical down scaling as the subtype of the quality type.

Furthermore, the metadata may include information indicating a plurality of subtypes of the quality type. In this case, the metadata may include information indicating the number of subtypes of the quality type. The information indicating the number of subtypes of the quality type may indicate the number_of_subtypes_minus1 field.

Furthermore, the metadata may include pieces of information indicating a plurality of quality types of the target region. In this case, the metadata may include information on a quality type indicated by each of the pieces of information indicating the plurality of quality types. That is, the metadata may include information indicating a level of each of the quality types of the target region, information indicating a subtype of each of the quality types and/or detailed information of each of the quality types. In other words, the metadata may include information indicating the level of each of the quality types indicated by the pieces of information indicating the plurality of quality types, and may include detailed information of each of the quality types. Furthermore, the metadata may include information indicating the subtype of each of the quality types. In this case, the metadata may include information indicating the number of quality types of the target region. The information indicating the number of quality types of the target region may indicate the number_of_quality_indication_type_minus1 field.

Furthermore, the metadata may include information indicating priority of each of the quality types. The information indicating the priority of each of the quality types may indicate the region_quality_indication_type_inter_type_index field.

Furthermore, the metadata may include a flag indicating whether information on the area in which post-processing is performed in the target region is forwarded. When a value of the flag is 1, the metadata may include information indicating the area in which post-processing is performed in the target region. In the metadata, the flag indicating whether information on the area in which post-processing is performed in the target region is forwarded may indicate the processing_region_indication_flag field.

Specifically, a flag indicating whether information on a 2D coordinate system is transmitted and information indicating a type of the target region may be transmitted. When a value of the flag indicating whether information on the area in which post-processing is performed in the target region is forwarded is 1, a value of the flag indicating whether information on a 2D coordinate system is transmitted is 1, and the information indicating the type of the target region indicates a rectangle as the type of the target region, the metadata may include information indicating a distance from the top boundary of the target region, information indicating a distance from the bottom boundary of the target region, information indicating a distance from the left boundary of the target region, and information indicating a distance from the right boundary of the target region. In this case, the area in which post-processing is performed may be derived as an area from the top boundary to the distance from the top boundary, that is, an area that neighbors the top boundary and that has the top boundary as the width and the distance from the top boundary as the height. Furthermore, the area in which post-processing is performed may be derived as an area from the bottom boundary to the distance from the bottom boundary, that is, an area that neighbors the bottom boundary and that has the bottom boundary as the width and the distance from the bottom boundary as the height. Furthermore, the area in which post-processing is performed may be derived as an area from the left boundary to the distance from the left boundary, that is, an area that neighbors the left boundary and that has the left boundary as the height and the distance from the left boundary as the width. Furthermore, the area in which post-processing is performed may be derived as an area from the right boundary to the distance from the right boundary, that is, an area that neighbors the right boundary and that has the right boundary as the height and the distance from the right boundary as the width.

In this case, the flag indicating whether information on a 2D coordinate system is transmitted may indicate the 2D_coordinate_flag field. The information indicating the type of the target region may indicate the region_type field. Furthermore, the information indicating the distance from the top boundary of the target region may indicate the processing_region_top_margin field. The information indicating the distance from the bottom boundary of the target region may indicate the processing_region_bottom_margin field. The information indicating the distance from the left boundary of the target region may indicate the processing_region_left_margin field. The information indicating the distance from the right boundary of the target region may indicate the processing_region_right_margin field.

Furthermore, When a value of the flag indicating whether information on the area in which post-processing is performed in the target region is forwarded is 1, a value of the flag indicating whether information on a 2D coordinate system is transmitted is 1, and the information indicating the type of the target region indicates a given closed figure as the type of the target region, the metadata may include information indicating a distance from a boundary configured with the j-th vertex and (j+1)-th vertex of the target region. In this case, the area in which post-processing is performed in the target region may be derived as an area from the boundary configured with the j-th vertex and the (j+1)-th vertex to the distance indicated by the information. That is, the area in which post-processing is performed in the target region may be derived as an area that neighbors the boundary configured with the j-th vertex and the (j+1)-th vertex and that has the boundary as the width and the distance indicated by the information as the height.

Furthermore, When a value of the flag indicating whether information on the area in which post-processing is performed in the target region is forwarded is 1, a value of the flag indicating whether information on a 2D coordinate system is transmitted is 1, and the information indicating the type of the target region indicates a circle as the type of the target region, the metadata may include information indicating a distance from a boundary of the target region. In this case, the area in which post-processing is performed in the target region may be derived as an area from the boundary to the distance indicated by the information. That is, the area in which post-processing is performed in the target region may be derived as an area of a doughnut shape from the boundary to the distance indicated by the information.

Furthermore, a flag indicating whether information on a 3D coordinate system is transmitted and information indicating a type of the viewport may be transmitted. When a value of the flag indicating whether information on the area in which post-processing is performed in the target region is forwarded is 1, a value of the flag indicating whether information on a 3D coordinate system is transmitted is 1, and the information indicating the type of the viewport indicates a type indicating the target region based on four great circles, the metadata may include information indicating coordinates on a vertical line passing through the center of the target region and information indicating coordinates on a horizontal line passing through the center of the target region. That is, the information indicating coordinates on a vertical line passing through the center of the target region may indicate the processing_region_yaw_margin field. The information indicating coordinates on a horizontal line passing through the center of the target region may indicate the processing_region_pitch_margin field.

Furthermore, a flag indicating whether information on a 3D coordinate system is transmitted and information indicating a type of the viewport may be transmitted. When a value of the flag indicating whether information on the area in which post-processing is performed in the target region is forwarded is 1, a value of the flag indicating whether information on a 3D coordinate system is transmitted is 1, and the information indicating the type of the viewport indicates a type indicating the target region based on two great circles and two small circles, the metadata may include information indicating a distance from the top boundary of the target region, information indicating a distance from the bottom boundary of the target region, information indicating a distance from the left boundary of the target region, and information indicating a distance from the right boundary of the target region. The information indicating a distance from the top boundary of the target region may indicate the processing_region_yaw_top_margin field. The information indicating a distance from the bottom boundary of the target region may indicate the processing_region_yaw_bottom_margin field. The information indicating a distance from the left boundary of the target region may indicate the processing_region_pitch_left_margin field. The information indicating a distance from the right boundary of the target region may indicate the processing_region_pitch_right_margin field.

Furthermore, the metadata may include a flag indicating whether information on the area in which post-processing is not performed in the target region is forwarded. When a value of the flag is 1, the metadata may include information indicating the area in which post-processing is not performed in the target region. In the metadata, the flag indicating whether information on the area in which post-processing is not performed in the target region is forwarded may indicate the core_region_indication_flag field.

Specifically, a flag indicating whether information on a 2D coordinate system is transmitted and information indicating a type of the target region may be transmitted. When a value of the flag indicating whether information on the area in which post-processing is not performed in the target region is forwarded is 1, a value of the flag indicating whether information on a 2D coordinate system is transmitted is 1, and the information indicating the type of the target region indicates a rectangle as the type of the target region, the metadata may include information indicating the x component of the left top sample of the area in which post-processing is not performed in the target region, information indicating the y component of the left top sample of the area in which post-processing is not performed in the target region, information indicating the width of the area in which post-processing is not performed in the target region, and information indicating the height of the area in which post-processing is not performed in the target region. The information indicating the y component of the left top sample of the area in which post-processing is not performed in the target region may indicate the core_region_top_index field. The information indicating the x component of the left top sample of the area in which post-processing is not performed in the target region may indicate the core_region_left_index field. The information indicating the width of the area in which post-processing is not performed in the target region may indicate the core_region_width field. The information indicating the height of the area in which post-processing is not performed in the target region may indicate the core_region_height field.

Furthermore, When a value of the flag indicating whether information on the area in which post-processing is not performed in the target region is forwarded is 1, a value of the flag indicating whether information on a 2D coordinate system is transmitted is 1, and the information indicating the type of the target region indicates a given closed figure as the type of the target region, the metadata may include information indicating the x component of a vertex of the area in which post-processing is not performed in the target region and information indicating the y component of a vertex of the area in which post-processing is not performed. The information indicating the x component of the vertex of the area in which post-processing is not performed in the target region may indicate the core_vertex_index_x field. The information indicating the y component of the vertex of the area in which post-processing is not performed in the target region may indicate the core_vertex_index_y field.

Furthermore, When a value of the flag indicating whether information on the area in which post-processing is not performed in the target region is forwarded is 1, a value of the flag indicating whether information on a 2D coordinate system is transmitted is 1, and the information indicating the type of the target region indicates a circle as the type of the target region, the metadata may include information indicating the radius of the area in which post-processing is not performed in the target region. The information indicating the radius of the area in which post-processing is not performed in the target region may indicate the core_circle_radius field.

Furthermore, a flag indicating whether information on a 3D coordinate system is transmitted and information indicating a type of the viewport may be transmitted. When a value of the flag indicating whether information on the area in which post-processing is not performed in the target region is forwarded is 1, a value of the flag indicating whether information on a 3D coordinate system is transmitted is 1, and the information indicating the type of the viewport indicates a type indicating the target region based on four great circles, the metadata may include information indicating the width of the area in which post-processing is not performed in the target region and information indicating the height of the area in which post-processing is not performed in the target region. The information indicating the width of the area in which post-processing is not performed in the target region may indicate the core_region_width field. The information indicating the height of the area in which post-processing is not performed in the target region may indicate the core_region_height field.

Furthermore, a flag indicating whether information on a 3D coordinate system is transmitted and information indicating a type of the viewport may be transmitted. When a value of the flag indicating whether information on the area in which post-processing is not performed in the target region is forwarded is 1, a value of the flag indicating whether information on a 3D coordinate system is transmitted is 1, and the information indicating the type of the viewport indicates a type indicating the target region based on two great circles and two small circles, the metadata may include information indicating a yaw value of the left top sample of the area in which post-processing is not performed in the target region, information indicating a pitch value of the left top sample of the area in which post-processing is not performed in the target region, information indicating a yaw value of the right bottom sample of the area in which post-processing is not performed in the target region, and information indicating a pitch value of the right bottom sample of the area in which post-processing is not performed in the target region. The information indicating a yaw value of the left top sample of the area in which post-processing is not performed in the target region may indicate the core_region_yaw_top_left field. The information indicating a pitch value of the left top sample of the area in which post-processing is not performed in the target region may indicate the core_region_pitch_top_left field. The information indicating a yaw value of the right bottom sample of the area in which post-processing is not performed in the target region may indicate the core_region_yaw_bottom_right field. The information indicating a pitch value of the right bottom sample of the area in which post-processing is not performed in the target region may indicate the core_region_pitch_bottom_right field.

Furthermore, the metadata may include a flag indicating whether detailed information on the post-processing is forwarded. When a value of the flag is 1, the metadata may include information indicating a filter used in the post-processing, information indicating the number of filter coefficients of the filter, and information indicating a value of each of the filter coefficients. The filter used in the post-processing may be one of a smoothing filter, a blending filter, an enhancement filter and a restoration filter.

Specifically, for example, when a value of the information indicating a filter used in the post-processing is 1, the information indicating a filter used in the post-processing may indicate a smoothing filter as the filter used in the post-processing. Furthermore, when a value of the information indicating the filter used in the post-processing is 2, the information indicating a filter used in the post-processing may indicate a blending filter as the filter used in the post-processing. Furthermore, when a value of the information indicating a filter used in the post-processing is 3, the information indicating a filter used in the post-processing may indicate an enhancement filter as the filter used in the post-processing. Furthermore, when a value of the information indicating a filter used in the post-processing is 4, the information indicating a filter used in the post-processing may indicate a restoration filter as the filter used in the post-processing.

The information indicating a filter used in the post-processing may indicate the processing_type field. The information indicating the number of filter coefficients of the filter may indicate the number_of_parameters field. The information indicating a value of each of the filter coefficients may indicate the processing_parameter field.

Meanwhile, the metadata may be received through an SEI message. Furthermore, the metadata may be included in an adaptation set (AdaptationSet), representation (Representation) or sub-representation (SubRepresentation) of a media presentation description (MPD). In this case, the SEI message may be used to assist the decoding of a 2D image or the display of a 2D image in a 3D space.

The 360-degree video reception apparatus decodes the current picture based on the metadata and the information on the current picture, and renders the decoded current picture into a 3D space by processing the decoded current picture (S1720). The 360-degree video reception apparatus may decode the current picture based on the information on the current picture. Furthermore, the 360-degree video reception apparatus may obtain metadata for region-wise quality indication information through a received bit stream, and may select a region having a characteristic preferred by the 360-degree video reception apparatus by comparing qualities of regions based on the metadata. Furthermore, the 360-degree video reception apparatus may determine priority of the target region, among the target region and the corresponding regions of the target region, based on the metadata, and may select a video stream, included in the target region, based on the priority. In this case, the corresponding regions may indicate regions at the same position as the target region in video streams other than a video stream including the current picture. Furthermore, the 360-degree video reception apparatus may select a quality type having the top priority, among the quality types of the target region, based on the metadata, and may preferentially compare the qualities of regions within the current picture based on the quality type having the top priority.

Furthermore, the 360-degree video reception apparatus may render the decoded current picture into a 3D space by processing the decoded current picture based on the metadata. The 360-degree video reception apparatus may map the 360-degree video data of the current picture to the 3D space based on the metadata. Specifically, the 360-degree video reception apparatus may perform post-processing on the target region based on region-wise packing process-related metadata for the target region of the current picture, and may render the current picture on which the post-processing has been performed into the 3D space. Specifically, the 360-degree video reception apparatus may obtain metadata for region-wise quality indication information through a received bit stream, and may perform post-processing on the target region based on the metadata. The post-processing may indicate a process of performing filtering on a surrounding area of a boundary between the target region and the surrounding area of the target region. Furthermore, the 360-degree video reception apparatus may derive the area in which the post-processing is performed and the area in which the post-processing is not performed in the target region based on the metadata, and may derive a type of a filter used in the post-processing region and the filter coefficients of the filter.

Meanwhile, if the current picture is a packed picture, the 360-degree video reception apparatus may obtain a projected picture from the current picture based on the metadata, and may re-project the projected picture onto the 3D space. In this case, the 360-degree video reception apparatus may obtain the projected picture based on the target region, and can reduce a region boundary error of the projected picture by performing post-processing based on the metadata for the target region. The region boundary error may mean an error in which a boundary at which the regions of the projected picture neighbor or a difference between regions of a boundary is not seen as a continuous picture, but appears as a divided area without appearing as a clear line or appearing clearly.

The above-described steps may be omitted according to an embodiment or replaced by other steps of performing similar/identical operations.

The 360 video transmission apparatus according to an embodiment of the present disclosure may include the above-described data input unit, stitcher, signaling processor, projection processor, data encoder, transmission processor and/or transmitter. The internal components have been described above. The 360 video transmission apparatus and internal components thereof according to an embodiment of the present disclosure may perform the above-described embodiments with respect to the method of transmitting a 360 video of the present disclosure.

The 360 video reception apparatus according to an embodiment of the present disclosure may include the above-described receiver, reception processor, data decoder, signaling parser, reprojection processor and/or renderer. The internal components have been described above. The 360 video reception apparatus and internal components thereof according to an embodiment of the present disclosure may perform the above-described embodiments with respect to the method of receiving a 360 video of the present disclosure.

The internal components of the above-described apparatuses may be processors which execute consecutive processes stored in a memory or hardware components. These components may be located inside/outside the apparatuses.

The above-described modules may be omitted or replaced by other modules which perform similar/identical operations according to embodiments.

The above-described parts, modules or units may be processors or hardware parts executing consecutive processes stored in a memory (or a storage unit). The steps described in the aforementioned embodiments can be performed by processors or hardware parts. Modules/blocks/units described in the above embodiments can operate as hardware/processors. The methods proposed by the present disclosure can be executed as code. Such code can be written on a processor-readable storage medium and thus can be read by a processor provided by an apparatus.

In the above exemplary systems, although the methods have been described based on the flowcharts using a series of the steps or blocks, the present disclosure is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present disclosure.

When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means. The processor may include application-specific integrated circuits (ASICs), other chipsets, logic circuits, and/or data processors. The memory may include read-only memory (ROM), random access memory (RAM), flash memory, memory cards, storage media and/or other storage devices.

1. A 360-degree video data processing method performed by a 360-degree video transmission apparatus, the method comprising:
obtaining 360-degree video data captured by at least one camera;
obtaining a current picture by processing the 360-degree video data;
generating metadata for the 360-degree video data;
encoding the current picture; and
performing processing for a storage or transmission on the encoded current picture and the metadata,
wherein the metadata comprises information indicating a quality type of a target region within the current picture, and
wherein when the quality type is a specific value, the metadata comprises information related to a horizontal direction or a vertical direction of the target region.

2. The method of claim 1, wherein the information related to the horizontal direction or the vertical direction is information indicating at least one of horizontal down scaling and vertical down scaling.

3-4. (canceled)

5. The method of claim 1, wherein the information related to the horizontal direction or the vertical direction is information about scaling between the target region and a region in the projected picture for the target region.

6. (canceled)

7. The method of claim 1, wherein the metadata comprises information indicating priority of the target region among regions within the current picture indicated based on the quality type.

8. The method of claim 1, wherein:
the metadata comprises pieces of information indicating a plurality of quality types of the target region, and
the metadata comprises information indicating a level of each of the quality types indicated by the pieces of information indicating the plurality of quality types.

9. The method of claim 8, wherein the metadata comprises detailed information of each of the quality types.

10. The method of claim 8, wherein the metadata comprise information indicating a number of the quality types of the target region.

11. The method of claim 6, wherein the metadata comprises information indicating priority of each of the quality types.

12. The method of claim 1, wherein:
the metadata comprises a flag indicating whether information on an area in which post-processing is performed in the target region is forwarded, and
when a value of the flag is 1, the metadata comprises information indicating the area in which post-processing is performed in the target region.

13. The method of claim 12, wherein:
the metadata comprises a flag indicating whether information on the area in which post-processing is not performed in the target region is forwarded, and
when a value of the flag is 1, the metadata comprises information indicating the area in which post-processing is not performed in the target region.

14. The method of claim 12, wherein:
the metadata comprises a flag indicating whether detailed information on the post-processing is forwarded,
when a value of the flag is 1, the metadata comprises information indicating a filter used in the post-processing, information indicating a number of filter coefficients of the filter, or information indicating a value of each of the filter coefficients.

15. A 360-degree video data processing method performed by a 360 video receiving apparatus, comprising:
receiving a signal including information on a current picture for 360-degree video data and metadata for the 360-degree video data;
obtaining the information on the current picture and the metadata by processing the signal;
decoding the current picture based on the information on the current picture and the metadata; and
rendering the decoded current picture on a 3D space by processing the decoded current picture,
wherein the metadata includes information indicating a quality type of a target region in the current picture, and
wherein when the quality type is a specific value, the metadata comprises information related to a horizontal direction or a vertical direction of the target region.

16. The method of claim 15, wherein the information related to the horizontal direction or the vertical direction is information indicating at least one of horizontal down scaling and vertical down scaling.

17-18. (canceled)

19. The method of claim 15, wherein the information related to the horizontal direction or the vertical direction is information about scaling between the target region and a region in the projected picture for the target region.

20. The method of claim 19, wherein the metadata comprises information indicating priority of the target region among regions within the current picture indicated based on the quality type.
